(19) United States
(12) Patent Application Publication
(10) Pub. No.: US 2006/0028935 A1
(43) Pub. Date: Feb. 9, 2006

(54) Optical pickup device, optical disk apparatus, and light-receiving unit

(75) Inventors: Taiichi Mori, Koga-shi (JP); Shogo Horinouchi, Fukuoka-shi (JP); Hideki Yoshinaka, Chikushino-shi (JP); Takashi Haruguchi, Fukuoka-shi (JP); Hideki Ohyama, Fukuoka-shi (JP); Shin Ishibashi, Fukuoka-shi (JP); Junya Aso, Fukuoka-shi (JP); Tsuyoshi Yoshimoto, Ogoori-shi (JP); Youichi Maehara, Kasuga-shi (JP)

Correspondence Address: STEVENS, DAVIS, MILLER & MOSHER, LLP, 1615 L. STREET N.W., SUITE 850, WASHINGTON, DC, 20036, US

(73) Assignee: MATSUSHITA ELECTRIC INDUSTRIAL CO., LTD., Osaka (JP)

(21) Appl. No.: 11/194,753

(22) Filed: Aug. 2, 2005

(30) Foreign Application Priority Data
Aug. 3, 2004 (JP) P2004-226495
Oct. 25, 2004 (JP) P2004-309402
Oct. 25, 2004 (JP) P2004-309403
Oct. 25, 2004 (JP) P2004-309404
Jan. 5, 2005 (JP) P2005-000388
Feb. 24, 2005 (JP) P2005-048375

(51) Int. Cl. G11B 7/00

(52) U.S. Cl. 369/44.37; 369/112.01

(57) ABSTRACT

An optical pickup device, comprises a first light source emitting light with a short wavelength; a second light source emitting s light with a wavelength longer than that of the first light source; an optical member guiding the light from the first light source and the light from the second light source on almost the same optical path; a focusing member focusing the light from the optical member; a movable lens provided between the optical member and the focusing lens; and a drive member driving the movable lens, wherein a position of the lens when at least one of recording and reproducing of information is carried out on a medium using the light from the first light source is made different from a position of the lens when at least one of the recording and reproducing of information is carried out on the medium using the light from the second light source.

### BACKGROUND OF THE INVENTION

1. Field of the Invention

The present invention relates to an optical disk apparatus which can be mounted on electronic equipment such as stationary personal computers or portable electronic equipment such as notebook personal computers, and an optical pickup device mounted on the optical disk apparatus.

2. Description of the Related Art

In optical disk apparatuses, recently, it has been required to perform recording and reproducing on CDs or DVDs with an infrared laser or a red color laser, and it has also been required to perform at least one of recording and reproducing of information on optical disks corresponds to a short wavelength laser such as a blue color laser.

Conventional Examples are disclosed in JP-A No. 2003-771631, JP-A No. 2002-245660, JP-A No. 2004-103189, JP-A No. 2004-152426, JP-A No. 2004-158102, JP-A No. 2003-77167, JP-A No. 2003-59080, JP-A No. 2000-131603, JP-A No. 2003-85806, JP-A No. 2004-206763, and JP-A No. 2004-334475.

An optical pickup configured to have short wavelength light is disclosed in JP-A No. 2003-771631, and an optical pickup where a light source with a long wavelength and a light source with a short wavelength are mounted is disclosed in JP-A No. 2002-245660.

However, correction of spherical aberration in the short wavelength light, or optimization of optical configuration in the long wavelength light is not disclosed in JP-A No. 2002-245660.

According to JP-A No. 2004-103189, JP-A No. 2004-152426, JP-A No. 2004-158102, JP-A No. 2003-77167, JP-A No. 2003-59080, JP-A No. 2000-131603, JP-A No. 2003-85806, JP-A No. 2004-206763, and JP-A No. 2004-334475, a focusing portion such as a collimator lens is moved so that the spherical aberration is corrected.

However, in an optical pickup which records and reproduces information on an optical disk with short wavelength light and long wavelength light, the patent documents do not disclose any configuration in which the spherical aberration in the short wavelength light is corrected, and an optimal optical system in the long wavelength light is accomplished, thereby making the apparatus as small as possible.

### SUMMARY OF THE INVENTION

An object of the present invention is to provide an optical pickup device and an optical disk, which are capable of accomplishing improved optical configuration in each wavelength and implementing miniaturization.

In order to achieve the above-mentioned object, the present invention provides an optical pickup device including: a first light source that emits light with a short wavelength; a second light source that emits light with a wavelength longer than that of the first light source; an optical member that guides the light from the first light source and the light from the second light source on almost the same optical path; a focusing member that focuses the light from the optical member; a movable lens provided between the optical member and the focusing lens; and a drive member that drives the movable lens. In this case, a position of the lens when at least one of recording and reproducing of information is carried out on a medium using the light from the first light source is made different from a position of the lens when at least one of the recording and reproducing of information is carried out on the medium using the light from the second light source.

According to the above structure of the invention, since the lens can be disposed at a predetermined position in each wavelength, the spherical aberration in the short wavelength light can be reduced, and an optimal optical system can be implemented in the long wavelength light. Also, the movable lens is provided on almost the same optical path along which the short wavelength light and the long wavelength light are to be guided, so that a minimum number of components can be used to obtain the effect, thereby allowing the device to be small-sized.

### BRIEF DESCRIPTION OF THE DRAWINGS

FIG. 1 is a schematic view illustrating an optical pickup device in accordance with an embodiment of the present invention.

FIG. 2 is a view illustrating an optical pickup device in accordance with an embodiment of the present invention.

FIG. 3 is a view illustrating a module on which an optical pickup device in accordance with an embodiment of the present invention is mounted.

FIG. 4 is a view illustrating a module on which an optical pickup device in accordance with an embodiment of the present invention is mounted.

FIG. 5 is a view illustrating a portion of an optical pickup device in accordance with an embodiment of the present invention.

FIG. 6 is a view illustrating a portion of an optical pickup device in accordance with an embodiment of the present invention.

FIG. 7 is a view illustrating a portion of an optical pickup device in accordance with an embodiment of the present invention.

FIG. 8 is a view illustrating a portion of an optical pickup device in accordance with an embodiment of the present invention.

FIG. 9 is a view illustrating a portion of an optical pickup device in accordance with an embodiment of the present invention.

FIG. 10 is a view illustrating a portion of an optical pickup device in accordance with an embodiment of the present invention.

FIG. 11 is a view illustrating a portion of an optical pickup device in accordance with an embodiment of the present invention.

FIG. 12 is a view illustrating a portion of an optical pickup device in accordance with an embodiment of the present invention.

FIG. 13 is a view illustrating a portion of an optical pickup device in accordance with an embodiment of the present invention.

FIG. 14 is a view illustrating light being emitted from a light source of an optical pickup device in accordance with an embodiment of the present invention.

FIG. 15 is a view illustrating light being emitted from a light source of an optical pickup device in accordance with an embodiment of the present invention.

FIG. 16 is a view illustrating a portion of an optical pickup device in accordance with an embodiment of the present invention.

FIG. 17 is a view illustrating a portion of an optical pickup device in accordance with an embodiment of the present invention.

FIG. 18 is a view illustrating a portion of an optical pickup device in accordance with an embodiment of the present invention.

FIG. 19 is a view illustrating a portion of an optical pickup device in accordance with an embodiment of the present invention.

FIG. 20 is a view illustrating a portion of an optical pickup device in accordance with an embodiment of the present invention.

FIG. 21 is a view illustrating a portion of an optical pickup device in accordance with an embodiment of the present invention.

FIG. 22 is a view illustrating a portion of an optical pickup device in accordance with an embodiment of the present invention.

FIG. 23 is a view illustrating a portion of an optical pickup device in accordance with an embodiment of the present invention.

FIG. 24 is a view illustrating a portion of an optical pickup device in accordance with an embodiment of the present invention.

FIG. 25 is a view illustrating a portion of an optical pickup device in accordance with an embodiment of the present invention.

FIG. 26 is a view illustrating a portion of an optical pickup device in accordance with an embodiment of the present invention.

FIG. 27 is a view illustrating a portion of an optical pickup device in accordance with an embodiment of the present invention.

FIG. 28 is a view illustrating a portion of an optical pickup device in accordance with an embodiment of the present invention.

FIG. 29 is a view illustrating a portion of an optical pickup device in accordance with an embodiment of the present invention.

FIG. 30 is a view illustrating a portion of an optical pickup device in accordance with an embodiment of the present invention.

FIG. 31 is a view illustrating a temperature distribution of an optical pickup device in accordance with an embodiment of the present invention.

FIG. 32 is a view illustrating a portion of an optical pickup device in accordance with an embodiment of the present invention.

FIG. 33 is a view illustrating a portion of an optical pickup device in accordance with an embodiment of the present invention.

FIG. 34 is a view illustrating a portion of an optical pickup device in accordance with an embodiment of the present invention.

FIG. 35 is a view illustrating a portion of an optical pickup device in accordance with an embodiment of the present invention.

FIG. 36 is a view illustrating a portion of an optical pickup device in accordance with an embodiment of the present invention.

FIG. 37 is a view illustrating a portion of an optical pickup device in accordance with an embodiment of the present invention.

FIG. 38 is a view illustrating a portion of an optical pickup device in accordance with an embodiment of the present invention.

FIG. 39 is a view illustrating a portion of an optical pickup device in accordance with an embodiment of the present invention.

FIG. 40 is a view illustrating a portion of an optical pickup device in accordance with an embodiment of the present invention.

FIG. 41 is a view illustrating a portion of an optical pickup device in accordance with an embodiment of the present invention.

FIG. 42 is a view illustrating a portion of an optical pickup device in accordance with an embodiment of the present invention.

FIG. 43 is a view illustrating a portion of an optical pickup device in accordance with an embodiment of the present invention.

FIG. 44 is a view illustrating a portion of an optical pickup device in accordance with an embodiment of the present invention.

FIG. 45 is a view illustrating a portion of an optical pickup device in accordance with an embodiment of the present invention.

FIG. 46 is a view illustrating a portion of an optical pickup device in accordance with an embodiment of the present invention.

FIG. 47 is a view illustrating a portion of an optical pickup device in accordance with an embodiment of the present invention.

FIG. 48 is a view illustrating a portion of an optical pickup device in accordance with an embodiment of the present invention.

FIG. 49 is a view illustrating a portion of an optical pickup device in accordance with an embodiment of the present invention.

FIG. 50 is a view illustrating a portion of an optical pickup device in accordance with an embodiment of the present invention.

FIG. 51 is a view illustrating a portion of an optical pickup device in accordance with an embodiment of the present invention.

FIG. 52 is a view illustrating a portion of an optical pickup device in accordance with an embodiment of the present invention.

FIG. 53 is a view illustrating a portion of an optical pickup device in accordance with an embodiment of the present invention.

FIG. 54 is a view illustrating a portion of an optical pickup device in accordance with an embodiment of the present invention.

FIG. 55 is a view illustrating a portion of an optical pickup device in accordance with an embodiment of the present invention.

FIG. 56 is a view illustrating a portion of an optical pickup device in accordance with an embodiment of the present invention.

FIG. 57 is a view illustrating a portion of an optical pickup device in accordance with an embodiment of the present invention.

FIG. 58 is a view illustrating a portion of an optical pickup device in accordance with an embodiment of the present invention.

FIG. 59 is a view illustrating a portion of an optical pickup device in accordance with an embodiment of the present invention.

FIG. 60 is a view illustrating a portion of an optical pickup device in accordance with an embodiment of the present invention.

FIG. 61 is a view illustrating a portion of an optical pickup device in accordance with an embodiment of the present invention.

FIG. 62 is a view illustrating a portion of an optical pickup device in accordance with an embodiment of the present invention.

FIG. 63 is a view illustrating a portion of an optical pickup device in accordance with an embodiment of the present invention.

FIG. 64 is a view illustrating a portion of an optical pickup device in accordance with an embodiment of the present invention.

FIG. 65 is a view illustrating a portion of an optical pickup device in accordance with an embodiment of the present invention.

FIG. 66 is a perspective view illustrating an optical disk apparatus in accordance with an embodiment of the present invention.

### DESCRIPTON OF THE PREFERRED EMBODIMENTS

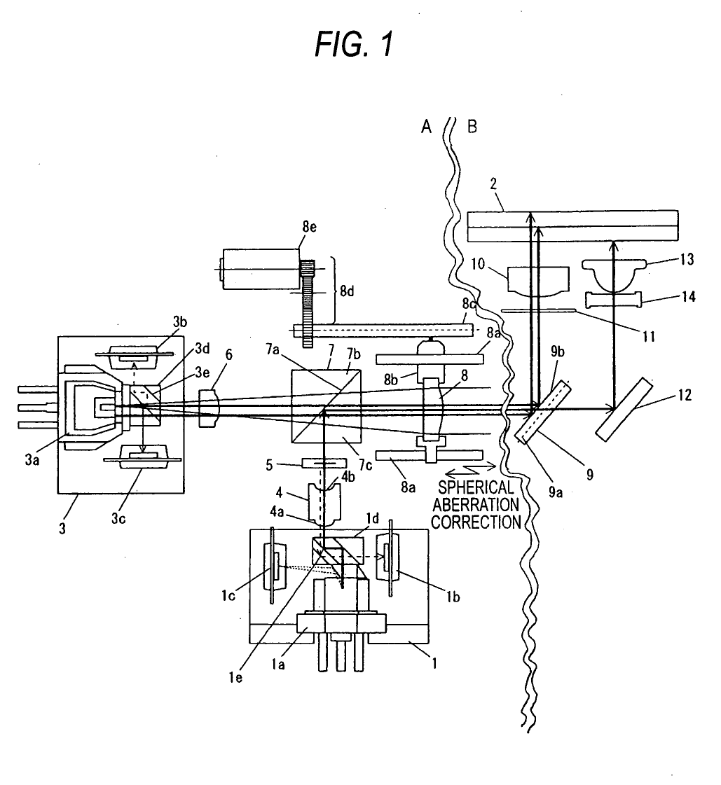

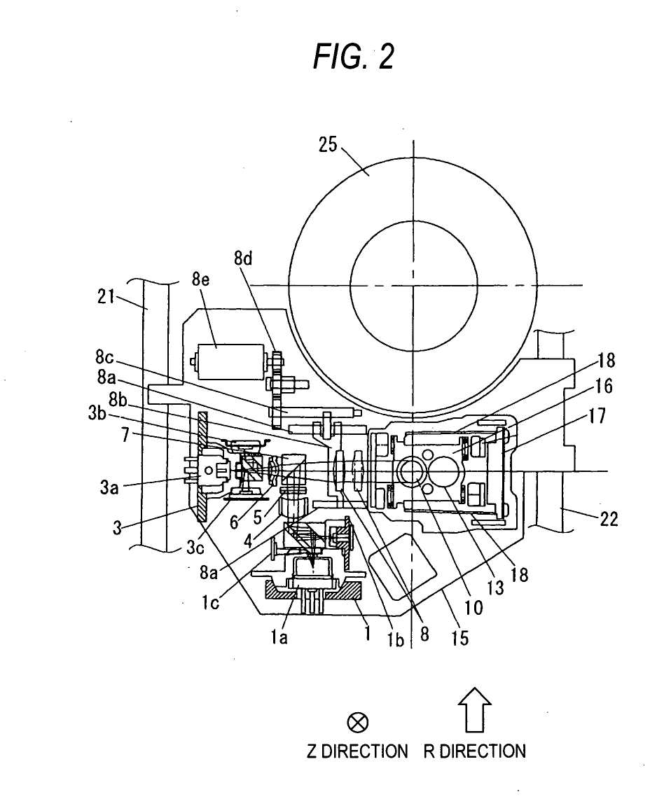

FIG. 1 is a schematic view illustrating a structure of an optical pickup device in accordance with an embodiment of the present invention. In addition, referring to FIG. 1, the portion A of double undulating lines ranging from a short wavelength optical unit 1 or a long wavelength optical unit 2 to a collimator lens 8, is a schematic view when the optical pickup device is seen from a Z direction (top of the paper) in FIG. 2, and the portion B of the double undulating lines ranging from a starting mirror 9 to an optical disk 2 is a schematic view when the optical pickup device is seen from an R direction in FIG. 2.

Referring to FIG. 1, reference numeral 1 denotes a short wavelength optical unit which emits short wavelength laser light. The light emitted from the short wavelength optical unit 1 has a wavelength of about 400 nm to 415 nm. In the present embodiment, the short wavelength optical unit is adapted to emit light of about 405 nm. In addition, the light of the above-described laser wavelength shows colors ranging from a blue color to a violet color. In the present embodiment, details of the short wavelength optical unit 1 will be described below, which includes a light source 1a emitting short wavelength laser light, a light-receiving portion 1b for signal detection which receives the light reflected from the optical disk 2, a light-receiving portion le provided so as to monitor the amount of the light emitted from the light source 1a, an optical member 1d, and a holding member (not shown) holding these constitutional members in their predetermined positional relationship. The light source 1 aA is provided with a semiconductor laser element (not shown) containing GaN or containing GaN as a main component. Light emitted from the semiconductor laser element is incident on the optical member 1 d, and a portion of the incident light is reflected by the optical member 1d and then enters the light-receiving portion 1e. Although not shown, the light-receiving portion 1c is provided with a circuit or the like which converts light to electrical signals and adjusts the intensity of the light emitted from the light source 1a to desired intensity based on the electrical signals. In addition, most of light emitted from the light source 1a is guided through the optical member 1d toward the optical disk 2. In addition, the light reflected from the optical disk 2 is incident on the light-receiving portion 1b via the optical member 1d. The light-receiving portion 1b converts the light to electrical signals, and generates radio frequency (RF) signals, tracking error signals, focusing error signals, and so forth from the electrical signals. The optical member 1d is provided with a hologram 1e which separates the light reflected from the optical disk 2 so as to obtain the focusing error signals.

Furthermore, in the present embodiment, one short wavelength optical unit is configured to include the light source 1a, the light-receiving portions 1b and 1c, and the optical member 1d in order to make the optical pickup device small-sized. However, at least one of the light-receiving portions 1b and 1c may be separated from the short wavelength optical unit 1 to be a discrete member. Alternatively, the optical member 1d may be separated from the short wavelength optical unit 1 to be a discrete member.

Reference numeral 3 denotes a long wavelength optical unit emitting laser light of long wavelength. The light emitted from the long wavelength optical unit 3 has a wavelength of about 640 nm to 800 nm. The long wavelength optical unit is adapted to emit light of one type of wavelength or light of several types of wavelengths. In the present embodiment, the long wavelength optical unit is adapted to emit a light flux of wavelength of about 660 nm (red color: e.g. corresponding to DVDs) and a light flux of wavelength of about 780 nm (infrared color: e.g. corresponding to CDs). In the present embodiment, details of the long wavelength optical unit 3 will be described below, which includes a light source 3a emitting long wavelength laser light, a light-receiving portion 3b for signal detection which receives the light reflected from the optical disk 2, a light-receiving portion 3c provided so as to monitor the amount of the light emitted from the light source 3a, an optical member 3d, and a holding member (not shown) holding these constitutional members in their predetermined positional relationship. The light source 3a is provided with a semiconductor laser element (not shown). The semiconductor laser element is configured to have a mono block (monolithic structure). A light flux of wavelength of about 660 nm (red color) and a light flux of wavelength of 780 nm (infrared color) are emitted from elements of the mono block. In addition, the elements of the mono block are adapted to emit two light fluxes in the present embodiment. However, two of the elements emitting one light flux with one block element may be built in. A plurality of light fluxes emitted from the semiconductor laser element are incident on the optical member 3d, and a portion of the incident light is reflected by the optical member 3d to enter the light-receiving portion 3c. Although not shown, the light-receiving portion 3c is provided with a circuit or the like which converts light to electrical signals and adjusts the intensity of the light emitted from the light source 3a to desired intensity based on the electrical signals. In addition, most of the light emitted from the light source 3a is guided through the optical member 3d toward the optical disk 2. In addition, the light reflected from the optical disk 2 is incident on the light-receiving portion 3b via the optical member 3d. The light-receiving portion 3b converts the light to electrical signals, and generates RF signals, tracking error signals, focusing error signals, and so forth from the electrical signals. In addition, the optical member 3d is provided with a hologram 3e which separates the light reflected from the optical disk 2 into a plurality of light fluxes so as to generate the focusing error signals for CDs and guides each of the light fluxes to a predetermined position of the light-receiving portion 3b.

Furthermore, in the present embodiment, one long wavelength optical unit 3 is configured to include the light source 3a, the light-receiving portions 3b and 3c, and the optical member 3d in order to make the optical pickup device small-sized. However, at least one of the light-receiving portions 3b and 3c may be separated from the long wavelength optical unit 3 to be a discrete member. Alternatively, the optical member 3d may be separated from the long wavelength optical unit 3 to be a discrete member.

Reference numeral 4 denotes a beam-shaping lens which allows light emitted from the short wavelength optical unit 1 and the light reflected from the optical disk 2 to be transmitted therethrough. The beam-shaping lens 4 is preferably made of glass which has less deterioration due to transmission of short wavelength laser light. The beam-shaping lens 4 is made of the glass in the present embodiment. However, the beam-shaping lens 4 may be made of another material as long as the material has less deterioration due to transmission of short wavelength laser light. The beam-shaping lens 4 is formed for the purpose of preventing astigmatism of the short wavelength laser light and astigmatism occurring on an optical path from the short wavelength optical unit 1 to the optical disk 2. In consideration of use of the beam-shaping lens 4, the light reflected from the optical disk 2 may be made incident on the short wavelength optical unit 1 without passing through the beam-shaping lens 4. However, the light reflected from the optical disk 2 are made incident on the short wavelength optical unit 1 via the beam-shaping lens 4 in the present embodiment considering their optical arrangement. In addition, the beam-shaping lens 4 is employed to reduce the astigmatism of the short wavelength light in the present embodiment. However, a beam-shaping prism or a beam-shaping hologram may be employed instead.

In addition, a convex portion 4a and a concave portion 4b are respectively formed at both ends of the beam-shaping lens 4, and the beam-shaping lens 4 is disposed such that light emitted from the short wavelength optical unit 1 is first incident on the convex section 4a and is then emitted from the concave portion 4b.

Reference numeral 5 denotes an optical component, which is disposed at an end of the beam-shaping lens 4 on its optical path, and is disposed at the concave portion 4b of the beam-shaping lens 4. That is, light emitted from the short wavelength optical unit 1 is incident on the optical component 5 via the beam-shaping lens 4 and then guided to the optical disk 2, and the light reflected from the optical disk 2 is incident on the short wavelength optical unit 1 via the optical component 5 and the beam-shaping lens 4 in this order. The optical component 5A is provided with a hologram or the like and has at least the following functions. That is, the optical components functions to separate the light reflected from the optical disk 2 into a predetermined number of light fluxes so as to mainly generate tracking error signals. As described above, the light is separated into a plurality of light fluxes for generating focusing error signals by means of the hologram 1e provided in the optical member 1d and the light is separated into a plurality of light fluxes for generating tracking error signals by means of the optical component 5.

In particular, the optical component 5 may have a function of acting as a RIM intensity correction filter for reducing the amount of light in almost the central portion of the short wavelength light. Furthermore, the optical component 5 may be separated into two parts and one part of the optical component 5 may be allowed to have a function of separating the light reflected from the optical disk 2 into a predetermined number of light fluxes so as to mainly generate tracking error signals and the other part of the optical component 5 may be allowed to have a function of acting as a RIM intensity correction filter.

Reference numeral 6 denotes a relay lens through which long wavelength light emitted from the long wavelength optical unit 3 is transmitted. The relay lens 6 is made of a transparent member such as resin or glass. The relay lens 6 is provided so as to efficiently guide light emitted from the long wavelength optical unit 3 to a rear member. In addition, the provision of the relay lens 6 allows the long wavelength optical unit 3 to be disposed closer to a beam splitter 7, so that the device can be made small-sized.

Reference numeral 7 denotes a beam splitter as an optical member, which has at least two transparent members 7b and 7c bonded to each other. One inclined surface 7a is formed between the transparent members 7b and 7c, and the inclined surface 7a is provided with a wavelength selection film. The wavelength selection film is directly formed in the inclined surface 7a of the transparent member 7c on which light emitted from the short wavelength optical unit 1 are incident, and the transparent member 7b is bonded to the inclined surface 7a of the transparent member 7c where the wavelength selection film is formed by means of a bonding material such as resin or glass.

In addition, the beam splitter 7 has a function of reflecting short wavelength light emitted from the short wavelength optical unit 1 and transmitting light emitted from the long wavelength optical unit 3. That is, the beam splitter is adapted to guide the light emitted from the short wavelength optical unit 1 and the light emitted from the long wavelength optical unit 3 in almost the same direction.

Reference numeral 8 denotes a collimator lens which is movably held. The collimator lens 8 is attached to a slider 8b, and the slider 8b is movably attached to a pair of supporting members 8a arranged parallel to each other. A lead screw 8c where a helical groove is formed is provided substantially parallel to the supporting member 8a, and a protrusion entering the groove of the lead screw 8c is formed at an end of the slider 8b. A gear group 8d is coupled to the lead screw 8c, and the gear group 8d is provided with a drive member 8e. A drive force of the drive member 8e is transmitted to the lead screw 8c via the gear group 8d, and the lead screw 8c is rotated by the drive force, so that the slider 8b moves along the supporting member 8a. That is, a difference in driving directions or a difference of driving speed of the drive member 8e enables the collimator lens 8 to move toward or away from the beam splitter 7, and enables its movement speed to be adjusted.

In addition, various motors may be employed as the drive member 8e, and in particular, a stepping motor is preferably employed as the drive member 8e. That is, by adjusting the number of pulses sent to the stepping motor, the amount of rotation of the lead screw 8c is determined, so that the amount of movement of the collimator lens 8 can be easily set.

As such, by employing a structure that the collimator lens 8 is caused to move toward or away from the beam splitter 7, the spherical aberration can be easily adjusted. That is, the spherical aberration of the short wavelength light can be adjusted in response to the position of the collimator lens 8, so that at least one of recording and reproducing can be efficiently carried out on each of the first recording layer formed on the optical disk corresponding to the short wavelength and the second recording layer formed to a depth different from the first recording layer.

Since short wavelength light and long wavelength light incident from the beam splitter 7 is transmitted through the collimator lens 8, the collimator lens is made of glass or preferably a short wavelength-resistant resin (e.g. a resin which is not deteriorated by the short wavelength light or hardly deteriorated by the same). Short wavelength light or long wavelength light reflected from the optical disk 2 is also transmitted through the collimator lens 8.

Furthermore, the collimator lens 8 is caused to move by the drive member 8e to perform correction of the spherical aberration of the short wavelength light in the present embodiment. However, other configuration may be employed to move the collimator lens 8, and another means may be employed to adjust the spherical aberration of the short wavelength light.

Reference numeral 9 denotes a starting mirror. The starting mirror 9 is provided with a ¼ wavelength member 9a acting on the short wavelength light. As the ¼ wavelength member 9a, a ¼ wavelength plate is preferably used to rotate a polarization direction of the light transmitted two times (e.g. in the outward path and the homeward path) by about 90°. The ¼ wavelength member 9a is inserted into the starting mirror 9 in the present embodiment. A wavelength selection film 9b is formed at a surface where light emitted from each of the units 1 and 3 are incident in the starting mirror 9, and the wavelength selection film functions to reflect most of the long wavelength light emitted from the long wavelength optical unit 3 and transmit most of the short wavelength light emitted from the short wavelength optical unit 1.

Reference numeral 10 is an objective lens for long wavelength laser light, and the objective lens 10 focuses the light reflected from the starting mirror 9 onto the optical disk 2. The objective lens 10 is employed in the present embodiment. However, another focusing member such as a hologram may be employed instead. Furthermore, as a matter of course, the light reflected from the optical disk 2 is transmitted through the objective lens 10. The objective lens 10 is made of a material such as glass or resin.

Reference numeral 11 denotes an optical component provided between the objective lens 10 and the starting mirror 9, and the optical component 11 has an aperture filter for implementing a numerical aperture required to correspond to the optical disk 2 of DVD (light having a wavelength of about 660 nm) and CD (light having a wavelength of about 780 nm), a polarizing hologram responding to the light having a wavelength of about 660 nm, and an ¼ wavelength member (preferably, an ¼ polarization plate). The optical component 11 is composed of a dielectric multi-film or a diffraction lattice opening means. The polarizing hologram polarizes the light having a wavelength of about 660 nm (the polarizing hologram separates the light having a wavelength of about 660 nm into light fluxes for tracking error signals or light fluxes for focusing error signals). In addition, the ¼ wavelength member rotates the polarization direction of the homeward path with respect to the outward path of light having a wavelength of about 660 nm and about 780 nm by about 90°.

Reference numeral 12 denotes a starting mirror reflecting most of the short wavelength light. The starting mirror 12 is formed with a reflective film.

Reference numeral 13 denotes an objective lens. The objective lens 13 focuses the light reflected from the starting mirror 12 onto the optical disk 2. The objective lens 13 is employed in the present embodiment. However, another focusing member such as a hologram may be employed instead. Furthermore, as a matter of course, the light reflected from the optical disk 2 is transmitted through the objective lens 13. The objective lens 13 is made of a material such as glass or resin. When the objective lens is made of resin, it is preferably made of a short wavelength-resistant resin (e.g. a resin which is not deteriorated by the short wavelength light or hardly deteriorated by the same).

Reference numeral 14 denotes an achromatic diffraction lens provided between the objective lens 13 and the starting mirror 12, the achromatic diffraction lens 14 has a function of correcting chromatic aberration. The achromatic diffraction lens 14 is formed to deny and reduce the chromatic aberration occurring in each optical component through which the short wavelength light is transmitted. The achromatic diffraction lens 14 is basically configured such that a desired hologram is formed on the lens, and the degree of correction of the chromatic aberration can be determined by adjusting at least one of the lattice pitch of the hologram and the radius of curvature of the lens. The achromatic diffraction lens 14 is made of glass or resin such as plastic. When the resin is employed, it is preferably to form the lens with a short wavelength-resistant resin (e.g. a resin which is not deteriorated by the short wavelength light or hardly deteriorated by the same).

Hereinafter, a specific arrangement of the optical system configured as described above will be described with reference to FIG. 2.

FIG. 2 actually shows an implemented example of the optical structure shown in FIG. 1, and its shape is a little different from each member shown in FIG. 1. However, the function is almost the same as each other.

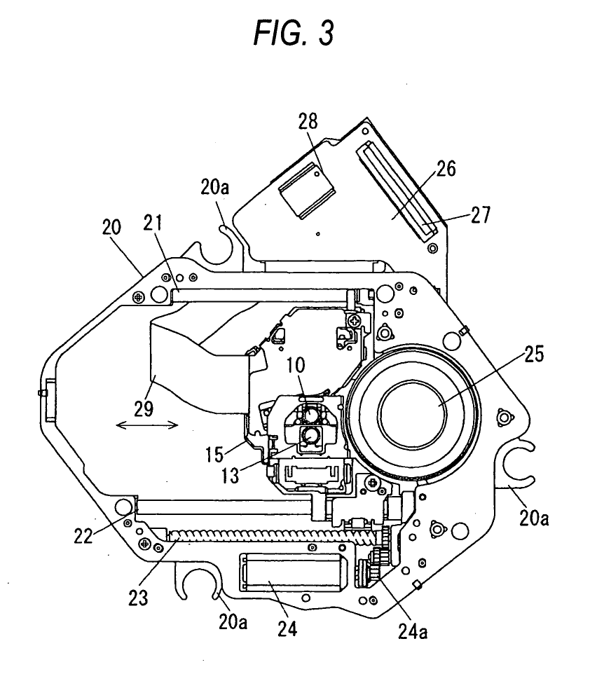

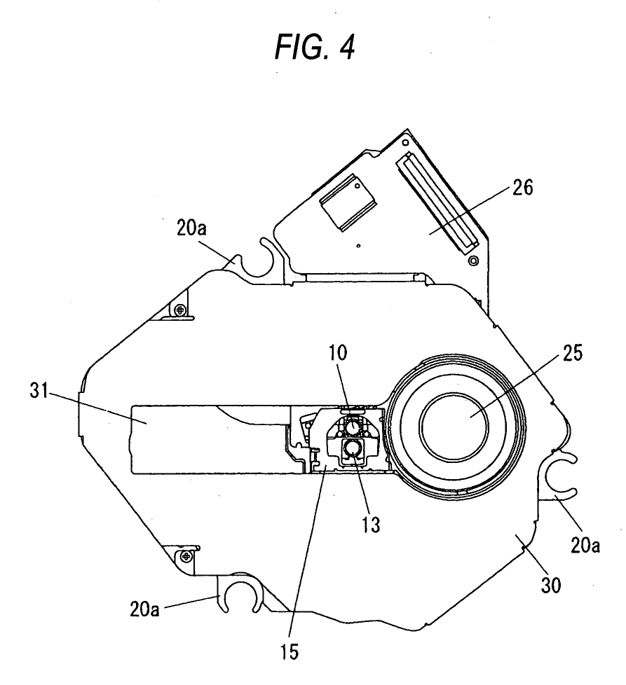

Reference numeral 15 denotes a base. The above-described members are fixed or movably attached to the base 15. The base 15 is made of metal such as zinc, zinc alloy, aluminum, aluminum alloy, titan, titan alloy, or metal alloys, and is preferably formed by a die-casting method in consideration of mass production. The base 15 is movably held with respect to the optical pickup module as shown in FIGS. 3 and 4.

Referring to FIGS. 3 and 4, reference numeral 20 denotes a frame. Shafts 21 and 22 disposed substantially parallel to each other are attached to the frame 20, and the base 15 is movably attached to the shafts 21 and 22. In addition, a screw shaft 23 having a helical groove is disposed substantially parallel to the shafts 21 and 22 and rotatably attached to the frame 20 at the side of the shaft 22 opposite to the shaft 21. Although not shown in detail, a member integrally or separately provided formed in the base 15 is engaged with a groove formed in the screw shaft 23. The screw shaft 23 is engaged with the gear group 24a rotatably provided in the frame 20, and this gear group 24a is engaged with a feed motor 24. Accordingly, when the feed motor 24 rotates, the gear group 24a rotates which in turn rotates the screw shaft 23, so that the base 15 can be reciprocated in the direction indicated by the arrow in FIG. 3. In this case, the feed motor 24 is disposed substantially parallel to the screw shaft 23 in the present embodiment. Furthermore, the optical disk 2 is mounted on the frame 20, and the spindle motor 25 for rotating the optical disk 2 is attached by means of screw fixation or adhesion.

In addition, as shown in FIG. 3, a control substrate 26 is formed separately from the frame 20. This control substrate 26 is electrically bonded to the base 15, for example, via the flexible substrate 29, and furthermore, the control substrate 26 is electrically connected to the spindle motor 25 by a member (not shown). The control substrate 26 is provided with a connector 27 for electrical connection to the control substrate provided in the optical disk. A flexible substrate is inserted into the connector 27 to establish an electrical connection.

In addition, as shown in FIG. 4, a frame cover 30 may be provided at least at the side of the frame 20 facing the optical disk for one purpose of protecting the members. A through-hole 31 is formed in the frame cover 30, and at least objective lenses 10 and 13 in the base 15 are exposed through the through-hole 31, and furthermore, the spindle motor 25 protrudes by a predetermined distance. In addition, referring to FIGS. 3 and 4, an attaching portion 20a for fixation to other member is formed in the frame 20, and a screw or the like is inserted into the attaching portion 20a to mount the frame 20 to other member.

Referring to FIG. 2, the short wavelength optical unit 1, the long wavelength optical unit 3, the beam-shaping lens 4, the optical component 5, the relay lens 6, the beam splitter 7, the supporting member 8a, the lead screw 8c, the gear group 8d, the drive member 8e, the starting mirrors 9 and 12, and so forth are attached to the base 15 by means of organic adhesive such as photocurable adhesive or epoxy-based adhesives, or metallic adhesive such as solder or lead-free solder or the like, or screw fixation, fitting, press fitting, and so forth.

In addition, the lead screw 8c and the gear group 8d are rotatably attached to the base 15.

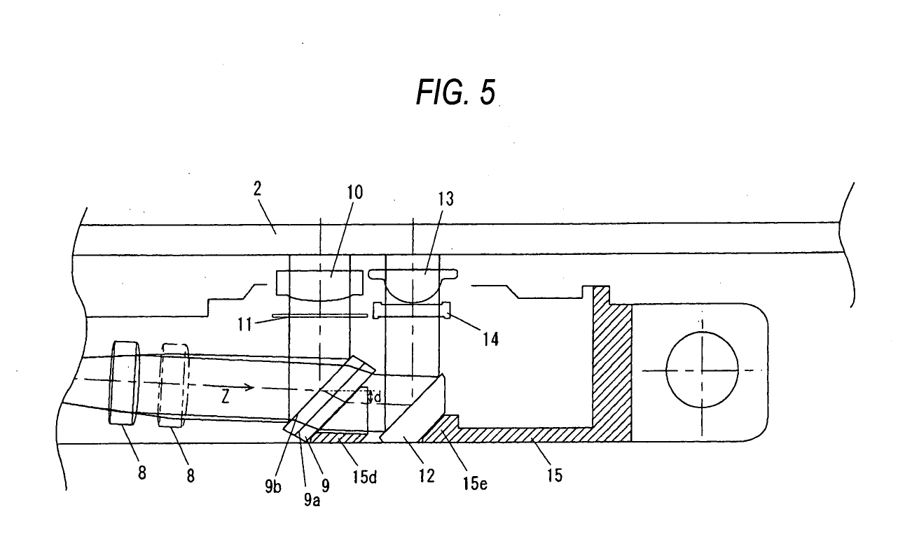

Reference numeral 17 denotes a suspension holder. The suspension holder 17 is attached to the base 15 by various bonding methods with a yoke member to be described below. The lens holder 16 and the suspension holder 17 are connected to each other by a plurality of suspensions 18. The lens holder 16 is supported so as to move in a predetermined range with respect to the base 15. The objective lenses 10 and 13, the optical component 11, the achromatic diffraction lens 14, and so forth are attached to the lens holder 16. The objective lenses 10 and 13, the optical component 11, and the achromatic diffraction lens 14 also move with the movement of the lens holder 16. As shown in FIG. 5, the starting mirrors 9 and 12 are attached to the protruding portions 15d and 15e formed in the base 15 by means of photocurable resins or instantaneous adhesive, respectively. When the starting mirror 9 is attached to the protruding portion 15d, the position of adhesion between the starting mirror 9 and the protruding portion 15d is considered so as not to shield light being transmitted through the starting mirror 9. Since the starting mirrors 9 and 12 are provided so as to be located below the lens holder 16, they are not shown in FIG. 2.

Since the starting mirror 9 is inclined with respect to the light flux transmitted through the collimator lens 8 or the beam splitter 7 emitted from the short wavelength optical unit 1, the light flux reaching from the short wavelength optical unit 1 is refracted when it is transmitted through the starting mirror 9, and is moved by a distance d as shown in FIG. 5 toward the direction away from the objective lenses 10 and 13.

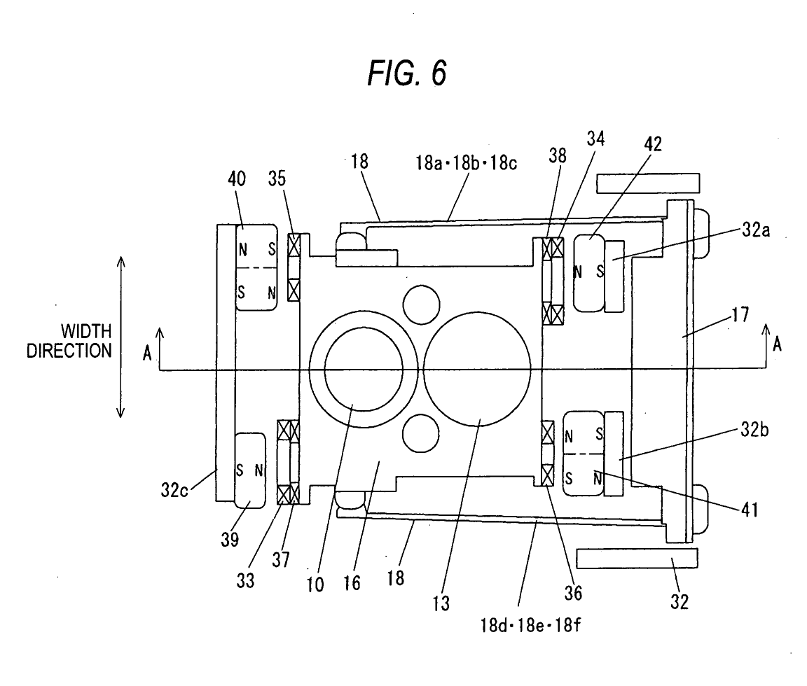

The objective lens 10 and the objective lens 13 having an axial thickness larger than the objective lens 10 are disposed in the order of the objective lens 10 and the objective lens 13 along the direction where light emitted from the short wavelength optical unit 1 or the long wavelength optical unit 3 and transmitted through the beam splitter 7 or the collimator lens 8 are propagating. In other words, the objective lens 13 and the objective lens 10 are disposed in this order from the side of the suspension holder 17 in the lens holder 16 as shown in FIG. 6.

Even when the lens holder 16 moves upward and downward when the objective lenses 10 and 13 are disposed as described above, the light flux is not shielded by the objective lens 13 or the achromatic diffraction lens 14, so that the optical pickup device can be made thin.

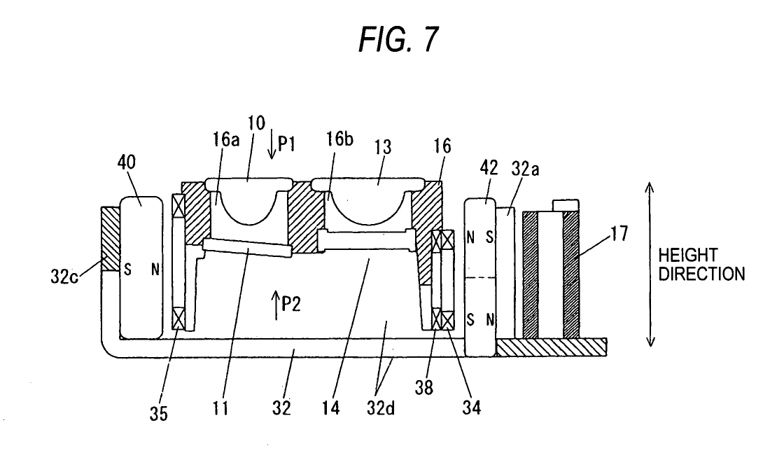

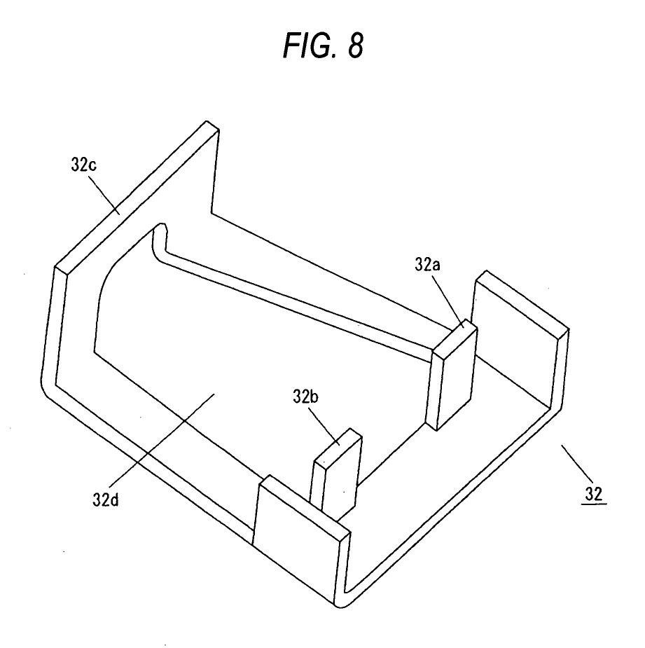

A structure around the lens holder 16 will be described with reference to FIGS. 6 to 8. In addition, FIG. 7 is a view illustrating a cross-section taken along the line A-A in FIG. 6 that shows the optical pickup device in the present embodiment.

As shown in FIG. 7, through-holes 16a and 16b are formed in the lens holder 16, and the objective lenses 10 and 13 are dropped into the through-holes 16a and 16b, respectively from the P1 direction shown in FIG. 7 and then fixed by means of photocurable adhesive or the like. In this case, peripheral edges of the objective lenses 10 and 13 abut on peripheral edges of the through-holes 16a and 16b of the lens holder 16. In addition, the optical component 11 and the achromatic diffraction lens 14 are inserted into the through-holes 16a and 16b, respectively, from the P2 direction in FIG. 7, and are also fixed by means of photocurable adhesive or instantaneous adhesive. Outer peripheral portions of the optical component 11 and achromatic diffraction lens 14 also abut on peripheral edges of the through-holes 16a and 16b of the lens holder 16.

As shown in FIG. 6, reference numerals 33 and 34 denote focusing coils which are wound in a substantially ring shape and are respectively provided at diagonally opposite positions of the lens holder 16. Reference numerals 35 and 36 denote tracking coils which are wound in a substantially ring shape and are provided at the other diagonally positions of the lens holder 16 different from the focusing coils 33 and 34. In addition, sub-tracking coils 37 and 38 are provided between the focusing coils 33 and 34 and the lens holder 16. The provision of the sub-tracking coils 37 and 38 can suppress unnecessary tilting of the lens holder 16 during tracking. The sub-tracking coils 37 and 38 may be bonded to the lens holder 16 by means of organic adhesive such as thermocurable adhesives, and then the focusing coils 33 and 34 may be bonded onto the sub-tracking coils 37 and 38 by means of adhesive, or a bonding structure in which the sub-tracking coil 37 and the focusing coil 33 are bonded to each other in advance may be bonded to the lens holder 16. Thermocurable adhesives are preferably used for bonding between the coils and the lens holder 16 or bonding between the coils. However, photocurable adhesive or other adhesive may be employed for the same. Also other methods may be employed for the bonding as long as predetermined positions between the coils and the lens holder 16 and between the coils can be ensured.

Three suspensions 18 are provided at each side so as to pinches the lens holder 16 therebetween, and the suspensions 18 elastically connect the suspension holder 17 to the lens holder 16, and at least the lens holder 16 can be displaced with respect to the suspension holder 17 in a predetermined range. In addition, in the present embodiment, three suspensions 18 are provided at each side so that the total number of suspensions is six. However, the number of the suspensions 18 may increase more (e.g. eight), or may decrease (e.g. four). In addition, three upper suspensions 18 are suspensions 18a, 18b, and 18c from the side facing the optical disk 2 in FIG. 6, respectively, and three lower suspensions 18 are suspensions 18d, 18e, and 18f from the side facing the optical disk 2 in FIG. 6 for simplicity of description. Both ends of the suspensions 18 are fixed to the lens holder 16 and the suspension holder 17, respectively by means of insert molding.

Hereinafter, an example of interconnections between respective coils provided in the lens holder 16 and the suspension 18 will be described. That is, each coil provided in the lens holder 16 allows a current to flow through the suspension 18.

Both ends of the focusing coil 33 are electrically connected to the suspensions 18a and 18b, respectively, and both ends of the focusing coil 34 are electrically connected to the suspensions 18d and 18e, respectively. In addition, the tracking coil 35, the sub-tracking coil 37, the tracking coil 36, and the sub-tracking coil 38 are serially connected, and one of both ends of the serially connected coil group is connected to the suspension 18c, and the other end is connected to the suspension 18f. An end of each coil and the suspension 18 are electrically connected by metallic adhesive such as solder or lead-free solder.

The suspension 18 may be made of a wire having a substantially circular or substantially elliptical cross-section, or may be made of a wire in the shape of a polygon such as a rectangle in cross-section, or a leaf spring may be processed to be used as the suspension 18. The suspension 18 has a substantially truncated chevron shape when seen from an exit direction of light of the objective lenses 10 and 13 with the suspension holder 17 downward, and a tension is applied thereto. This allows miniaturization and a reduction in resonance of the suspension 18 in its buckling direction.

Reference numeral 32 denotes a yoke member made of Fe or Fe alloys which are readily capable of constituting a magnetic circuit, and standing members 32a, 32b, and 32c facing the respective coils provided in the lens holder 16 are integrally formed with the yoke member 32 by cutting and bending or the like. In addition, an opening 32d is formed at a lower surface of the yoke member 32, and the starting mirrors 9 and 12 fixed to the base 15 are inserted through the opening 32d. In addition, the suspension holder 17 is fixed onto the yoke member 32 by means of adhesion or the like, and the yoke member 32 is also bonded to the base 15 by means of adhesion or the like.

Reference numerals 29 to 42 are magnets provided on the yoke member 32 by means of adhesion or the like.

The magnet 39 is attached to the standing member 32c and is also provided to face the focusing coil 33 and the sub-tracking coil 37. In addition, the magnet 39 is polarized so that its magnetic poles are exposed to a surface facing the sub-tracking coil 37 and the focusing coil 33 in the order of S pole and N pole toward the objective lenses 10 and 13 from its bottom surface in the height direction shown in FIG. 7, and is disposed in the yoke member 32.

The magnet 40 is attached to a portion of the standing member 32c opposite to the side on which the magnet 39 is attached in the width direction shown in FIG. 6, and is provided to face the tracking coil 35. In addition, in the present embodiment, the standing member 32c is widely formed in the width direction shown in FIG. 6 so as to increase the rigidity of the yoke member 32. However, the standing member 32c may be split into two parts so that the magnet 39 may be attached to one of the two parts and the magnet 40 may be attached to the other by means of adhesion or the like. In addition, the magnet 40 is polarized so that its magnetic poles are exposed to a surface facing the tracking coil 35 in the order of N pole and S pole from its inner side in the width direction shown in FIG. 6, and is disposed in the yoke member 32.

The magnet 41 is attached to the standing member 32b, and is polarized so that its magnetic poles are exposed to a surface facing the tracking coil 36 in the order of N pole and S pole from its inner side in the width direction shown in FIG. 6, and is disposed in the yoke member 32.

The magnet 42 is attached to the standing member 32a, and is provided to face the focusing coil 34 and the sub-tracking coil 38. In addition, the magnet 42 is polarized so that its magnetic poles are exposed to a surface facing the focusing coil 34 and the sub-tracking coil 38 in the order of S pole and N pole toward the objective lenses 10 and 13 from its bottom surface in the height direction shown in FIG. 7, and is disposed in the yoke member 32.

Hereinafter, respective parts will be described in detail.

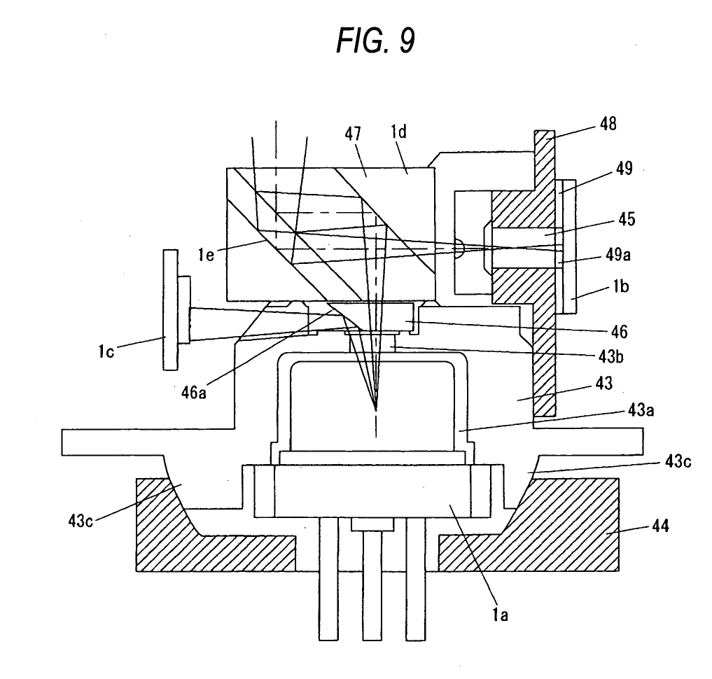

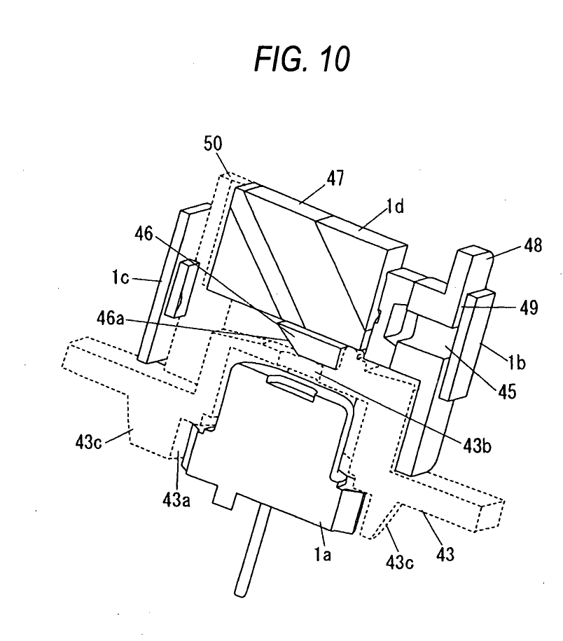

First, the short wavelength optical unit 1 will be described with reference to FIGS. 9 and 10. In addition, FIG. 9 clearly shows the arrangement relationship between the respective portions, and FIG. 10 show a cross-sectional view of the actual short wavelength optical unit 1.

At least the light source 1a, the light-receiving portion 1b, the light-receiving portion 1c, and the optical member 1d are provided in a placing portion 43 in a direct or indirect manner. In addition, a rear end of the placing portion 43 is attached to the holding member 44. A attaching portion 43c of the placing portion 43 with the holding member 44 is bent in a convex shape, and similarly, a mounting portion of the holding member 44 with the placing portion 43 is also bent in a convex shape. The placing portion 43 is combined with the holding member 44, and their positions are determined to be desired ones by making the respective bent portions slid on each other, and organic adhesive or metallic adhesive such as solder is then used to fix them together.

A light source receiving portion 43a is formed in the placing portion 43 to receive at least a portion of the light source 1a, and after the light source 1a is received in the light source receiving portion 43a, a bonding material is used to prevent the light source la from being dropped out of the light source receiving portion 43a. In addition, a through-hole 43b communicating with the light source receiving portion 43a is formed at a portion of the light source 1 a facing the light emission portion, and light emitted from the light source 1a passes through the through-hole 43b to be guided to the optical member 1d. As will be described in detail, the optical member 1d has an optical portion 46 having an inclined surface 43a and an optical portion 47 having a plurality of inclined surfaces therein. A light-receiving-portion attaching portion 48 facing the optical member 1d is integrally formed in the placing portion 43, and a through-hole 45 is formed in the light-receiving-portion attaching portion 48. The light-receiving portion 1b is attached to a portion of the light-receiving-portion attaching portion 48 opposite to the optical member 1d via a flexible printed substrate 49 by means of adhesion or the like. The flexible printed substrate 49 is omitted and described in FIG. 9 or FIG. 10, but it electrically connects the light-receiving portion 1b with other members and has a through-hole 49a formed therein. Light emitted from the optical member 1d is guided to the light-receiving portion 1b via the through-holes 45 and 49a. In addition, as clear from FIG. 10, the light-receiving-portion attaching portion 50 is integrally formed in the placing portion 43 so as to face the light-receiving-portion attaching portion 48, and the optical member 1d is disposed between the light-receiving-portion attaching portions 48 and 50. Although not shown, a through-hole is formed in the light-receiving-portion attaching portion 50, and the light-receiving portion 1c is attached to the light-receiving-portion attaching portion 50 by means of adhesion or the like. Light emitted from the optical portion 46 are guided to the light-receiving portion 1c via the through-hole of the light-receiving-portion attaching portion 50.

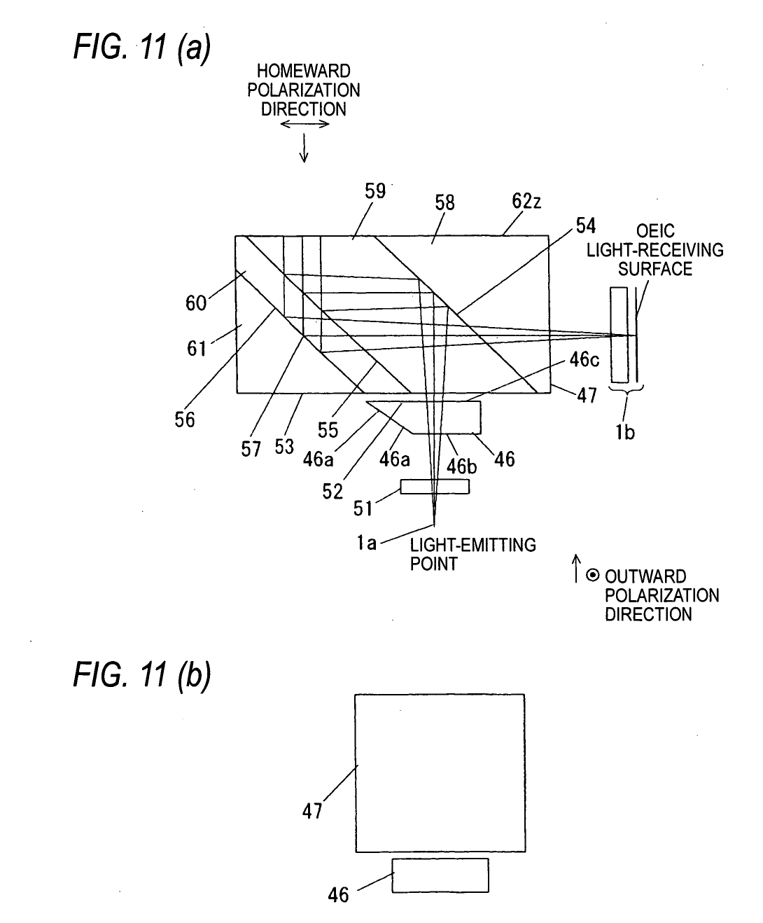

Next, optical portions 46 and 47 of the optical member 1d will be described in detail with reference to FIG. 11.

Short wavelength light emitted from an emitting point of the light source 1a is guided to the optical portion 46 via the cover glass 51 serving as an emission window of the light of the light source 1a. Light incident on the plane 46b formed substantially parallel to the cover glass 51 of the optical portion 46 is transmitted through the optical portion 46, and light incident on the inclined surface 46a inclined with respect to the plane 46b is reflected to be incident on the light-receiving portion 1c (not shown in FIG. 11), and are used for monitoring light output. A reflecting portion such as a dielectric multi-film or a metal film is formed on the inclined surface 46a. Most of the light transmitted through the optical portion 46 is transmitted through the plane 46c formed substantially parallel to the plane 46b to be guided to the optical portion 47. In this case, although not shown, a photochromic filter is formed in the plane 46c, and light sensed by the photochromic filter is guided to the optical portion 47. The transmittance of the photochromic filter varies, but the transmittance is adjusted by a divergence angle of the light emitted from the light source 1a. That is, the transmittance of the photochromic filter is made low when the divergence angle of the light emitted from the light source 1a is large, and the transmittance of the photochromic filter is made high when the divergence angle of the light emitted from the light source 1a is small. By adjusting the transmittance of the photochromic filter with the divergence angle of the light emitted from the light source 1a, data can be prevented from being erased due to excessive strong output of light at the time of carrying out recording or reproduction on a single layer disk or a multi-film disk. Specifically, the divergence angle of the light emitted from the light source 1a is classified in every predetermined range in advance, and a photochromic filter having a different transmittance for each classified light source 1 is formed, so that good recording and reproducing characteristics for the optical disk can be obtained. In a case where the photochromic filter is composed of a dielectric multi-film or a metal film to adjust the transmittance, its constitutional material, a film structure, or a film thickness can be adjusted when the dielectric multi-film is employed, and a constitutional material or the thickness of the metal film can be adjusted when the metal film is employed.

Light transmitted through the plane 46c is incident on the optical portion 47. In this case, a predetermined gap is formed between the optical portions 46 and 47. The optical portion 47 has a substantially rectangular shape as a whole, and a light-absorbing film having a function of absorbing light is formed in the bottom surface 53 where the light from the light source 1a is incident except a predetermined region. This prevents the light emitted from the light source la from being incident on the optical portion 47 from positions other than the predetermined region. At least a portion of the light emitted from the light source 1a and transmitted through the optical portion 46 is incident into the optical portion 47 from one portion where the absorbing film is not disposed at the bottom surface 53.

The optical portion 47 is composed of blocks 58 to 61 which are made of transparent glass and bonded to each other, and an inclined surface 54 is formed at the bonding portion between the block 58 and the block 59, an inclined surface 55 is formed between the block 59 and the block 60, and an inclined surface 56 is formed between the block 60 and the block 61. At least the inclined surfaces 54, 55, and 56 are formed inside the optical portion 47, and ends of the inclined surfaces 54, 55, and 56 are exposed to a surface of the optical portion 47. A first polarization beam splitter is provided in the inclined surface 54, and a second polarization beam splitter is provided in the inclined surface 55 in the same manner. The first and second polarization beam splitters are provided directly in the block 59. However, the first polarization beam splitter may be provided in the block 58 while the second polarization beam splitter may be provided in the block 60. Both the first and second polarization beam splitters allow light of p polarization (hereinafter, referred to as a P wave) to be transmitted, and allow light of s polarization (hereinafter, referred to as an S wave) to be reflected. In addition, at least the first and second beam splitters are provided at the portions through which light is transmitted in the optical portion 47. However, they are formed in the entire surfaces of the inclined surfaces 54 and 55 in consideration of the productivity in the present embodiment. A reflective film and a hologram 57 (same as the hologram le shown in FIG. 1) causing astigmatism are formed in the inclined surface 56.

Light transmitted through the bottom surface of the optical portion 47 from the light source 1a to be incident on the optical portion 47 is S waves, and is reflected by the first polarization beam splitter provided in the inclined surface 54, and is incident on the second polarization beam splitter provided in the inclined surface 55. Since the second polarization beam splitter also reflects the S waves as described above, the light incident on the second polarization beam splitter is reflected and emitted from the top surface 62z of the optical portion 47, then transmitted through the above respective members to be guided to the optical disk 2. Further, the light reflected from the optical disk 2 is converted to P waves by an action of the ¼ wavelength member 9a and is incident on the optical portion 47 from the top surface 62z of the optical portion 47 again. In this case, a portion where light is emitted toward the optical disk 2 from the optical portion 47 and a portion where the light reflected from the optical disk 2 is incident are at almost the same position. Since the light reflected from the optical disk 2 and returned to the optical portion 47 are P waves as descried above, it is transmitted by the second polarization beam splitter provided in the inclined surface 55 to be incident on the inclined surface 56. A reflective hologram 57 causing astigmatism is formed in the inclined surface 56. The light reflected from the optical disk 2 is separated in a predetermined direction by using the hologram 57 so as to obtain focusing error signals. Since the light reflected from the inclined surface 56 is P waves, it is transmitted through the second polarization beam splitter again, then transmitted through the block 59 and transmitted through the first polarization beam splitter to pass through the block 58 because the first polarization beam splitter also has a property of allowing the P wave to be transmitted through, then emitted outside the optical portion 47, and then incident on the light-receiving portion 1b.

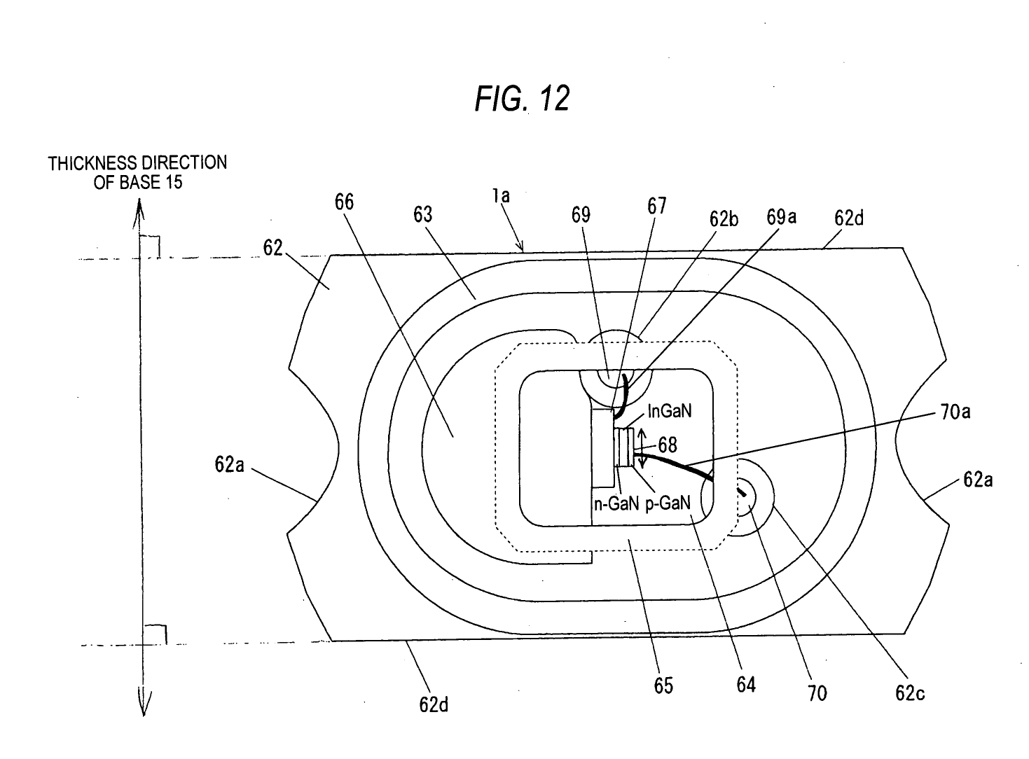

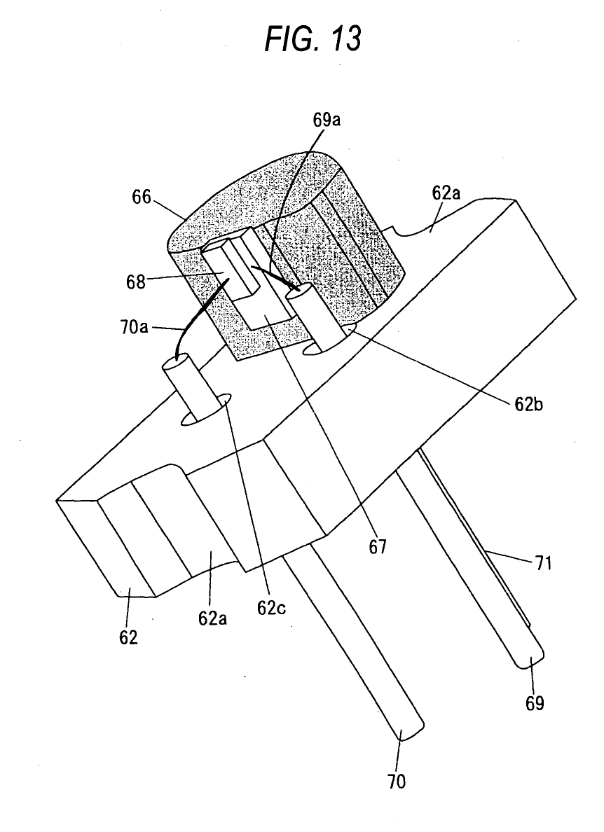

Next, an example of the light source 1a will be described with reference to FIGS. 12 and 13.

As shown in FIGS. 12 and 13, the light source 1a has the following members. First, the light source has a base 62 made of a metal material, and concave portions 62a used for positional adjustment of the light source 1a are formed at short sides of the base 62. In addition, through-holes 62b and 62c are formed. In addition, although not shown in the drawing, a through-hole other than the through-holes 62b and 62c is formed. A cover member 63 is bonded to the base 62 by means of soldering or welding, and a rectangular through-hole 64 is formed on a ceiling surface of the cover member 63, and a cover glass 65 (same as the cover glass 51 in FIG. 11 ) is attached by means of adhesion or the like so as to cover the through-hole 64. The cross-section of the cover glass 63 is elliptical or oblong. In addition, a good thermal conductive block 66 such as copper or copper alloy is formed in a region surrounded by the base 62 and the cover member 63, and the block 66 is bonded to the base 62 by means of welding or a metallic bonding material. The cross-section of the block 66 is substantially semi-circular. A semiconductor laser element 68 is formed in a flat portion of the block 66 via the sub-mount 67 made of a metal material. Accordingly, the sub-mount 67 and the semiconductor laser element 68 together with the block 66 are disposed in the region surrounded by the base 62 and the cover member 63. In addition, a light emitting surface of the semiconductor laser element 68 is disposed to face the cover glass 65, and light is emitted outward from the cover glass 65. Rod-shaped terminals 69, 70, and 71 are inserted into the through-holes 62b and 62c formed in the base 62 and the other through-hole, respectively, and portions inserted into the through-holes 62b and 62c and the other through-hole of the terminals 69, 70, and 71 are attached to the base 62 via an insulating material so as to keep an insulation between the base 62 and the terminals 69, 70, and 71. Leading portions of the terminals 69, 70, and 71 are connected to the base 62 by means of a gold line 69a, and the terminal 69 is electrically conductive with the n-type gallium nitride of the semiconductor laser element 68 via the sub-mount 68. In addition, the terminal 70 is electrically conductive with the p-type gallium nitride of the semiconductor laser element 68 by means of the gold line 59a. Accordingly, power is supplied to the semiconductor laser element 68 via the terminals 69, 70, and 81, and short wavelength light is emitted therefrom.

A gallium nitride semiconductor laser element in which an active layer (e.g. a gallium nitride having an emitting center such as In) is formed between the p-type gallium nitride and the n-type gallium nitride as described above is preferably employed as the semiconductor laser element 68m, and emits light having a wavelength of 400 nm to 415 nm. As a matter of course, a semiconductor laser element made of another material emitting another short wavelength laser light may be employed.

The semiconductor laser element 68 has a rectangular parallelepiped cross-section, and is configured to have the p-type gallium nitride, the n-type gallium nitride, and the active layer laminated substantially parallel to the along a long-side direction X. In this case, an n-type gallium nitride, an active layer, and a p-type gallium nitride are sequentially laminated in this order from the side of the sub-mount 67 as the semiconductor laser element 68. However, a reverse order of the p-type gallium nitride, the active layer, and the n-type gallium nitride may be employed from the side of the sub-mount 67. In any cases, a laminated direction of the active layer of the semiconductor layer element 68 is in a non-parallel relation with the long side 62d of the base 62 (they cross each other vertically in the present embodiment). In addition, since the base 62 is attached to the base 15 such that the long side 62d is substantially vertical to the thickness direction of the base 15, the active layer of the semiconductor laser element 68 is laminated substantially parallel to the thickness direction of the base 15. In this case, in order to efficiently use the short wavelength laser when the long side 62d of the base 62 is attached substantially vertically to the thickness direction of the base 15 for making the optical disk apparatus thin, the laminated direction of the semiconductor laser element 68 only needs to be substantially parallel to the thickness direction of the base 15.

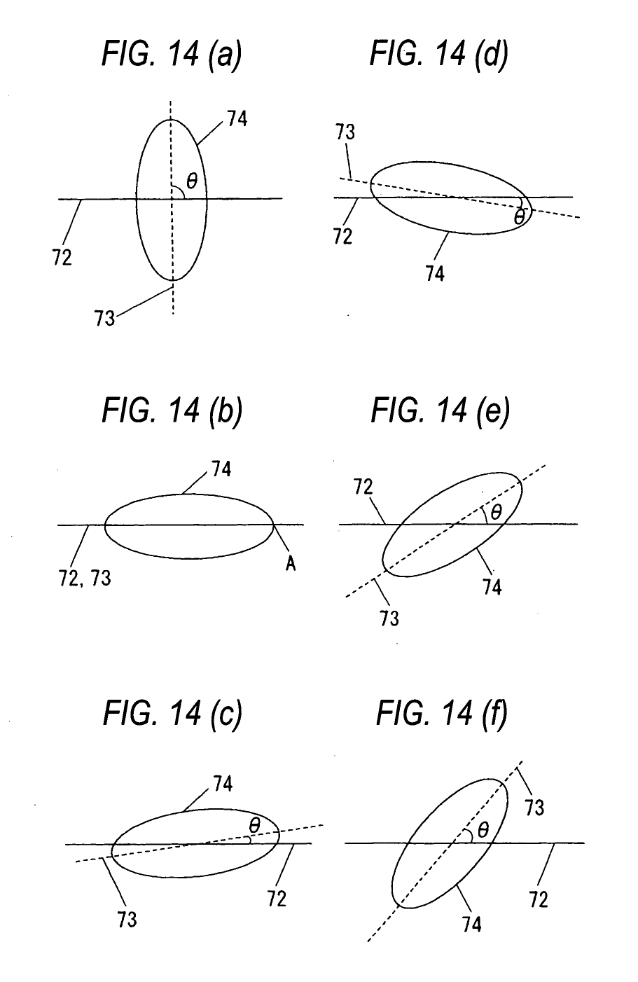

In this case, the relation between the base 62 and the semiconductor laser element 68 will be more specifically described. Since a long side of a rectangular cross-section is bonded to the sub-mount 67, the long side 62d of the base 62 and the long-side direction X of a rectangular cross-section of the semiconductor laser element 68 are in non-parallel relation (they cross each other vertically in the present embodiment). This structure allows the light emitted from the semiconductor laser element 68 to be emitted so that the major axis of the intensity distribution of the substantially elliptical radiating light is substantially parallel to the long side 62d of the base 62. For example, as shown in FIG. 14, reference numeral 72 denotes an axis substantially parallel to the long side 62d of the base 62, 74 denotes the intensity distribution of the light emitted from the semiconductor laser element 68 and an outline of the light represented by a constant intensity line, 73 denotes a substantially elliptical major axis of the outline 74 of the emitted light, and an angle θ crossed between the axis 72 and the major axis 73 is 90° as shown in FIG. 14A. However, the angle θ crossed between the axis 72 and the major axis 73 is not 90° as shown in FIGS. 14B and 14C in the present embodiment. In addition, the angle θ is defined as a minimum angle crossed between the axis 72 and the major axis 73. That is, the angle θ is in a range of 0° to 90°. That is, the axis 72 and the major axis 73 are parallel to each other as shown in FIG. 14B, and the axis 72 and the major axis 73 has a predetermined crossed angle θ as shown in FIGS. 14B to 14F. In this case, the crossed angle θ is preferably 0° to 45°, and more preferably 0° to 30°, and is furthermore preferably 0° to 15°. As a matter of course, most preferably, the crossed angle between the axis 72 and the major axis 73 is substantially parallel to each other as shown in FIG. 14B (the angle θ is about 0°). In addition, the axis 72 is made parallel to the long side 62d of the base 62 in the present example. However, this axis 72 may be defined in a relation with another constitutional member as described below. That is, the axis 72 may be defined as one which is parallel to the main surface of the mounted optical disk 2 and vertical to the direction of light emitted from the cover glass 65 of the light source 1a, may be defined as one which is vertical to the thickness direction of the base 15 and vertical to a direction of light emitted from the cover glass 65 of the light source 1a, or may be defined as one which is parallel to a bottom surface of the base 15 and vertical to a direction of light emitted from the cover glass 65 of the light source 1a. Furthermore, the axis 72 may be defined as an axis vertical to the rotational axis of the spindle motor 25 and also vertical to the direction of light emitted from the cover glass 65 of the light source 1a.

As such, by disposing the major axis as described above in the outer wheel of light emitted from the light source 1a, an efficiency of using the light can be enhanced, and light having a bigger output can be irradiated on the optical disk 2 when the light source 1a having the same output is used, and the light source 1a having a smaller output can be employed when the intensity of the light irradiated onto the optical disk 2 is made the same.

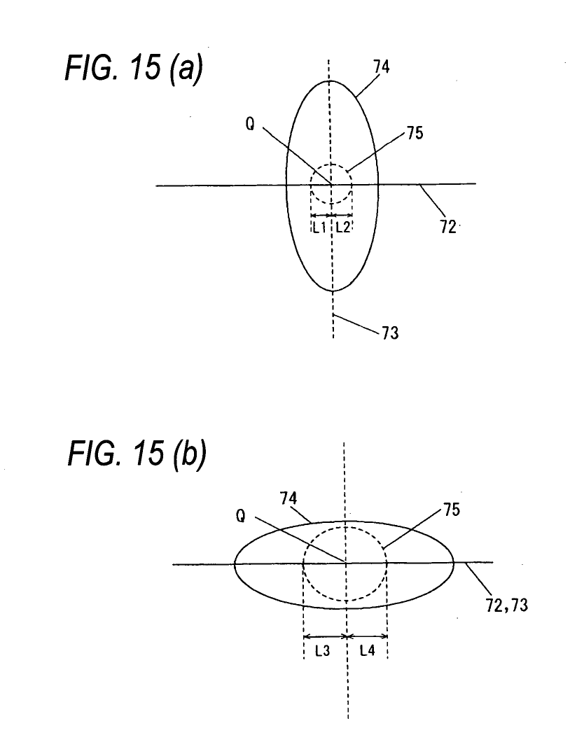

Hereinafter, the principle will be described in detail with reference to FIG. 15.

FIG. 15A shows a case where the axis 72 and the major axis 73 vertically cross each other, that is, shows an elliptical shape in the longitudinal direction. In this case, when the amount of light at the center Q (where the major axis and the minor axis cross each other) of the outline 74 of light is set to one in a direction along the axis 72, the light within a region up to a predetermined ratio of amount of light is used. That is, the predetermined ratio is 0.6 in the present embodiment (this ratio is determined according to the specification, and is typically 0.3 to 0.8), and the light within a circular region away from the center Q by the distances L1 and L2 to the right and left, that is, within the circular region 75 having a diameter of L1+L2 are used in the present embodiment. Since the distance is approximately equal to the distance L2 (L1≅L2) in the present embodiment, the region of light to be actually used becomes the circular region 75 having a radius of L1 or L2. Since the outline is long in the longitudinal direction in FIG. 15A, the distances L1 and L2 having the amount of light of 0.6 at the center Q from the center Q become relatively shorter. Thus, the available region of amount of light is very small. Alternatively, light ranging up to the region having a predetermined ratio of light amount are used in the most preferred embodiment shown in FIG. 15B. That is, in the present embodiment, the predetermined ratio is 0.6 (this ratio is determined according to the specification, and is typically 0.3 to 0.8), and a circular region away from the center Q by the distances L3 and L4 to the right and left, that is, the light of the circular region 75 having a diameter L3+L4 are used in the present embodiment. As the distance L3 is approximately equal to the distance L4 (L3≅L4) (in the present embodiment, the region of light to be actually used becomes the circular region 75 having a radius of L3 or L4. Since the outline 74 of light is long in the transverse direction FIG. 15B, the distances L3 and L4 having the amount of light of 0.6 at the center Q from the center Q become relatively longer. Thus the available region of amount of light significantly increased as compared to the case of FIG. 15A, so that the light can be efficiently utilized. That is, L1<L3 and L2<L4.

In the present embodiment, a structure in which the major axis 73 of the substantially elliptical light emitted from the light source 1a as described above is not made a right angle but made a predetermined angle θ with respect to the axis 72, may be applied to the structure that the long side 62d of the base 62 is attached to the base 15 as shown in FIGS. 12 and 13. Thereby the major axis of the elliptical light emitted from the light source 1a can be made substantially parallel to the base 15 as described above, and the height of the light source 1a does not increase so that the device can be made small-sized. In addition, in the optical disk apparatus of 18 mm or less, preferably 15 mm or less, and more preferably 13 mm or less assumed in the present embodiment, the light source 1a is attached at a low position, which is preferable in implementing the optical disk apparatus. In addition, when the axis 72 and the major axis 83 forms a predetermined angle (greater than 0° and less than 90°), which can be implemented by rotating and mounting the light source 1a itself by a predetermined angle (in this case, the mounting height when the light source 1a is attached increases a little), or by rotating the block 66 of the light source 1a by a predetermined amount and mounting it on the base 62, or by mounting the semiconductor laser element 68 on the block 66 so as to incline with respect to the long side 62d.

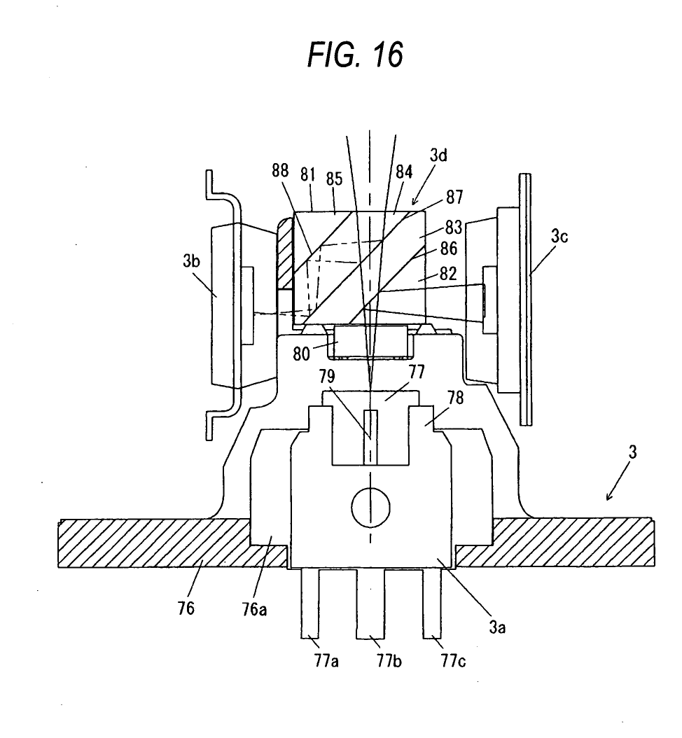

Next, the long wavelength optical unit 3 will be described with reference to FIG. 16.

A light source holding portion 76a is formed in the placing portion 76, and the light source 3a is bonded to the light source holding portion 76a by means of soldering, lead-lead-free soldering, or a bonding material such as a photocurable resin, and the optical member 3d is attached to the light source holding portion 76a of the placing portion 76. In addition, the light-receiving portions 3b and 3c are attached to the placing portion 76 by means of a bonding material such as a photocurable resin so as to pinch the optical member 3d therebetween. The light source 3a covers at least a portion of the lead frame 77 with a mold member 78 such as a resin, and the semiconductor laser element 79 is attached to the lead frame 77. Terminals 77a to 77c are electrically connected to the lead frame 77. The semiconductor laser element 79 is configured to have emitting light with a wavelength of 640 nm to 800 nm and is adapted to emit light having one type of wavelength one time or emit light having several types of wavelengths several times. In the present embodiment, the semiconductor laser element is adapted to emit a light flux having a wavelength of about 660 nm (red color: corresponding to DVD) and a light flux having a wavelength of about 780 nm (infrared color: corresponding to CD). The semiconductor laser element 79 is adapted to emit two light fluxes by means of elements of mono block in the present embodiment. However, the elements emitting one light flux with one block may be formed on the plural lead frames 77.

The optical member 3d is composed of two optical portions 80 and 81, and the optical portion 80 has a plate shape, and a film (not shown) preventing stray light from occurring is formed, which serves to make unnecessary light emitted from the light source 3a not reach the optical portion 81. That is, the film is configured such that an opening is formed in the film preventing the stray light from occurring, a main portion of the light is guided to the optical portion 81 via the opening, and is made of a material that absorbs light incident on the portions except the opening. In addition, a hologram having wavelength selectivity responding to light of CD and not easily responding to light of DVD is formed, and this hologram enables the light of CD to be separated into three beams. The optical portion 81 is formed on the optical portion 80, and the optical portion 81 is configured such that blocks 82 to 85 made of transparent glass are bonded to each other, and an inclined surface 86 is formed at a bonded portion between the block 82 and the block 83, an inclined surface 87 is formed between the blocks 83 and 84, and an inclined surface 88 is formed between the blocks 84 and 85. At least the inclined surfaces 86, 87, and 88 are formed inside the optical portion 81, and ends of the inclined surfaces 86, 87, and 88 are exposed to a surface of the optical portion 81.

The inclined surface 86 is formed with at least one of the hologram and the reflective film at a portion of its light-transmitting portion so as to make 3 to 15% of light emitted from the light source 3a reflected, and is formed with a dielectric multi-film transmitting P waves of light corresponding to CD and DVD and reflecting S waves. Light reflected in the inclined surface 86 is incident on the light-receiving portion 3c to be used to control the output of light of the light source 3a. In addition, a dielectric multi-film transmitting P waves of light corresponding to CD and DVD and reflecting S waves of light corresponding to CD and transmitting S waves of light corresponding to DVD is formed in the inclined surface 87. In addition, a dielectric multi-film or a metal film having a reflecting property is formed in the inclined surface 88. In addition, a reflective hologram 3e is formed in the inclined surface 88 in the present embodiment.

Stray light of light emitted from the light source 3a and corresponding to CD, when incident on the optical portion 80, is removed and separated by a hologram having wavelength selectivity, which become beams on the optical disk 2. In addition, when the light is incident on the optical portion 81 from the optical portion 80, a portion of the light is reflected in the inclined surface 88 to be incident on the light-receiving portion 3c, and the other light, P waves, passes through the inclined surface 86 to be incident on the block 83, and then guided to the inclined surface 87. Light as P waves corresponding to CD passes through the block 84 to be emitted from a top surface of the block 84 in the inclined surface 87. In addition, the light reflected from the optical disk 2 is S waves because of the action of the ¼ wavelength member of the optical component 11, then incident on the top surface of the block 84 again and incident on the inclined surface 87. Since a film having a reflective property of reflecting the S waves of light corresponding to CD is formed in the inclined surface 87, the light corresponding to CD reflected from the optical disk 2 is reflected in the inclined surface 87, then reflected in the inclined surface 88, and transmitted through the block 34 to be incident on the inclined surface 87 again. As described above, since the film having a reflective property of reflecting the S waves of light corresponding to CD is formed in the inclined surface 87, the light is reflected in the inclined surface 87 again, and transmitted through the block 84 to be guided to the light-receiving portion 3b. The light incident on the light-receiving portion 3b is converted to electrical signals, and RF signals, tracking error signals, focusing error signals or the like are generated. In addition, by means of the reflective hologram 3e formed in the inclined surface 88, the light reflected from the optical disk 2 is separated into several beams, and guided to a predetermined location of the light-receiving portion 3b, respectively, thereby generating the focusing error signals.

Stray light of light emitted from the light source 3a and corresponding to DVD, when incident on the optical portion 80, are removed and incident on the optical portion 81. The hologram having wavelength selectivity formed in the optical portion 80 does not react to the light corresponding to DVD. In addition, when the light is incident on the optical portion 81 from the optical portion 80, a portion of the light is reflected in the inclined surface 86 to be incident on the light-receiving portion 3c, and the other light is transmitted through the inclined surface 86 to be incident on the block 83 and guided to the inclined surface 87. Since the light corresponding to DVD is P waves in the inclined surface 87, it is transmitted through the block 84 and emitted from a top surface of the block 84. In addition, the light reflected from the optical disk 2 becomes S waves and then incident on the top surface of the block 84 again, and then incident on the inclined surface 87. Since a film having a property of transmitting the light corresponding to DVD is formed in the inclined surface 87, the light reflected from the optical disk 2 and corresponding to DVD is transmitted through the inclined surface 87, and then transmitted through the block 83 again to be incident on the inclined surface 86. Since the inclined surface 86 reflects the light of S waves corresponding to DVD, the light corresponding to DVD is reflected and is transmitted through the block 83 to be guided to the inclined surface 87 again. However, a film allowing the light corresponding to DVD to be transmitted is formed in the inclined surface 87 as described above. Thus the light is guided to the light-receiving portion 3b via the inclined surface 87. The light incident on the light-receiving portion 3b is converted to electrical signals, and RF signal, tracking error signals, focusing error signals or the like are generated.

In addition, FIG. 16 shows a homeward and outward optical path corresponding to CD.

Next, the beam shaping splitter 4 used in the present embodiment will be described.

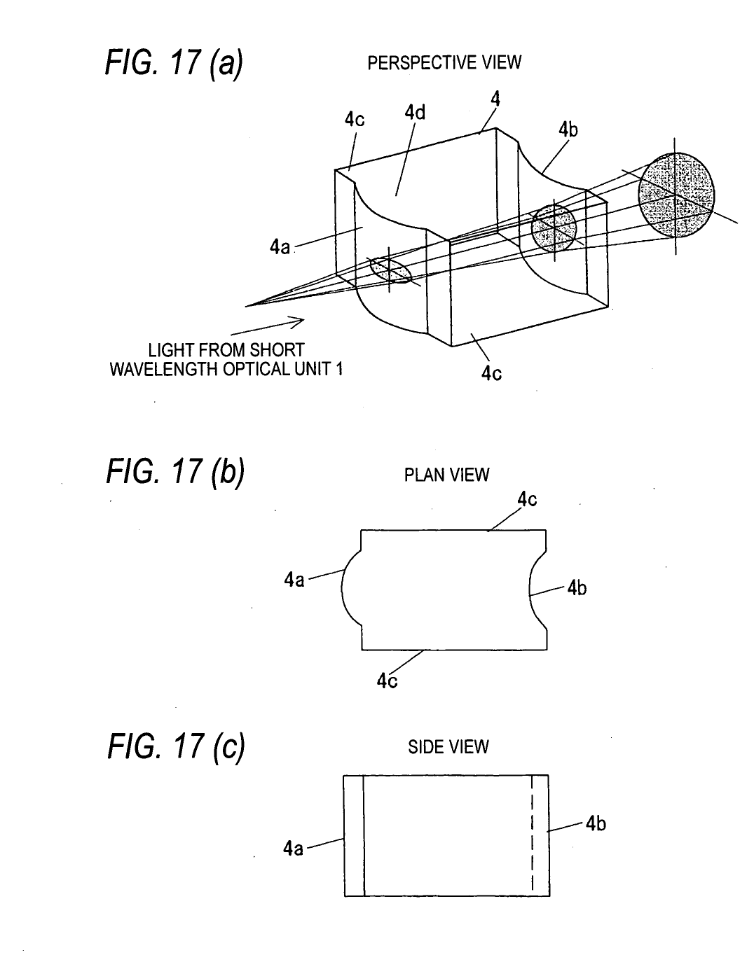

The beam shaping splitter 4 includes a light-transmitting portion 4d having a convex portion 4a and a concave portion 4b, and a mounting portion 4c formed so as to pinch the light-transmitting portion 4d as shown in FIG. 17, and the light-transmitting portion 4d and the mounting portion 4c are integrally formed in the present embodiment. However, they may be separately formed and then bonded to each other by means of adhesive or the like.

As shown in FIG. 17A, short wavelength light emitted from the short wavelength optical unit 1 have an elliptical shape immediately before it is incident on the beam shaping splitter 4, but have a substantially circular shape after it is transmitted through the beam shaping splitter 4 by adjusting the radius of curvature or a predetermined curved surface of the convex portion 4a or the concave portion 4b. Similarly, the light reflected from the optical disk 2 has a substantially elliptical shape from circular light by being transmitted through the beam shaping splitter 4.

Next, the optical component 5 used in the present embodiment will be described with reference to FIG. 15.

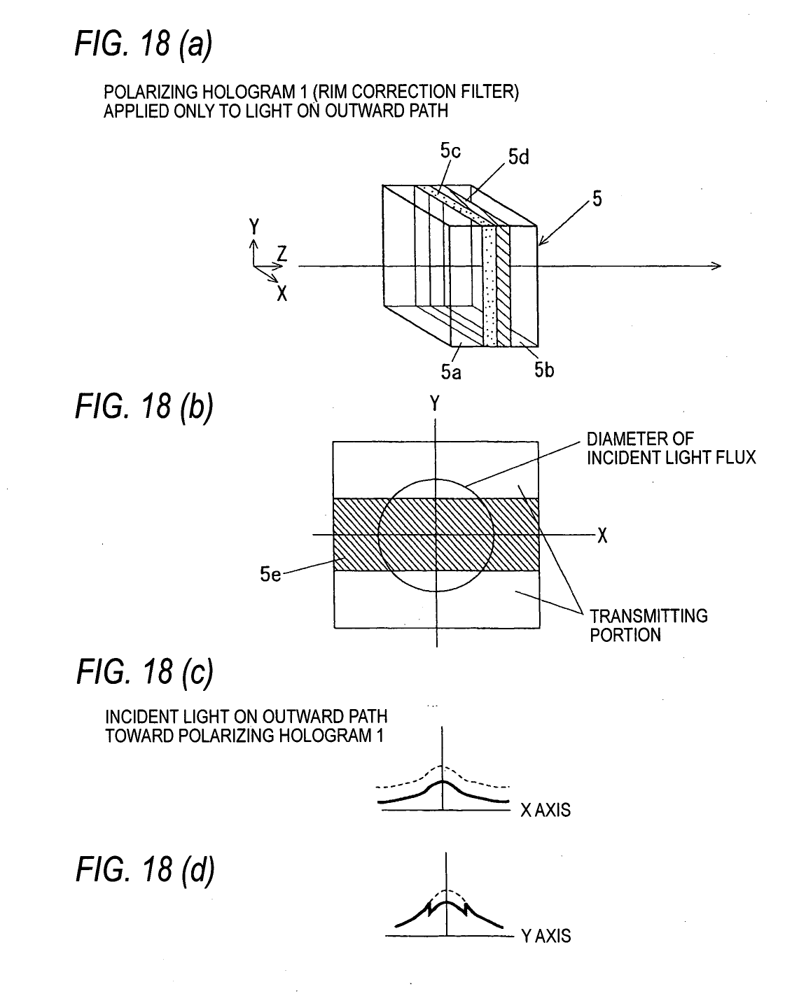

The optical component 5 is made of transparent glass and has a substantially rectangular shape, and has the polarizing portions 5c and 5d interposed between the plate-shaped substrates 5a and 5b. The polarizing portion 5c significantly responds to the S waves emitted from the short wavelength optical unit 1, and hardly responds to the P waves reflected from the optical disk 2. In addition, the polarizing portion 5d hardly responds to the S waves emitted from the short wavelength optical unit 1, and significantly responds to the P waves reflected from the optical disk 2. In addition, light emitted from the short wavelength optical unit 1 is transmitted through the substrate 5a, the polarizing portion 5c, the polarizing portion 5d, and the substrate 5b in this order in the optical component 5, and the light reflected from the optical disk 2 is transmitted through the substrate 5b, the polarizing portion 5d, the polarizing portion 5c, and the substrate 5a in this order. The polarizing portion 5c is made of an optically anisotropic resin material so that the hologram 5e having a polarization selectivity has a substantially rectangular shape as shown in FIG. 18B. As shown in FIG. 18B, the hologram 5e is rectangular, and is configured such that an end of the diameter of the incident light flux protrudes from the long side of the rectangle. In addition, the polarizing portion 5c is formed by charging at least an optically isotropic resin (not shown) in the hologram 5e. As an example of manufacturing methods, the hologram 5e is manufactured on the substrate 5a by a well-known method, and the optically isotropic resin is charged in at least the air gap of the hologram 5e. As shown in FIG. 18C, the amount of incident light is indicated as a dotted line in an X axis of FIG. 18B, and when transmitted through the polarizing portion 5c, the amount of light generally decreases as shown as the solid line, and as shown in FIG. 18D, the amount of incident light is indicated as a dotted line in a Y axis of FIG. 18B, and when transmitted through the polarizing portion 5c, the main amount of light generally decreases as shown as the solid line. As such, by making a large amount of light decreased in the polarizing portion 5c, the RIM intensity (the intensity ratio of the outermost part of light flux with respect to the central intensity) can increase, and short wavelength light can be focused as a small spot on the optical disk, so that at least one of recording and reproducing on the optical disk 2 can be carried out with a high density. That is, the polarizing portion 5c has a function of RIM intensity correction filter which does not respond to the X direction where the RIM intensity is high and only responds to the Y axis where the RIM intensity is low.

In addition, although not shown, a hologram having wavelength selectivity and made of an optically anisotropic resin material on the substrate 5b is formed in the polarizing portion 5d, and an isotropic resin is charged within the hologram. The hologram constituting a part of the polarizing portion 5d has a function of separating the light reflected from the optical disk into a predetermined number of light fluxes so as to mainly generate tracking error signals.

In addition, as an example of manufacturing methods, the polarizing portions 5c and 5d are formed in the substrates 5a and 5b to face each other, respectively, and are bonded to each other by means of adhesive used therebetween, thereby manufacturing the optical component 5.

Next, the relay lens 6 will be described in detail.

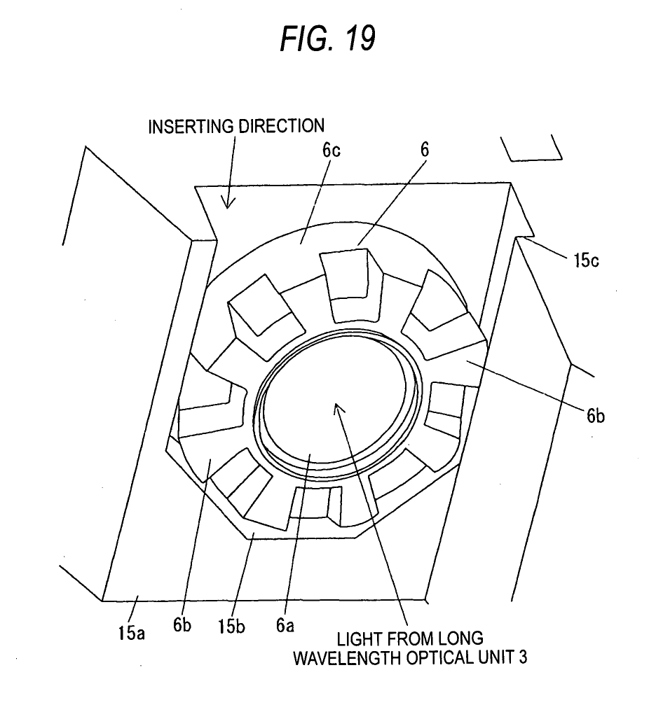

Specifically, the relay lens 6 is shaped as shown in FIG. 19. That is, the relay lens has a light-transmitting portion 6a where light is transmitted through at least a portion thereof, a plurality of protrusions 6b preferably radially formed around the light-transmitting portion 6a, and an outer wheel portion 6c having a substantially circular shape resulted from the formed protrusions 6b. In the present embodiment, the light-transmitting portion 6a, the protrusions 6b, and the outer wheel portion 6c are molded integrally. However, each piece of them may be formed and then assembled together.

A mounting portion 15a is vertically disposed in the base 15, and the mounting portion 15a is formed with a concave portion 15b provided with a stepped portion 15c. The relay lens 6 is inserted into the concave portion from the insertion direction shown in FIG. 19. The relay lens 6 will not be dropped toward the long wavelength optical unit 3 by virtue of the concave portion 15b formed with the stepped portion 15c. Although not shown, a through-hole is formed at a portion of the inserted relay lens 6 facing the light-transmitting portion 6a. Accordingly, as shown in FIG. 19, light emitted from the long wavelength optical unit 3 is transmitted through the light-transmitting portion 6a and the through-hole formed in the mounting portion 15a, and is then propagated toward the beam splitter 7.

In addition, a slender pin (not shown) is brought into abutment with the protrusion 6b by means of an operator or an automatic adjusting device to displace the relay lens 6 by a predetermined angle, so that correction of the astigmatism can be carried out. In addition, since the outer wheel portion 6c substantially abuts on an inner wall of the concave portion 15b, and has some or less protrusions or concave portions, but has a substantially circular shape, the relay lens 6 is rotatably held by the above-described slender pin or the like. After the relay lens 6 is rotated by a predetermined angle to correct the astigmatism, instantaneous adhesive or photocurable adhesive is applied and cured at least over the relay lens 6 and the mounting portion 15a to fix the relay lens 6 and the mounting portion 15a. In this case, the adhesive is preferably formed within the concave portion 15b in the mounting portion 15a, and it is preferable to consider the applying method or the amount of adhesive applied so as not to substantially cover the light-transmitting portion 6a with the adhesive.

Next, the beam splitter 7 will be described in detail.

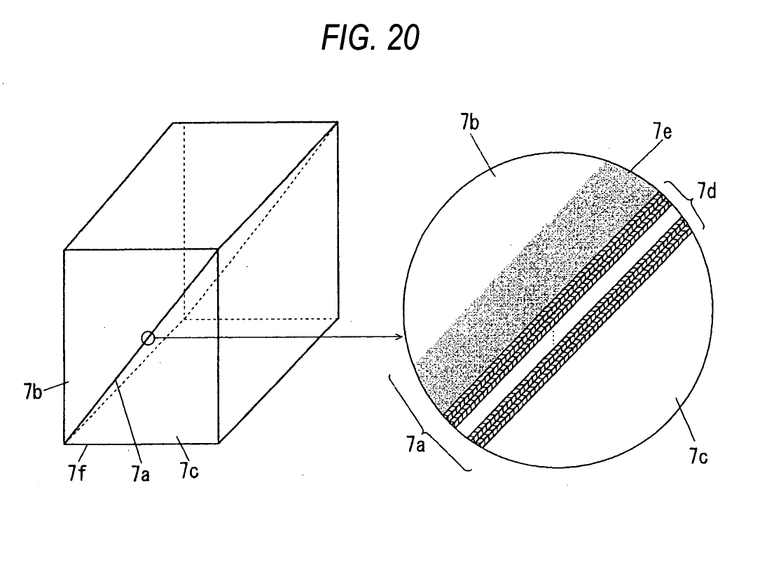

An outer shape of the beam splitter 7 is a substantially rectangular parallelepiped or a substantially cube as shown in FIG. 20, and as described above, it is configured to have the transparent members 7b and 7c bonded to each other and has the inclined surface 7a formed by the bonding between the transparent members 7b and 7c. The inclined surface 7a has approximately 45° with respect to the bottom side 7f of a lateral surface as shown in FIG. 20, but it is properly determined so as to be a predetermined angle according to the specification or the outer shape of the beam splitter 7. The transparent members 7b and 7c are made of a glass material to have a substantially triangular prism shape. The laminated portion 7d and the bonding portion 7e are included in the inclined surface as shown in FIG. 20.

The laminated portion 7d is formed such that a low refraction film and a high refraction film are alternately laminated, a SiO₂ film is employed as the low refraction film and Ta₂O₅ film is employed as the high refraction film in the present embodiment. In addition, the thickness of each of the high and low refraction films is about 10 nm to about 400 nm. In addition, in the present embodiment, polishing or surface treatment is preferably carried out on the surface where the laminated portion 7d of the transparent member 7c is to be formed, and thin film formation techniques such as sputtering or deposition is employed to laminate SiO₂, Ta₂O₅, SiO₂, Ta₂O₅, . . . , SiO₂, Ta₂O₅, SiO₂ in this order, thereby forming the laminated portion 7d is formed. In the present embodiment, at least twenty sets of pairs of thin films of SiO₂ film and Ta₂O₅ film are laminated (35 sets or less are preferable in consideration of the yield, the manufacturing cost, and so forth). When each of the SiO₂ film and Ta₂O₅ film is assumed as one layer, the laminated portion 7d has 40 layers to 70 layers. In addition, it is advantageous in terms of characteristic and productivity to have an actual thickness of the laminated portion 7d in a range of 2 to 10 μm.

As such, when the laminated portion 7d is formed, by adjusting the thickness of each layer (e.g. SiO₂ film and Ta₂O₅ film), a function of allowing light having a predetermined wavelength to be transmitted and allowing light having other wavelength to be reflected can be implemented. In the present embodiment, the laminated portion 7d is configured to allow the red color light (e.g. light having a wavelength of about 660 nm) and the infrared light (e.g. light having a wavelength of about 780 nm) to be transmitted and to allow the short wavelength light (e.g. light having a wavelength of about 405 nm) to be reflected.

In addition, the bonding portion 7e is formed between the laminated portion 7d and the transmitting member 7b, and an Si-based adhesive is preferably employed in the bonding portion 7e. The Si-based adhesive has a property which is hardly deteriorated with respect to the short wavelength light, and thus it is very preferable in the optical pickup device using light of wavelength of about 405 nm as in the present embodiment. In addition, as a matter of course, the bonding portion 7e may be made of a glass or other resin material. By making the thickness of the bonding portion 7e 3 to 15 μm(preferably, 8 to 12 μm), good bonding between the transparent member 7b and 7c can be ensured, which can thus lead to an increased productivity. In addition, the present embodiment is characterized in that short wavelength light is incident from the bottom side 7f and the laminated portion 7d is formed on the transparent member 7c without via the bonding portion 7e. Thus the bonding portion 7e can be kept from being deteriorated due to the short wavelength light.

Next, the collimator lens 8 and its driving device will be described.

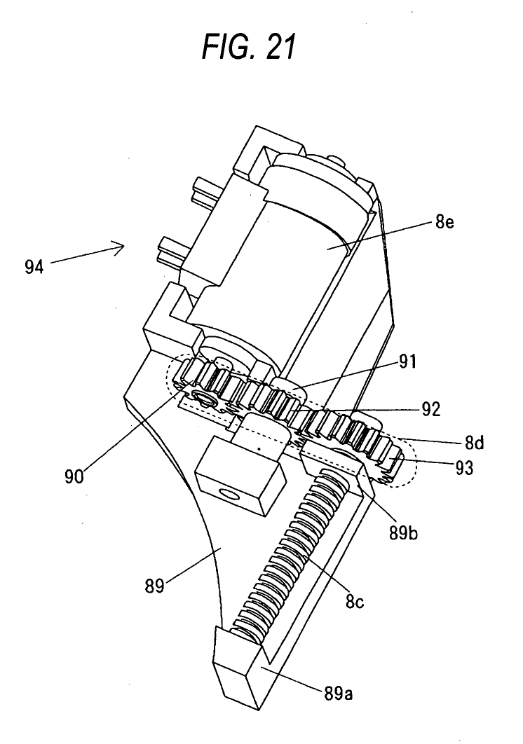

The lead screw 8c, the gear group 8d, and the drive member 8e are fixed to the base 89 as shown in FIG. 21. In addition, a stepping motor is used as the drive member in the present embodiment. A motor gear 90 is fixed to a rotating shaft of the drive member 8e. In addition, a train shaft is rotatably attached to the base 89, and a train gear 92 is fixed to the train shaft 91, and the motor gear 90 is engaged with the train gear 92. In addition, a pair of mounting portions 89a and 89b is integrally formed in the base 89, and an end of the screw shaft 8c is rotatably held in the mounting portion 89a, and the other end of the screw shaft 8c is rotatably inserted into the mounting portion 89b. A shaft gear 93 is fixed to the end of the mounting portion 89b, and the shaft gear 93 is engaged with the train gear 92. That is, with rotation of the drive member 8e, a rotation driving force is transmitted to the screw shaft 8c via the gear group 8d (e.g. the motor gear 90, the train gear 92, and the shaft gear 93).

As such, the driving device 94 where the above-described respective members are mounted is attached to the base 15.

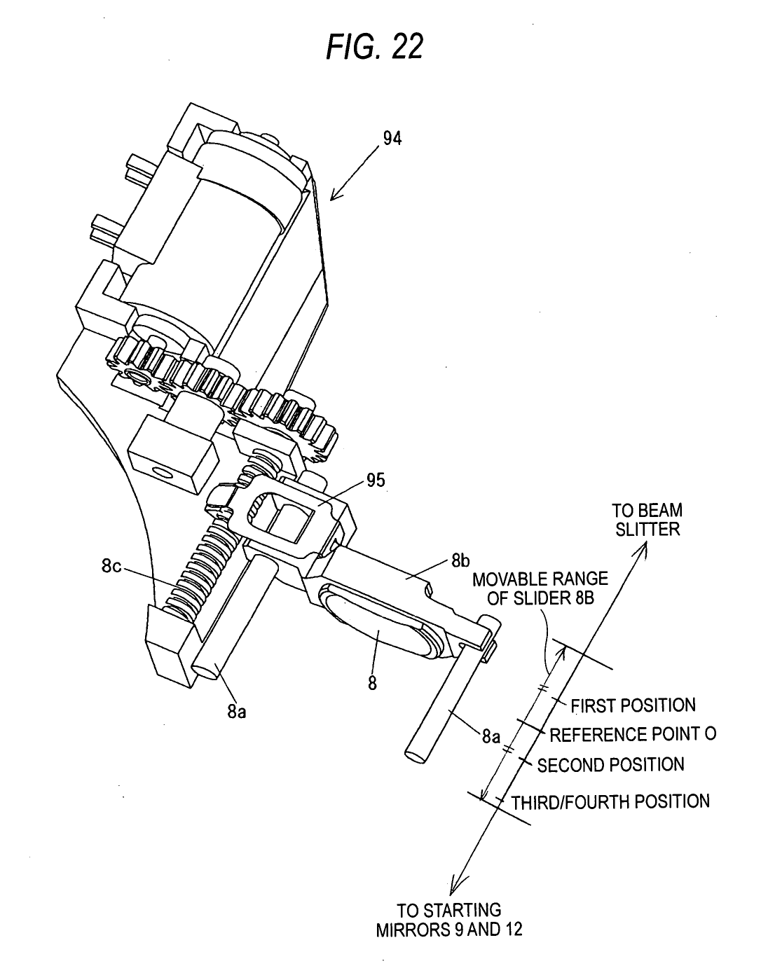

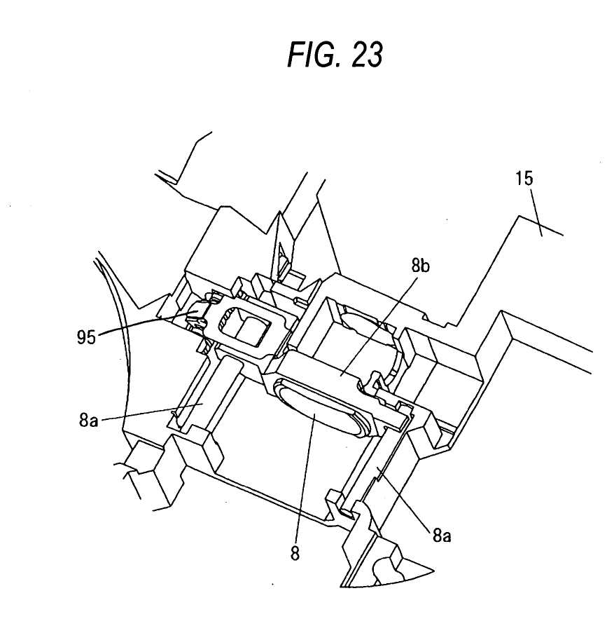

As shown in FIGS. 22 and 23, a slider mounted with the collimator lens 8 is movably attached to a pair of supporting members 8a attached to the base 15. In addition, to make the screw shaft 8c of the driving device 94 substantially parallel to the supporting member 8a, the driving device 94 is formed next to the supporting member 8a. A rack member 95 made of an elastic material such as a leaf spring is attached to the slider 8b by means of adhesion or mechanical bonding, and an end of the rack member 95 is engaged with a helical groove formed in the screw shaft 8c. Accordingly, when the center of the movable range of the slider 8b is referred to as a reference point O for description, the slider 8b is moved substantially parallel to the beam splitter 7 and the starting mirrors 9 and 12 from the reference point O by rotation of the screw shaft 8c. When the rotation direction or the rotation speed of the screw shaft 8c is changed, the movement direction or the speed of the slider 8b can be adjusted. In the present embodiment, since the stepping motor is used as the drive member 8e, the position of the slider 8b, that is, the position of the collimator lens 8 can be determined by the number of pulses supplied to the drive member 8e.

Although not shown, when at least one of recording and reproducing is carried out on the optical disk 2 (having a first recording layer and a second recording layer) with light emitted from the short wavelength optical unit 1, and when recording and reproducing of information are carried out on the optical disk 2 with light emitted from the long wavelength optical unit 2 and corresponding to CD or light emitted from the long wavelength optical unit 2 and corresponding to DVD, the position of the collimator lens 8 is preferably made different in each case to surely carry out at least one of the recording and reproducing operations.

Accordingly, when at least one of the recording and reproducing is carried out on the first recording layer (i.e. a recording layer spaced by 0.1 mm from the surface of the objective lens 13) of the optical disk 2 by means of light emitted from the short wavelength optical unit 1, the collimator lens 8 is made disposed at a first position; when at least one of the recording and reproducing is carried out on the second recording layer (i.e. a recording layer spaced by 0.075 mm from the surface of the objective lens 13) of the optical disk 2 by means of light emitted from the short wavelength optical unit 1, the collimator lens 8 is made disposed at a second position; when at least one of the recording and reproducing is carried out on the optical disk 2 by means of light emitted from the long wavelength optical unit 3 and corresponding to CD, the collimator lens 8 is made disposed at a third position, and when at least one of the recording and reproducing is carried out on the optical disk 2 by means of light emitted from the long wavelength optical unit 3 and corresponding to DVD, the collimator lens 8 is made disposed at a fourth position. The first to fourth positions are positions of the collimator lens 8 in a movable range of the slider 8b. The first position is always different from the second position, and the third and fourth positions are different from at least one of the first and second positions. That is, at least two different positions are present in the first to fourth positions. As the first position is always different from the second position, the movable range of the slider 8b can be made narrow when the third and fourth positions are present between the first and second positions. However, the present invention is not limited thereto. Next, an example of the positional relation of the first to fourth positions will be described.

As shown in FIG. 22, by setting the first position to 0.83 mm toward the beam splitter 7 from the reference point O, the second position to 0.83 mm toward the starting mirrors 9 and 12 from the reference point O, and the third and fourth positions to 1.9 mm toward the starting mirrors 9 and 12 from the reference point O, the position of the collimator lens 8 can be changed, and at least one of recording and reproducing can be surely carried out on each recording layer of the optical disk 2 in each type of the optical disk 2. In this case, the first and second positions are preferably fine-adjusted toward the beam splitter 7 or the starting mirrors 9 and 12 while keeping the interval of 1.66 mm according to the optical disk 2 where recording and reproducing are carried but by means of light emitted from the short wavelength optical unit 1. With this structure, the spherical aberration can be corrected with a higher accuracy for the short wavelength laser light. In addition, the fourth position is preferably fine-adjusted in the same manner according to the optical disk 2 (in this case, DVD) mounted on the spindle motor 25.

An example of the operation associated with the above-described structure will be described.

A separate sensor (not shown) is provided. It is assumed that the slider 8b is located at a home position by means of the sensor. The control member (not shown) determines which wavelength light is used to carry out recording and reproducing or whether the recording and reproducing are carried out in any one of the first recording layer and the second recording layer by means of external signals, etc., and by using the signals, the control member reads whether a pulse is transmitted to the drive member 8e from the memory. In this case, the first to fourth positions are determined by selecting which wavelength light is used for carrying out the recording and reproducing or by selecting the first recording layer or the second recording layer for carrying out the recording and reproducing. In order to make the collimator lens 8 located at each of the positions, to which direction and how much the slider 8b present at the home position be moved is determined to some degree at a point of time of design. Thus the collimator lens 8 can be readily located at the optimal positions (e.g. the first to fourth positions) by recording the number of transmitting pulses in each operation in the memory in advance. In addition, the first to fourth positions may coincide with the home position of the slider 8b, or the reference point O may coincide with the home position. In addition, when a predetermined operation is terminated, the control member transmits pulses to the drive member 8e so as to make the slider 8b returned to the home position.

Next, the achromatic diffraction lens 14 will be described.

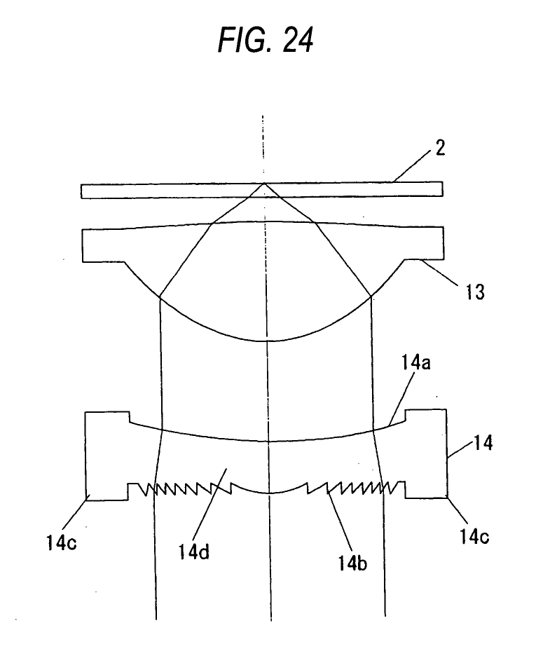

The achromatic diffraction lens 14 substantially has a light-transmitting portion 14d and an outer wheel portion 14c surrounding the outline of the light-transmitting portion 14d as shown in FIG. 24. A surface 14a of the light-transmitting portion 14d at the objective lens 13 has a concave shape, and a hologram having a predetermined pitch or shape is formed in the surface 14b at the starting mirror 12 opposite to the surface 14a. Short wavelength light is substantially transmitted through the light-transmitting portion 14d. In order to correct the chromatic aberration, it is possible to perform a desired achromatic correction by adjusting the pitch or the like of the hologram formed on the surface 14b. The achromatic diffraction lens 14 has a substantially circular shape, and the outer wheel portion 14c is mounted on the lens holder 16. In addition, in the present embodiment, the light-transmitting portion 14d and the outer wheel portion 14c are formed integrally. However, the light-transmitting portion 14d and the outer wheel portion 14c may be formed separately, and the light-transmitting portion 14d may be buried in a central portion of the outer wheel portion 14c.

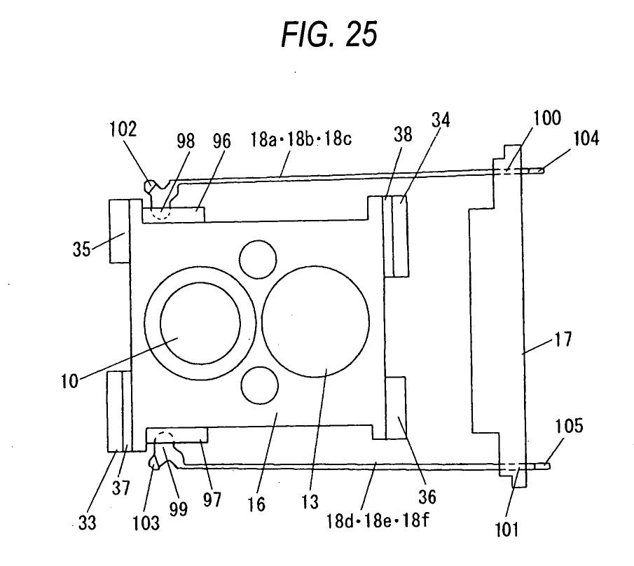

Next, embodiments of the lens holder 16 and the suspension holder 17 will be described with reference to FIGS. 25 to 28. In addition, members having the same reference numerals as those shown in FIGS. 6 and 7 have almost the same functions. In addition, as described above, the members having the same reference numerals shown in FIG. 25 to 28 as those shown in FIGS. 6 and 7 have almost the same functions, but the members shown in FIGS. 25 to 28 have somewhat different shapes from those shown in FIGS. 6 and 7.

The resonant frequency of the lens holder 16 needs to increase when at least one of the recording and reproducing is carried out on the optical disk 2 at a high speed. That is, in order to control the lens holder 16 so that the lens holder 16 can follow surface wobbling of the optical disk 2 by carrying out the recording and reproducing at a high speed, the resonant frequency of the lens holder 16 is preferably increased to control the lens holder 16 in a range below the resonant frequency. One of methods for increasing the resonant frequency of the lens holder 16 may include giving the lens holder 16 a high rigidity. In the present embodiment, all or at least a portion of the lens holder 16 is made of a material in which fibers are dispersed (hereinafter, referred to as a composite material) in resin in order to give the lens holder 16 a high rigidity. Liquid crystal polymers, epoxy resins, polyimide resins, polyamide resins, or acrylic resins are appropriately employed as the resin, and carbon fibers, carbon blacks, or metal fibers such as copper, nickel, aluminum, and stainless, or composite fibers thereof are employed as the fibers. In addition, in the present embodiment, the lens holder 16 is made of the material in which the carbon fibers are dispersed in the liquid crystal polymer.

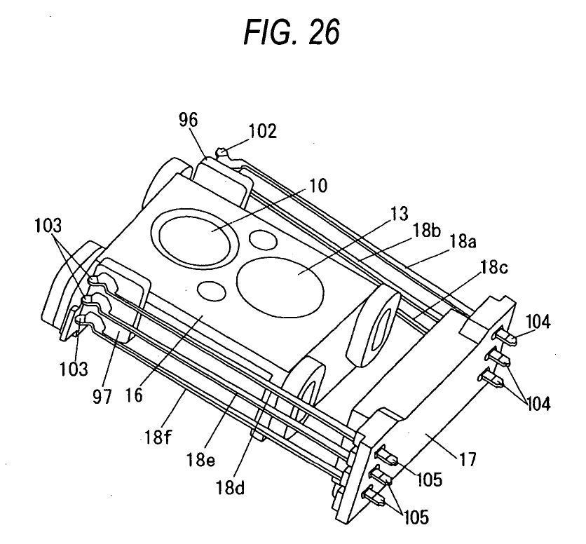

As shown in FIGS. 25 and 26, when the lens holder 16 and the suspension holder 17 are made of the composite material, since the lens holder 16 and the suspension holder 17 may have conductivity, an insulating film is formed on surfaces of the suspensions 18a to 18f. In this case, an insulating member may be provided between the lens holder 16 and various coils to insulate them from each other, or various kinds of coils are composed of coils themselves which are subjected to an insulating treatment. By forming the insulating film on the suspensions 18a to 18 in this way, an insulating property between the conductive lens holder 16 and the suspension holder 17 is kept. In addition, insulated ends 98 and 99 of the suspensions 18a to 18f are attached to bobbin suspension receiving portions 96 and 97 integrally formed in the lens holder 16 by means of insert molding. In addition, insulated ends 100 and 101 of the suspensions 18a to 18f at the suspension holder 17 are attached to the suspension holder 17 by means of insert molding. In addition, leading ends 102 and 103 of the suspensions 18a to 18f at the lens holder 16 do not have an insulating film thereon, and these leading ends 102 and 103 and various coils formed on the lens holder 16 are electrically connected, and leading ends 104 and 105 of the suspensions 18a to 18f at the suspension holder 17 do not have an insulating film thereon, and the leading ends 104 and 105 are connected to a flexible printed substrate (not shown).

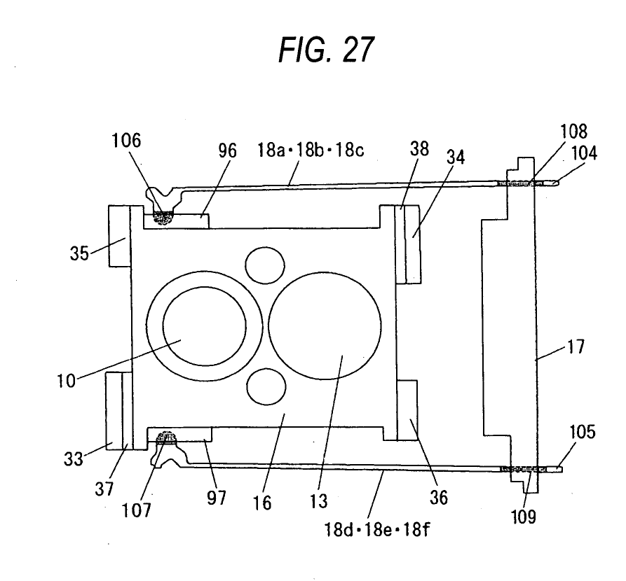

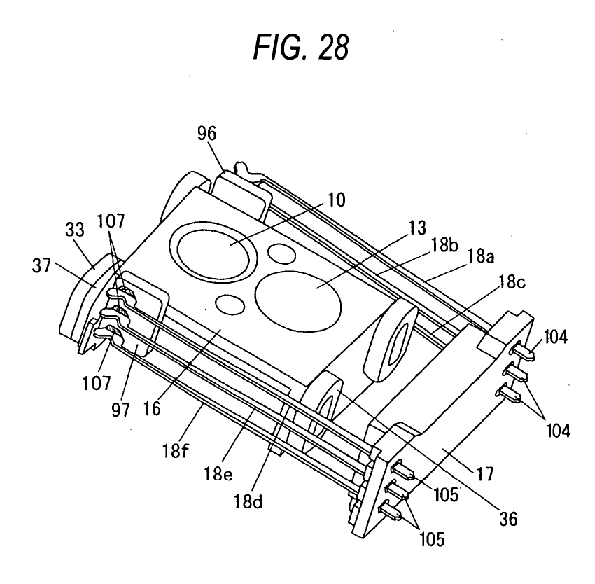

In addition, as modified examples of the embodiments shown in FIGS. 25 and 26, as shown in FIGS. 27 and 28, an insulating film is not formed on almost all of the suspensions 18a to 18f, and the insulating film is formed on ends 106 and 107 of the suspensions 18a to 18f, and all or at least portions of the ends 106 and 107 is bonded to the bobbin suspension receiving portions 96 and 97 (when the insulating film is formed on all of the ends, it is considered that the lends holder 16 is not in contact with the suspensions 18a to 18f). In the embodiments of FIGS. 27 and 28, portions of the ends 106 and 107 are bonded to the bobbin suspension receiving portions 96 and 97 for maintaining the insulating property. In addition, an insulating film is also formed on the ends 108 and 109 of the suspensions 18a to 18f at the suspension holder 17, and at least the ends 108 and 109 are bonded to the suspension holder 17, and in the embodiments of FIGS. 27 and 28, all of the ends 108 and 109 are bonded to the suspension holder 17.

In addition, an insulating material is used as the above-described insulating film by employing an applying method, an electrodeposition method, a deposition method or the like, and an inorganic insulating material such as an SiO₂ or an insulating material such as epoxy resins is employed as the insulating material. In addition, oxidation treatment may be carried out on the surface of the conductive suspensions 18a to 18f to form the insulating film. In addition, the suspensions 18a to 18f may be inserted into a tubular insulating material to be used as the insulating film, or a metal line allowed to pass through a resin wire by insert molding may be used as the suspensions 18a to 18f.

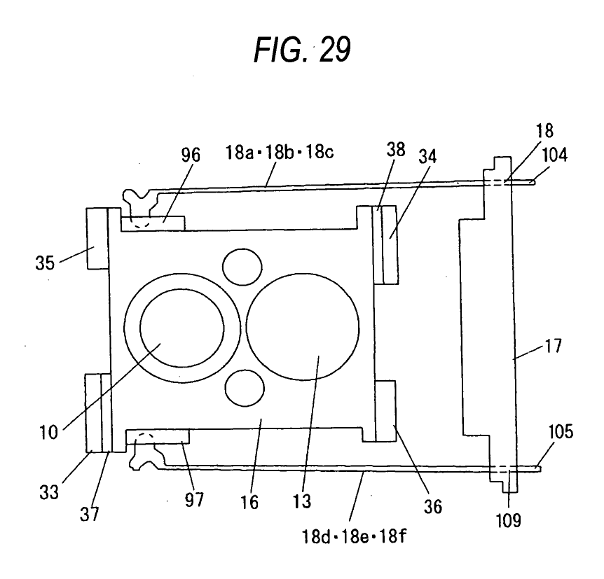

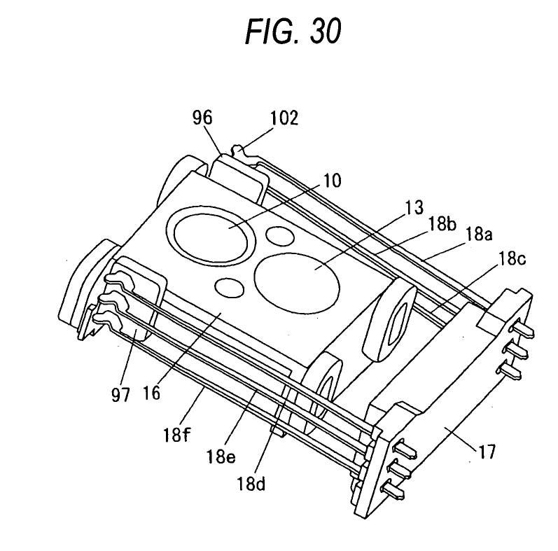

In addition, as shown in FIGS. 29 and 30, an insulating film is not formed on the suspensions 18a to 18f, and the suspension holder 17 and the bobbin suspension receiving portions 96 and 97 are made of a non-conductive material, and the lens holder 16 may be made of the above composite material. According to this structure, since the suspensions 18a to 18f themselves have an insulating property, the member to which the suspensions are attached has an insulating property. Thus, insulating treatment is not required in the suspension itself. The bobbin suspension receiving portions 96 and 97 and the lens holder 16 are formed integrally by two color molding, or configured by bonding the bobbin suspension receiving portions 96 and 97 to the lens holder 16 by means of adhesive made of resins. In the present embodiment, the lens holder 16 having a high rigidity can be used without carrying out the insulating treatment on the suspensions 18a to 18f.

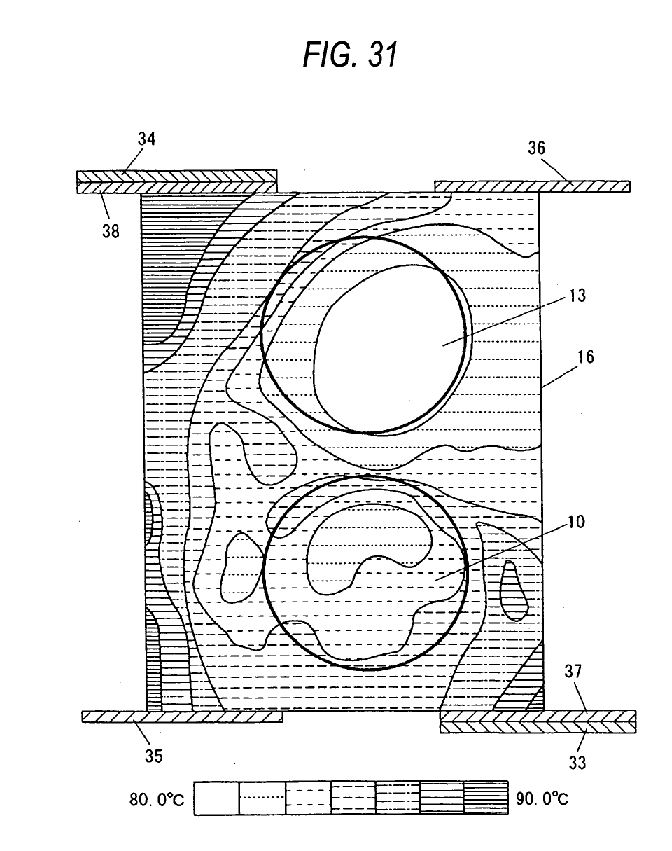

Next, the structure of the objective lens 10 and the lens holder 16 of the optical pickup device in the present embodiment will be described in detail with reference to FIGS. 31 to 35. In addition, some members shown in FIGS. 31 to 35 are different in shape from those shown in FIGS. 6, 7, and 25 to 28, but the members having the same reference numeral have almost the same functions.

FIG. 31 shows a temperature distribution on the lens holder 16 when current flows through the focusing coils 33 and 34, the tracking coils 35 and 36, and the sub-tracking coils 37 and 38. The objective lens 10 for long wavelength laser light and the objective lens 13 for short wavelength laser light are mounted on the lens holder 16. Positions of the objective lenses 10 and 13, focusing coils 33 and 34, the tracking coils 35 and 36, and the sub-tracking coils 37 and 38 are schematically illustrated in FIG. 31. Heat generated by allowing current to flow through the coils flows into the lens holder 16, and then flows into the objective lenses 10 and 13. The objective lenses 10 and 13 are deformed due to application of the heat. The deformation is typically expansion. However, contraction may also be considered depending on materials. In addition, resin rather than glass is significantly deformed due to application of heat. In addition, as can be seen from FIG. 31, there is a bias in the temperature distribution of the lens holder 16, and a set of the focusing coil 33 and the sub-tracking coil 37 becomes more heated than the tracking coil 35 in the objective lens 10, and a set of the focusing coil 34 and the sub-tracking coil 38 becomes more heated than the tracking coil 36 in the objective lens 13. Aberration occurs on the light transmitted through the objective lenses 10 and 13 due to biased deformation of the lens resulted from the inflowing and biased heat.

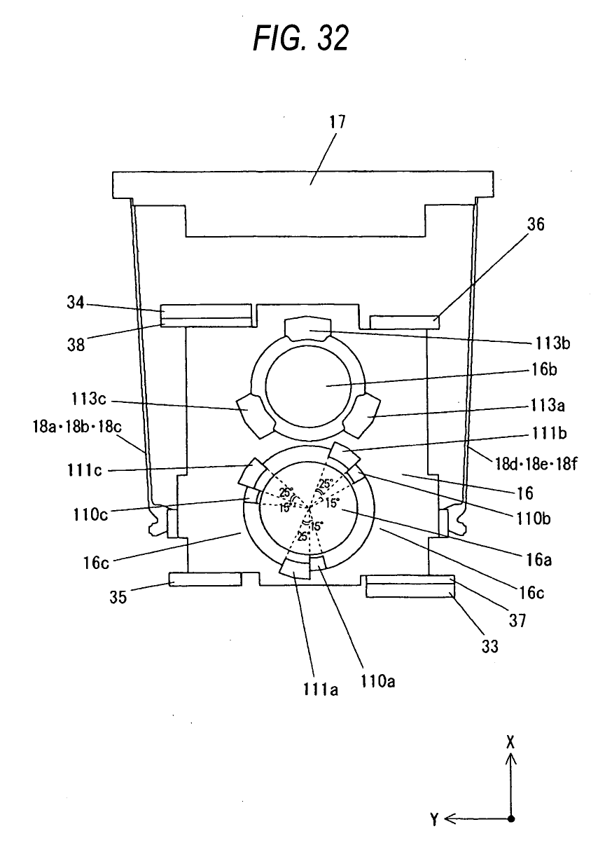

Referring to FIG. 32, reference numerals 110a, 110b, and 110c denote objective lens supporting surfaces, and 111a, 111b, 111c, 113a, 113b, and 113c denote adhering portions. The objective lens 13 for short wavelength laser light is dropped into the through-hole 16b of the lens holder 16 from the P1 direction shown in FIG. 7 and then fixed by a photocurable adhesive as described with reference to FIG. 7. In addition, the objective lens 10 for long wavelength laser light is dropped into the through-hole 16a of the lens holder 16 from the P1 direction shown in FIG. 7 and then fixed by a photocurable adhesive. The objective lens 10 of the objective lenses 10 and 13 mounted on the lens holder 16 is made of glass or resin in this manner, but is made of glass in the present embodiment. Accordingly, since a metal molding technique may be employed, the hologram can be readily formed in the objective lens 10, which allows the spherical aberration of the light having a plurality of types of wavelengths to be adjusted. In addition, the objective lens 13 may be made of glass or resin (preferably, a short wavelength-resistant resin), but is made of glass in the present embodiment. Accordingly, the objective lens 13 is hardly deteriorated for the short wavelength light, and good optical characteristics can be kept. In addition, the objective lenses 10 and 13 are used in the present embodiment. However, other focusing members such as a hologram may be employed instead.

Reference numerals 33 and 34 denote focusing coils as described with reference to FIG. 6, and are wound in a substantially ring shape, and are respectively formed at diagonally opposite positions of the lens holder 16. By making the focusing coils 33 and 34 provided at both ends of the lens holder 16, even when two lenses such as the objective lenses 10 and 13 are mounted on the lens holder 16, the optical pickup device can be made small-sized. Reference numerals 35 and 36 are wound in a substantially ring shape similar to the focusing coils 33 and 34, and are provided at different diagonally opposite positions from the focusing coils 33 and 34. In addition, sub-tracking coils 37 and 38 are provided between the focusing coils 33 and 34 and the lens holder 16, respectively. The provision of the sub-tracking coils 37 and 38 enables unnecessary tilting of the lens holder 16 occurring during tracking to be suppressed.

The relation between the lens holder 16 and the objective lenses 10 and 13 will be described in detail with reference to FIG. 32. The objective lens 13 is dropped into the through-hole 16b formed in a substantially circular shape toward the back from the front of the paper and is fixed to the lens holder 16 by means of photocurable adhesive injected into the adhering portions 113a, 113b, and 113c. In the meantime, the objective lens 10 is dropped into the through-hole 16a formed in a substantially circular shape toward the back from the front of the paper and is fixed to the lens holder 16 by means of photocurable adhesive after tilting adjustment is carried out while the lens is supported by the objective lens supporting surfaces 110a, 110b, and 110c. With this structure, optimal optical characteristics can be obtained. In this case, photocurable adhesive such as UV curable adhesive which are cured when irradiated with UV rays are employed as the adhesive. However, instantaneous adhesive or other adhesive may also be employed. In addition, adhesives preferably having a low thermal conductivity, or more preferably, adhesives having a heat-proof property which does not transfer the heat may be employed.

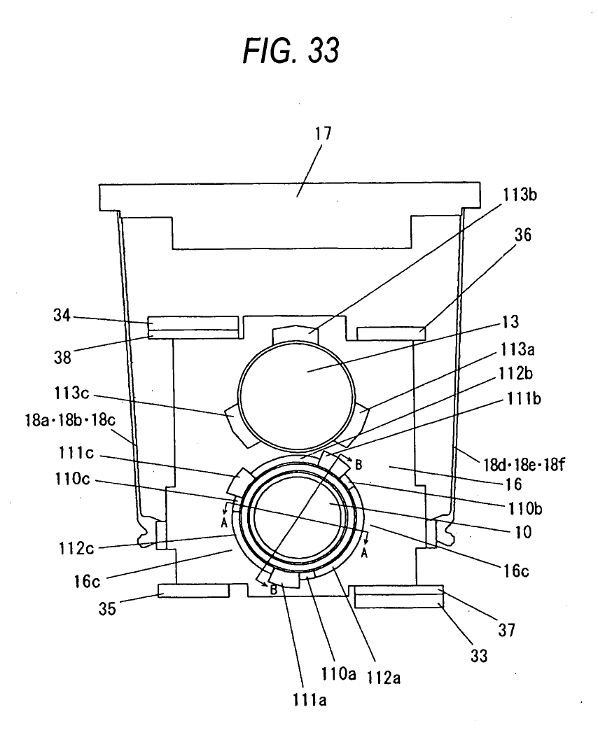

FIG. 33 shows a case in which the objective lens 13 is dropped into the through-hole 16b and the objective lens 10 is dropped into the through-hole 16a. As described with reference to FIG. 7, the peripheral edges of the objective lenses 10 and 13 abut on peripheral edges of the through-holes 16a and 16b of the lens holder 16. The outer peripheral portion of the objective lens 10 is in contact with the peripheral edge of the through-hole 16b of the lens holder 16 over almost the entire periphery. The contact between the objective lens made of resins and the lens holder 16 will be described in detail.

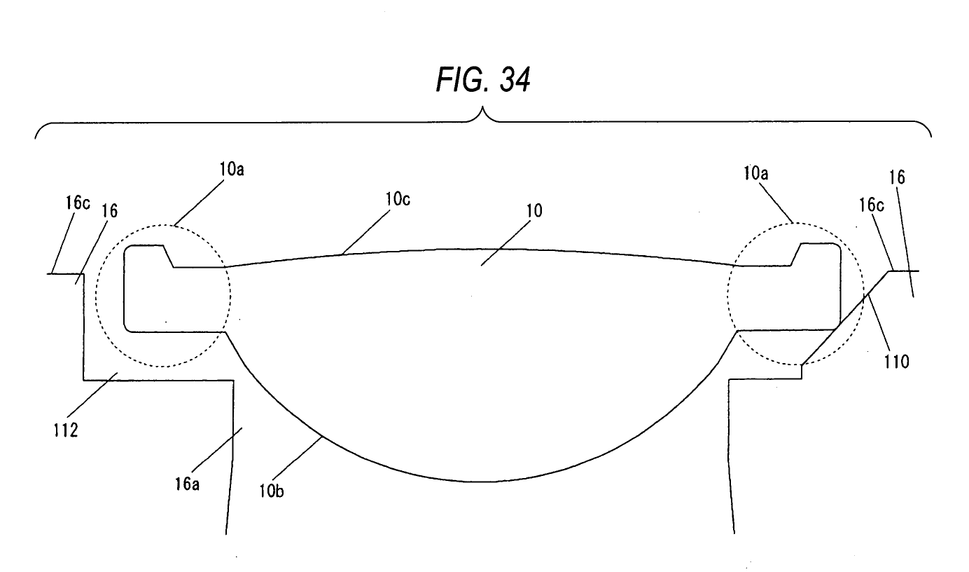

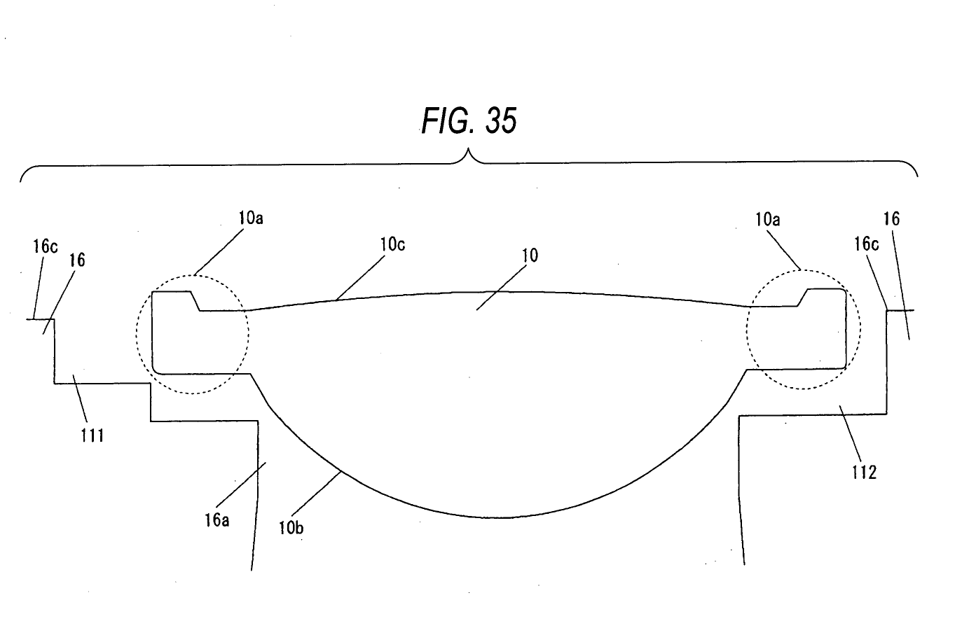

FIG. 34 is a cross-sectional view taken along the line A-A in FIG. 33, and FIG. 35 is a cross-sectional view taken along the line B-B in FIG. 33.

Reference numeral 10a denotes the objective lens outer peripheral portion that is an edge of the objective lens 10, and the objective lens 10 touches the lens holder 16 at a portion of the objective lens outer peripheral portion 10a and is adhered to the lens holder 16. In this way, the lens holder 16 and the objective lens 10 are fixed. Reference numeral 10b denotes an objective lens lower surface where the light emitted from the long wavelength optical unit 3 are incident on the objective lens 10, and 10c denotes an objective lens upper surface where the light incident from the lower surface 10c exits to the objective lens 10. The light transmitted through the objective lens 10 and emitted from the objective lens upper surface 10c is focused on the optical disk 2 corresponding to the objective lens upper surface 10c. A hologram is formed in the objective lens lower surface 10b. A light flux of wavelength of about 660 nm (red: corresponding to DVD) and a light flux of wavelength of about 780 nm (infrared: corresponding to DVD), which has become parallel light emitted from the long wavelength optical unit 3 and transmitted through the relay lens 6 or the collimator lens 8, are adjusted in spherical aberration when they are transmitted through the hologram.

Reference numeral 110 denotes an objective lens supporting surface formed in the lens holder 16. FIG. 34 is a cross-sectional view taken along the line A-A in FIG. 33. The objective lens supporting surface 110 is exactly an objective lens supporting surface 110c. However, since the objective lens supporting surfaces 110a, 110b, and 110c have almost the same structure and function, they are all referred to as the objective lens supporting surface 110 for simplicity. The objective lens supporting surface 110 has an inclined surface toward the through-hole 16a from the lens holder upper surface 16c of the lens holder 16. This inclined surface has a substantially spherical shape that is concaved with respect to the lens holder upper surface 16c. When the objective lens 10 is placed in the objective lens supporting surface 110, it is preferable that a principal point of the objective lens 10 coincide with and the center of the substantially spherical surface of the objective lens supporting surface 110. Misalignment of the principal point of the objective lens 10 and the center of the substantially spherical surface of the objective lens supporting surface 110 may be tolerable to some degree. By forming the substantially spherical surface on the objective lens supporting surface 110, the objective lens 10 can be tilted to adjust the direction of the optical axis of the objective lens 10.

Reference numeral 111 denotes an adhering portion formed in the lens holder 16. FIG. 35 is a cross-sectional view taken along the line B-B of FIG. 33. The adhering portion 111 is exactly an adhering portion 111b. However, since the adhering portions 111a, 111b, and 111c have almost the same structure and function, they are collectively referred to as the adhering portion 111 for simplicity. The adhering portion 111 is composed of a stepped portion located downward nearer to the through-hole 16a than the lens holder upper surface 16c of the lens holder 16. The adhering portion 111 is configured such that the objective lens 10 does not abut on the objective lens supporting surface when carrying out tilting adjustment by making the objective lens 10 slide on the objective lens supporting surface 110.

The arrangement of the objective lens supporting surface 110 and the adhering portion 111 will be described. As shown in FIG. 32, when the peripheral edge of the through-hole 16a is seen from the center axis of the through-hole 16a, the angles occupied by the objective lens supporting surfaces 110a, 110b, and 110c in the peripheral edge of the through-hole 16a are all about 15°, and the angles occupied by the objective lens supporting surfaces 111a, 111b, and 111c in the peripheral edge of the through-hole 16a are all about 25°. Since a contacting portion between the objective lens supporting surface 110 and the adhering portion 111, that is, a contacting portion between the lens holder 16 and the objective lens 10 is configured to be small, a thermal path from the lens holder 16 to the objective lens 10 becomes small, which can thus prevent the temperature of the objective lens 10 from increasing and can suppress deformation of the objective lens 10 to a low level.

The adhering portion 111a is disposed at a position which avoids the vicinity of a set of the focusing coil 33 and the sub-tracking coil 37 and is not too close to the tracking coil 35. In other words, the adhering portion 111a is disposed at a position closer to the tracking coil 35 than the set of the focusing coil 33 and the sub-tracking coil 37. With this structure, when the lens holder 16 is driven by allowing current to flow through the focusing coils 33 and 34, the tracking coils 35 and 36, and the sub-tracking coils 37, and 38, the adhering portion 111a can be disposed at a position having a low temperature between the tracking coil 35 whose temperature is apt to rise and the set of the focusing coil 33 and the sub-tracking coil 37 whose temperate rise is smaller than that of the tracking coli. The adhering portions 111b and 111c are disposed at positions almost equal in temperature to the position of the adhering portion 111a on the lens holder 16. In this case, a temperature difference among the adhering portions 111a, 111b, and 111c is preferably within 1° to 2°. Since the adhering portions 111a, 111b, and 111c are approximately equal in size to one another, adhesive injected into each of the adhering portions 111 comes into contact with the objective lens 10 over an approximately equal area. Accordingly, the amount of heat inflowing to the objective lens 10 from the adhering portions 111a, 111b, and 111c formed at positions whose temperatures are almost equal to one another becomes approximately constant, so that a biased deformation of the objective lens 10 does not easily occur, which can thus suppress occurrence of the astigmatism of light transmitted through the objective lens 10. In addition, the adhering portions 111a, 111b, and 111c are disposed at almost the same angle so as to be closer to intervals of 120° around the central axis of the through-hole 16a. The adhering portion 111 may be properly disposed at equal intervals of 120° (equal angle), but is disposed around the through-hole 16a as close as possible at a position where the temperatures at the time of drive becomes approximately equal. Accordingly, even when the adhesive injected into the adhering portion 111 is solidified and contracted, a force that the objective lens 10 is tensioned from the lens holder 16 is cancelled off. Thus, the positioned objective lens 10 is not easily out of alignment.

In addition, the adhering portion 111 is composed of three adhering pieces in the present embodiment. However, the number of the adhering portion 111 is not limited to this value. In addition, when the number of adhering portions 111 is changed such that the adhering portion 111 are disposed at intervals of 180° around the central axis of the through-hole 16a when the number of the adhering portion 111 is two and the adhering portion 111 are disposed at intervals of 90° around the central axis of the through-hole 16a when the number of the adhering portion 111 is four, the adhering portion 111 is preferably disposed at equal angles around the central axis of the through-hole 16a. However, if the number of the adhering portions 111 decreases, the force required for fixing the objective lens 10 to the lens holder 16 becomes weak. In order to prevent this situation, the adhering portion 111 needs to spread out. In addition, when the adhering portion 111 increases too much, each of the adhering portions 111 can be made small, but a plurality of positions having almost the same temperature on the lens holder 16 is required, and the position where the adhesive needs to be injected increases. As a result, the number of assembly processes may increase. The adhering portion 111 is preferably composed of three adhering pieces.

In addition, in the present embodiment, the adhering portions 111a, 111b, and 111c are made to have almost the same area and are disposed at positions close to the temperature on the lens holder 16. However, a structure can be implemented in which the amount of heat inflowing from each of the adhering portions 111 is made uniform by changing the area of the adhering portion 111 such that the adhering portion 111 formed at a position having a higher temperature of the lens holder 16 is made small and the adhering portion 111 formed at a position having a lower temperature thereof is made large.

The objective lens supporting surfaces 110a and 110b are adjacent to the adhering portions 111a and 111b, respectively, and are formed at positions close to the set of focusing coil 33 and sub-tracking coil 37. In addition, the objective lens supporting surface 110c is adjacent to the adhering portion 111c, and is formed at a position closer to the tracking coil 35 than the adhering portion 111c. As such, by making the objective lens supporting surface 110 disposed adjacent to the adhering portion 111, the objective lens supporting lens 110 is disposed at a position where the temperature of the lens holder 16 is low. As a result, thermal conduction to the objective lens 10 can be suppressed. In addition, by making the objective lens supporting surface 110 disposed adjacent to the adhering portion 111, the objective lens supporting surface 110 can also be disposed at intervals having almost the same angle around the central axis of the through-hole 16a. This structure allows the objective lens supporting surface 110 to stably support the objective lens 10.

In addition, in the present embodiment, the objective lens supporting surface 110 as a member supporting the objective lens 10 is composed of three objective lens supporting surfaces 110a, 110b, and 110c. According to this structure, the lens holder 16 is brought into contact with the objective lens outer peripheral portion 10a at three points, and the supported surfaces of the objective lens 10 can be determined uniquely. In addition, the points are three in the present embodiment. However, the number of points that support the objective lens 10 is not limited thereto.

In addition, in the present embodiment, the objective lens supporting surface 110 and the adhering portion 111 are formed as different surfaces on the lens holder 16. According to this structure, the adhesive can be prevented from being attached onto the objective lens supporting surface 110 for adjusting tilting, and the objective lens 10 can be adjusted with a good accuracy. In addition, by forming the adhering portion 111 separately from the objective lens supporting surface 110 to be adhered to the objective lens 10 and the lens holder 16, the objective lens 10 and the lens holder 16 can be surely fixed.

In addition, the objective lens supporting surfaces 110a and 110b are formed at positions closer to the set of focusing coil 33 and sub-tracking coil 37 than the adhering portions 111a and 111b, respectively, and the objective lens supporting surface 110c is formed at a position closer to the tracking coil 35 than the adhering portion 111c. However, the objective lens 10 and the lens holder 16 just touch each other in the objective lens supporting surface 110, and the adhering portion 111 to which heat is apt to be transferred can be disposed a position away from a high temperature portion. Thus a rise in temperature of the objective lens 10 can be suppressed.

In addition, as described with reference to FIGS. 25 to 30 in the present embodiment, all or at least a portion of the lens holder 16 is preferably made of a material (e.g. composite material) in which fibers are dispersed in a resin. Liquid crystal polymers, epoxy resins, polyimide resins, polyamide resins, or acrylic resins are properly employed as the resin, and carbon fibers, carbon blacks, or metal fibers such as copper, nickel, aluminum, and stainless metal, or composite fibers thereof are employed as the fiber. As such, when the lens holder is made of the composite material, the lens holder 16 may have conductivity. However, since the rigidity of the lens holder 16 increase to cause the resonant frequency to increase, at least one of recording and reproducing at a high speed can be carried out on the optical disk 2. In addition, in the present embodiment, the lens holder 16 is made of a material in which carbon fibers are dispersed in a liquid crystal polymer. According to this structure, thermal conductivity of the lens holder 16 is expected to increase. When thermal conductivity increases, the temperature of the lens holder 16 is apt to be uniform. Thus the position of the adhering portion 111 can be selected in a wider range, and the adhering portion can be readily disposed around the through-hole 16a at approximately equal angles (e.g. at intervals of about 120° when the adhering portions 111 are three).

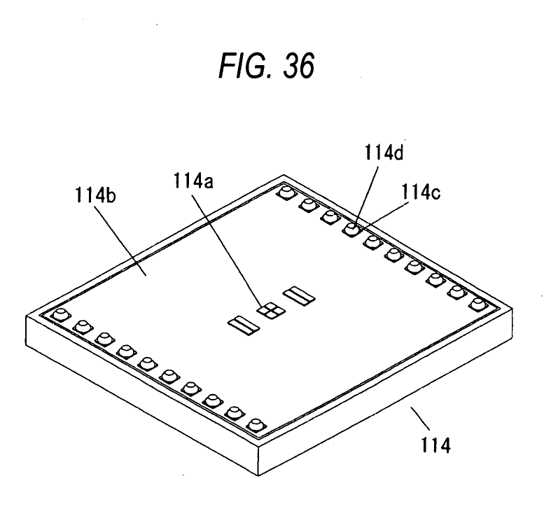

Next, the light-receiving portion 1 b of the short wavelength optical unit 1 will be described in detail with reference to FIGS. 36 to 49. In addition, some members shown in FIGS. 36 to 49 have different shapes from those shown in FIGS. 9 and 10, but the members having the same reference numeral have almost the same functions. FIG. 36 is a perspective view illustrating the light-receiving element 114 constituting the light-receiving portion 1b when seen from a surface of an integrated circuit (IC).

Referring to FIG. 36, reference numeral 114 denotes a light-receiving element composed of bare chip ICs which converts the light reflected from the information-recorded surface of the optical disk to electrical signals, and 114a denotes a light-detecting portion disposed at a substantially central position of the light-receiving element 114 to detect light incident on the light-receiving element 114, 114b denotes an electrical circuit portion, 114c denotes an electrode pad for inputting and outputting electrical signals, and 114d denotes bumps made of gold or solder which is disposed on the electrode pad for inputting and outputting electrical signals to establish an electrical connection in the light-receiving element 114. Each bumps 114d may be omitted as long as an electrical connection between the electrode pad for inputting and outputting electrical signals and an electrode pads 116 on the flexible printed substrate 49 to be described below can be surely established by means of adhesive resin layer for fixing the light-receiving element 115 to be described below. A surface of the light-receiving element 114 having the light-detecting portion 114a and the electrode pads 114c for inputting and outputting electrical signals is referred to as a light-detecting surface.

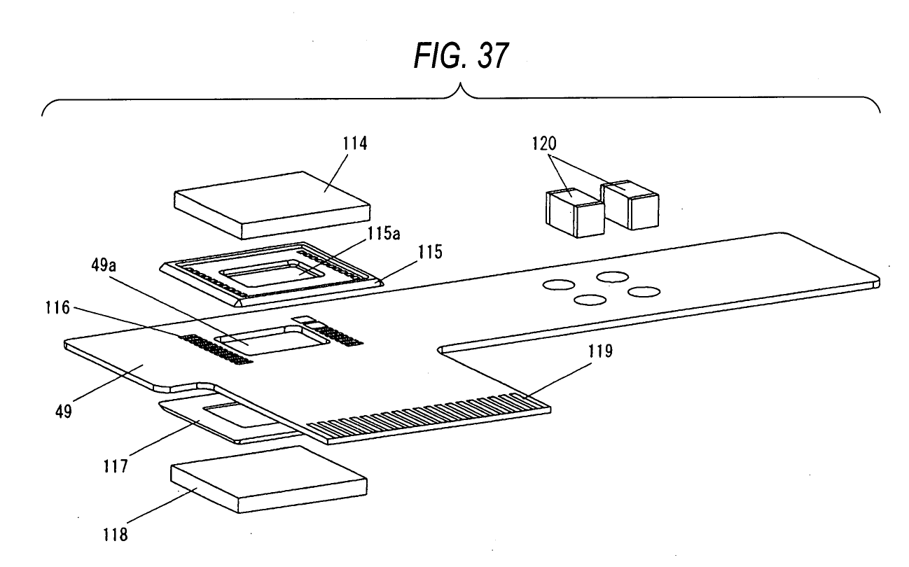

FIG. 37 is an exploded perspective view of constitutional components for explaining a structure of the flexible printed substrate unit 121 and a method of assembling the same.

Referring to FIG. 37, reference numeral 49 denotes a flexible printed substrate as an electrical wiring substrate having flexibility, 114 denotes a light-receiving element described with reference to FIG. 36 (since the electrode surface becomes negative, it is not seen), 115 denotes adhesive resin layer for fixing the light-receiving element as an anisotropic conductive film (ACF) carrying out protection of the inter-electrode connection and fixation between the flexible printed substrate 49 and the light-receiving element 114, 116 denotes an electrode pad disposed in two rows on the flexible printed substrate 49 at the same interval as the electrode pads 114c for inputting and outputting electrical signals, 118 denotes a transparent glass substrate for protecting the electrode pads 114c for inputting and outputting electrical signals of the light-receiving element 114 and allowing the light reflected from the optical disk to be transmitted, 117 denotes adhesive for bonding the flexible printed substrate 49 to the transparent glass substrate 118, 119 denotes an electrode pattern formed at an end of the flexible printed substrate 49, 120 denotes a power-ground decoupling capacitor for improving electrical characteristics of the light-receiving element 114, and 49a denotes a through-hole formed in a substantially middle portion between the electrode pads 116 disposed in two rows and allowing the light reflected from the optical disk to be transmitted. In this case, a single surface substrate where wiring and electrode pads are formed are used as the flexible printed substrate 49 for implementing the facilitated manufacture and a low cost. However, a double surface substrate where wiring and electrode pads are formed may be employed. In this case, a surface of the light-receiving element 114 where wiring and electrode pads are formed is referred to as an electrode surface.

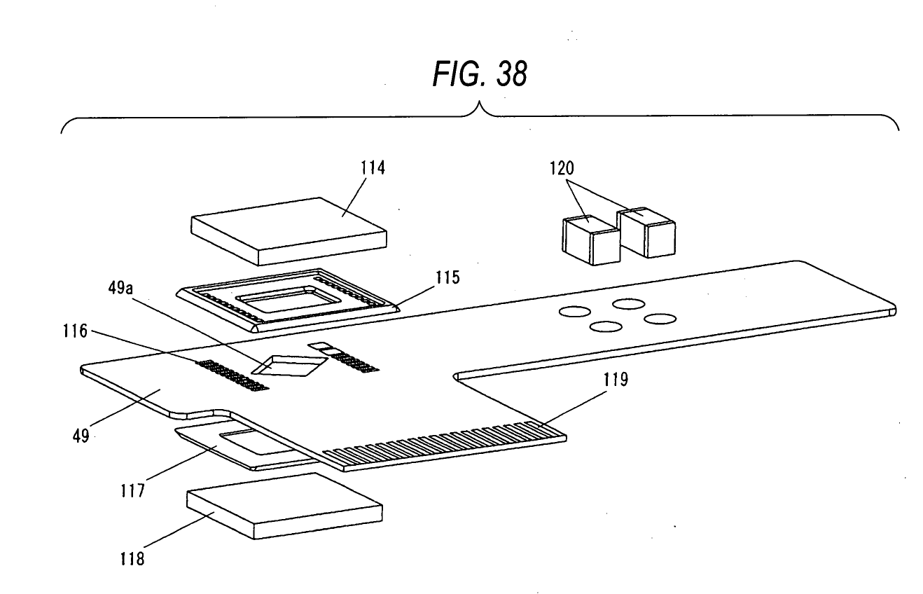

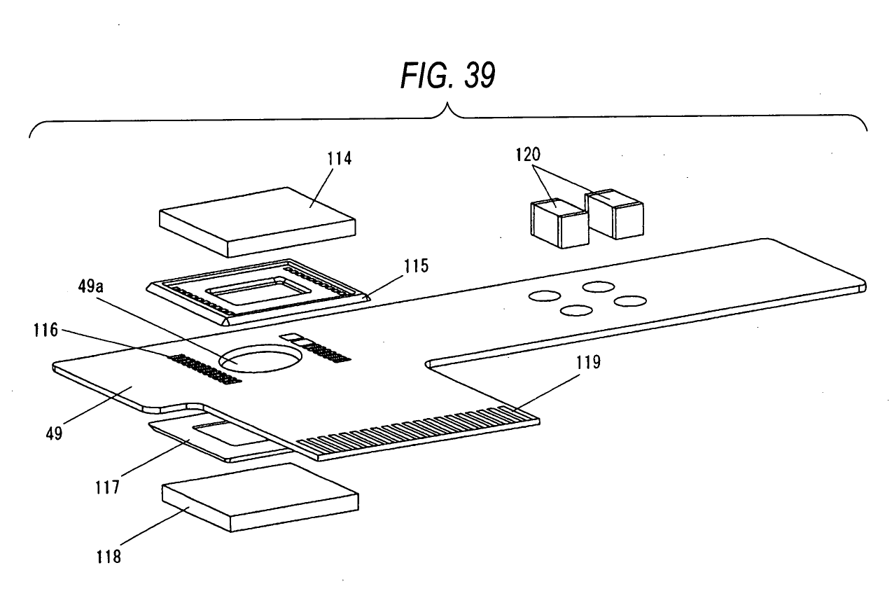

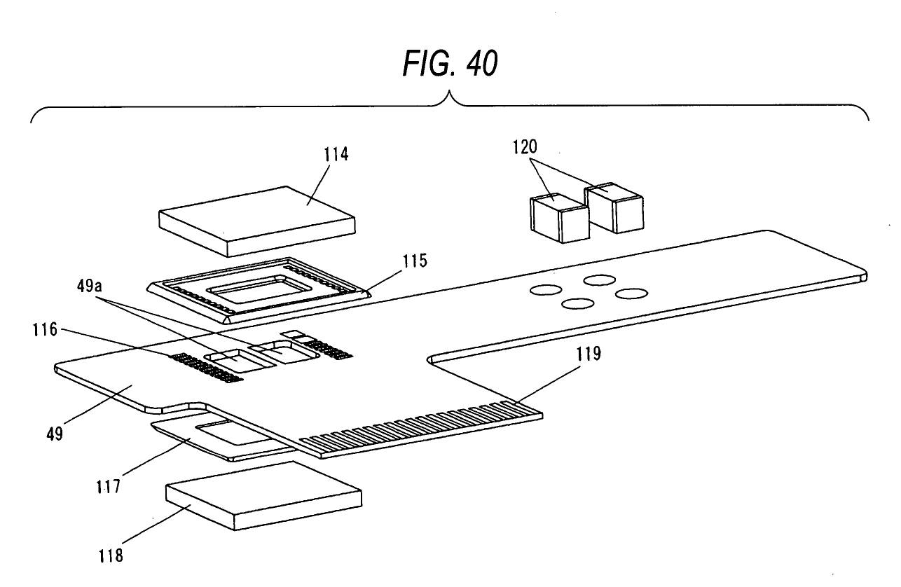

In addition, the through-hole 49 having a substantially rectangular shape is formed in FIG. 37, and the through-hole 49a of the flexible printed substrate 49 may be employed as long as at least some of the electrode pads for inputting and outputting electrical signals are seen from the through-hole 49a when the flexible printed substrate 49 and the light-receiving element 114 are bonded to each other and the light transmitted via the transparent glass substrate 118 and reflected from the information-recorded surface of the optical disk reaches the light-detecting portion 114a of the light-receiving element 114, and the through-hole 49a may have a substantially polygonal shape such as a substantially lozenge shape shown in FIG. 38, a substantially triangular shape, or a star shape, or a substantially elliptical shape as shown in FIG. 39, or a substantially circular shape. In addition, a plurality of the through-holes 49 may also be formed as shown in FIG. 40 as long as the light transmitted via the transparent glass substrate 118 and reflected from the information-recorded surface of the optical disk reaches the light-detecting portion 114a of the light-receiving element 114.

As such, by forming the through-hole 49a in the flexible printed substrate 49, that is, by surrounding the periphery of the through-hole 49a through which the light reflected from the optical disk is transmitted by means of the flexible printed substrate 49, the gap between the rows of the electrode pads disposed in two rows will not be easily changed even in the flexible printed substrate 49 made of a soft material. Thus the electrode pads 114c for inputting and outputting electrical signals of the light-receiving element 114 and the electrode pads 116 of the flexible printed substrate 49 can be surely connected to each other.

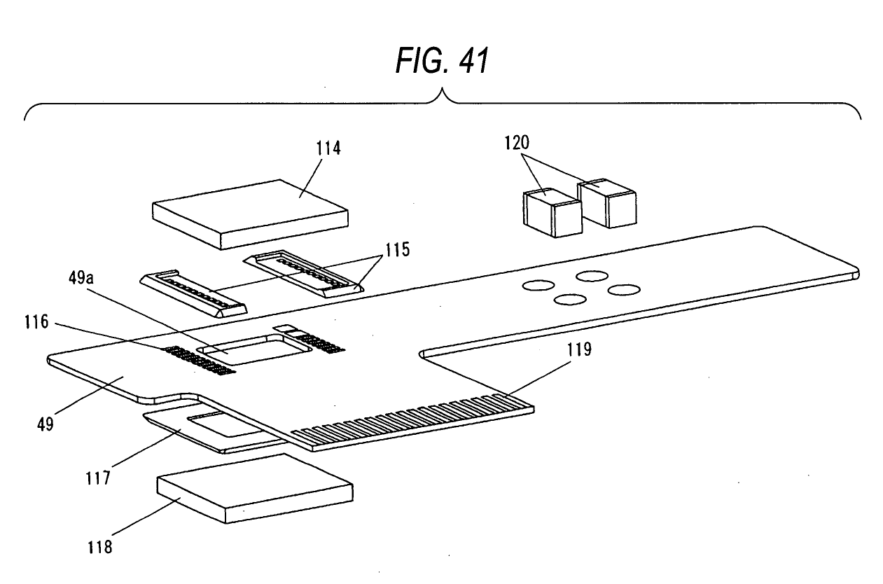

In addition, the through-hole 115a having a substantially rectangular shape is formed in a substantially central portion of the adhesive resin layer 115 for fixing the light-receiving element in FIG. 37. However, two sheets of small adhesive resin layers 115 for fixing the light-receiving element may be formed as shown in FIG. 41 as long as the adhesive resin layers 115 for fixing the light-receiving element are formed at least between the electrode pads 114c for inputting and outputting electrical signals and the electrode pads 116 of the flexible printed substrate 149. According to this structure, it is not necessary to form the through-hole 115a in the adhesive resin layer 115 for fixing the light-receiving element, and the used amount of the adhesive resin layer 115 for fixing the light-receiving element can be reduced.

In addition, the flexible printed substrate 49 is properly employed as a wiring substrate. However, another wiring substrate such as a glass epoxy substrate, a ceramic substrate and so forth may be employed, or the flexible printed substrate 49 may be used to form a thin optical pickup device having a light weight.

As shown in FIG. 37, the light-receiving element 114 and the flexible printed substrate 49 is fixed to each other by fixing the light-receiving element 114 formed with the bumps 114d to the electrode pads 116 by means of pressing and heating, by a so-called flip chip mounting, with the adhesive resin layer 115 for fixing the light-receiving element being interposed therebetween. In this case, an anisotropic conductive film (ACF) is properly employed as the adhesive resin layer 115 for fixing the light-receiving element, but not limited thereto.

In addition, the transparent glass substrate 118 is fixed to the rear surface of the flexible printed substrate 49 on which the light-receiving element 114 is mounted by means of pressing and heating with the adhesive 117 interposed therebetween, the through-hole 49a allowing the light reflected from the optical disk to be transmitted is formed in a substantially middle portion between the electrode pads 114c for inputting and outputting electrical signals formed in two rows on the flexible printed substrate 49, and the light reflected from the optical disk and incident from the transparent glass substrate 118 are allowed to reach the light-detecting portion 114a within the light-receiving element 114. With this structure, the light-detecting portion 114a within the light-receiving element 114 can be air-tightly encapsulated, connection between the light-receiving element 114 and the electrode can be protected, and fixation between components can be ensured.

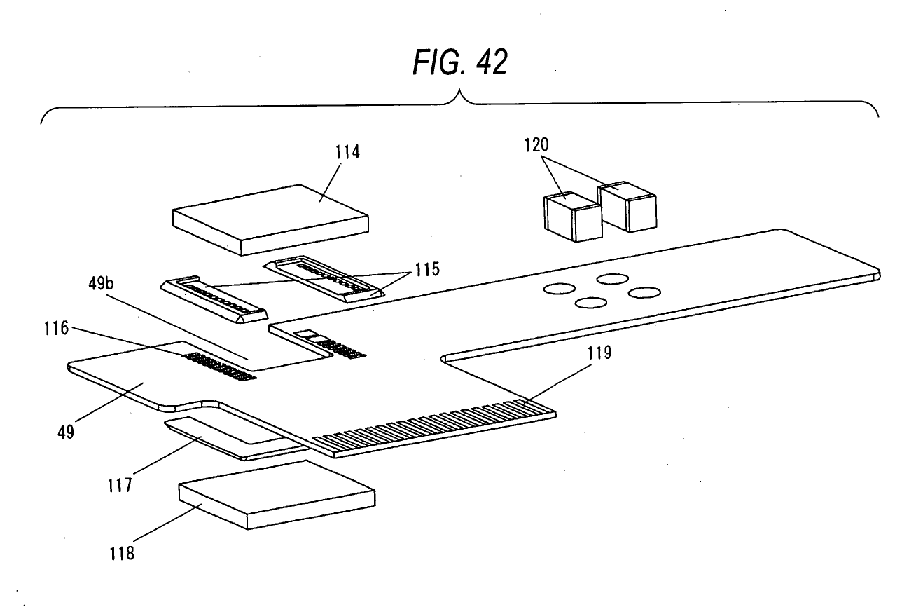

In addition, in the foregoing description, the through-hole 49a is formed in the flexible printed substrate 49. However, a notch 49b shown in FIG. 42 may be employed instead as long as the light transmitted via the transparent glass substrate 118 and reflected from the information-recorded surface of the optical disk reaches the light-detecting portion 114a of the light-receiving element 114. The notch 49b may be formed by carrying out notching by means of pressing after the flexible printed substrate 49 is fabricated, or may be formed when the outer shape of the flexible printed substrate 49 is formed.

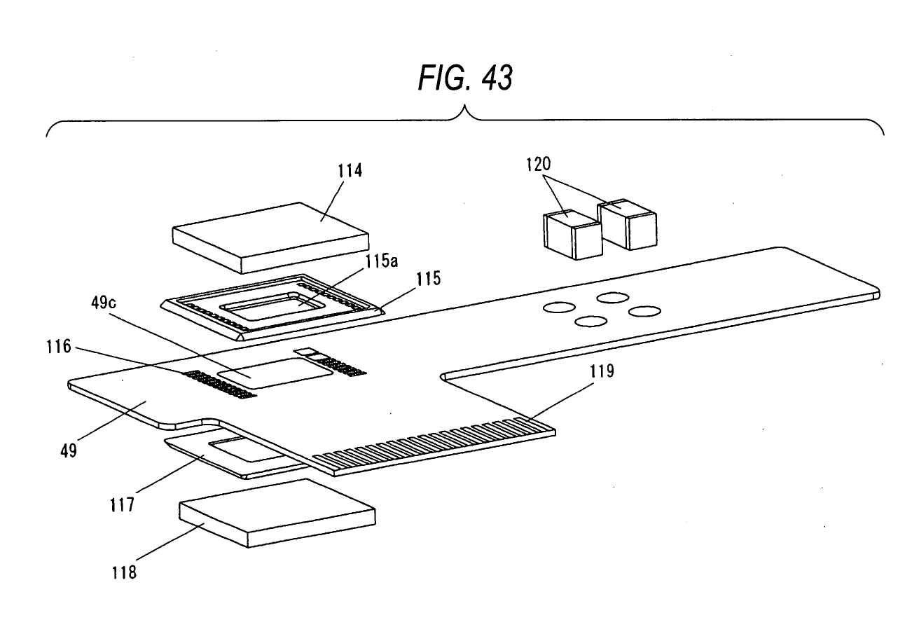

Similarly, the window 49c as a transparent glass member combined with the flexible printed substrate 49 may be formed as long as the light transmitted through the transparent glass substrate 118 and reflected from the information-recorded surface of the optical disk reaches the light-detecting portion 114a of the light-receiving element 114. The window 49c combined with the transparent glass member at the portion of the through-hole 49a described with reference to FIG. 37 is shown in FIG. 43. However, the window 49c may be shaped such that the transparent glass member is combined with the notch 49b or the through-hole 49a described hitherto, or may be shaped otherwise. Since the quality of the window 49c is not deteriorated even due to the transmission of the short wavelength laser light, the light reflected from the information recorded surface of the optical disk can be efficiently guided to the light-detecting portion 114a of the light-receiving element 114. In addition, when the window 49c is formed in the flexible printed substrate 49, the light-receiving portion 1b of the short wavelength optical unit 1 may be configured with the transparent glass substrate 118 omitted.

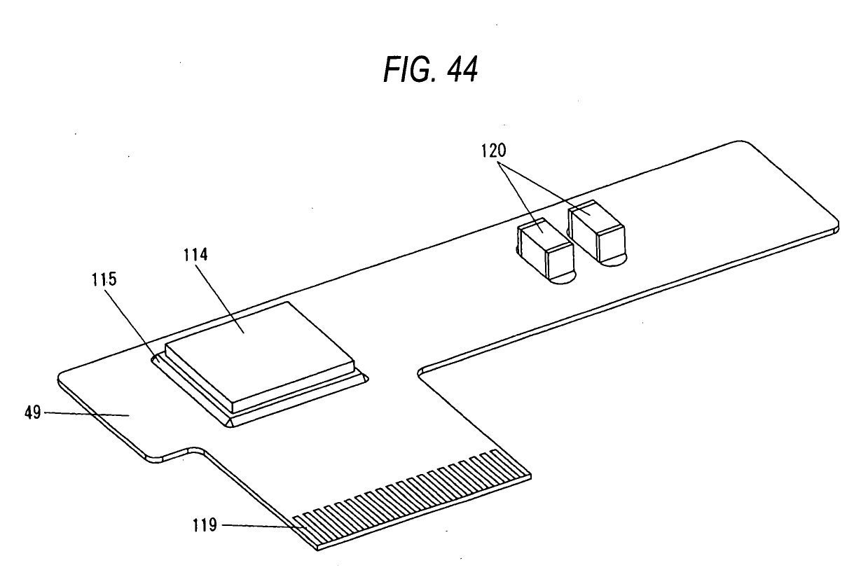

A perspective view of the assembled flexible printed substrate unit 121 as described above is shown in FIG. 44.

As such, the light-receiving element 114 composed of bare chip ICs is directly mounted on the flexible printed substrate 4 by using the flip chip mounting to form the light-receiving unit 123, so that a packaged photoelectric conversion integrated device encapsulated with a glass cover is not required. Thus the light-receiving portion 1b corresponding to the short wavelength laser can be made at a low cost. In addition, by mounting the light-receiving element 114 composed of bare chip ICs as it is directly on the flexible printed substrate 49, the optical pickup device can be made small-sized.

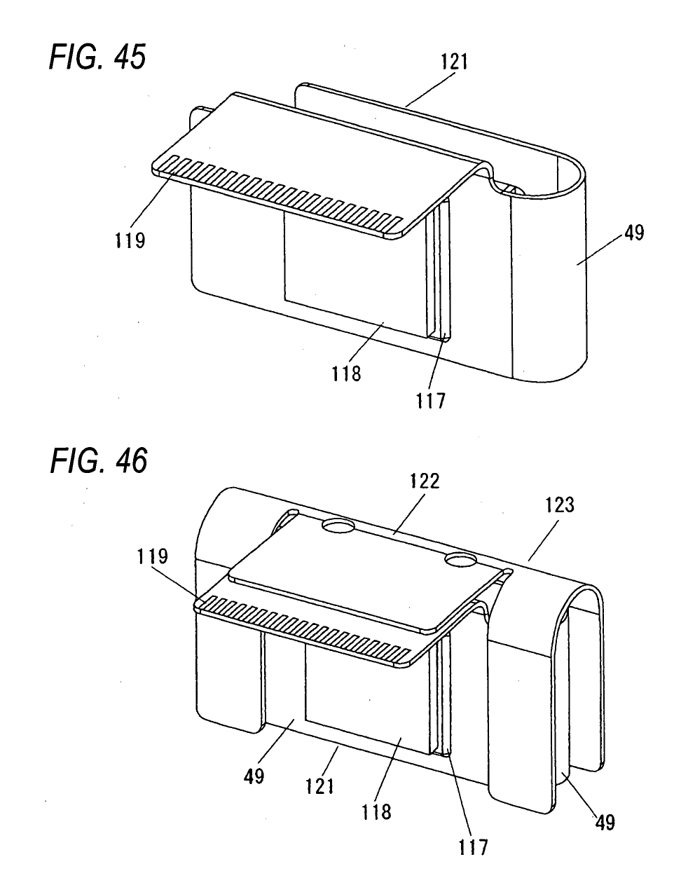

FIG. 45 is a perspective view illustrating a state in which the flexible printed substrate unit 121 shown in FIG. 44 is bent. A decoupling capacitor 120 between a power supply and the ground is soldered to a surface of the flexible printed substrate 49 and is folded so as to be disposed to face the rear surface of the surface having the light-detecting portion 114a of the light-receiving unit 114.

FIG. 46 is a perspective view of the light-receiving unit 123, and reference numeral 122 denotes a flexible printed substrate unit receiving component for receiving and holding the flexible printed substrate unit 121. The bent flexible printed substrate unit 121 as shown in FIG. 45 is fixed to the flexible printed substrate unit receiving component 122 by using photocurable adhesive. In this case, photocurable adhesive such as UV curable adhesive which is cured when irradiated with UV rays is employed as the adhesive. However, instantaneous adhesive or other adhesive may also be employed. In addition, the flexible printed substrate unit receiving component 122 is made of a material such as metal or resin, but preferably made of metal.

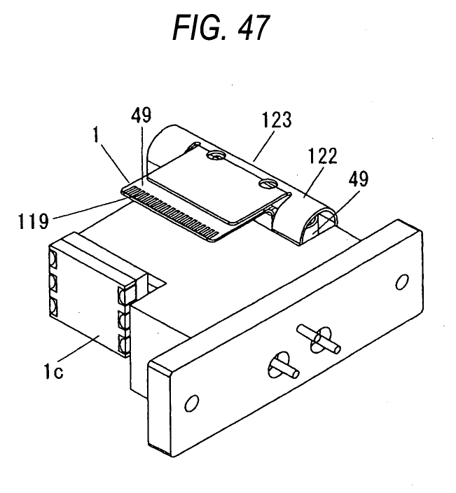

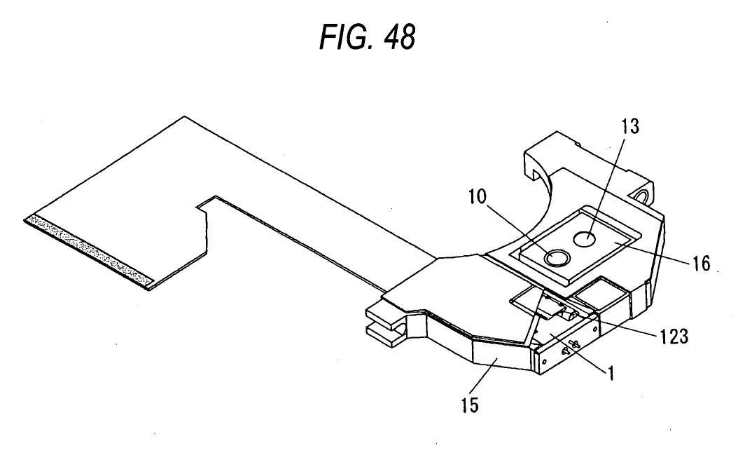

FIG. 47 is a view illustrating the short wavelength optical unit 1 using the light-receiving unit 123 as the light-receiving portion 1b, and reference numeral 1c denotes a light-receiving portion provided to monitor the amount of the light emitted from the light source la (not shown) of the short wavelength optical unit 1, and the light-receiving unit 123 and the light-receiving portion 1c are fixed to the short wavelength optical unit 1 after fine-adjustment of the relative position is carried out based on the short wavelength optical unit as a reference, and are assembled into the base 15 of the optical pickup device as shown in FIG. 48. In particular, the light-receiving unit 123 is fixed to the placing portion 43 of the short wavelength optical unit 1 with photocurable adhesive after carrying out fine-adjustment on the short wavelength optical unit 1 while grasping the flexible printed substrate unit receiving component 122 by means of jig or the like. In this case, photocurable adhesive such as UV curable adhesive which is cured when irradiated with UV rays is employed as the adhesive. However, instantaneous adhesive or other adhesive may also be employed.

Since the light-receiving unit 123 receives and holds the flexible printed substrate unit 121 by using the hard flexible printed substrate unit receiving component 122 as compared to the flexible printed substrate unit 121, the fine-adjustment of the relative position of the short wavelength optical unit 1 can be smoothly carried out.

In the present example, the operation of the optical pickup device will be briefly described with reference to FIG. 48 while attention is paid to the function of reproducing recorded information.

The optical pickup device as shown in FIG. 48 is designed and fabricated such that laser light (outward light) for reproducing recorded information reflected from the short wavelength optical unit 1 is transmitted through a plurality of optical elements (not shown) to be focused on the information-recorded surface of the optical disk (not shown) by means of the objective lens 13.

The light (homeward light) reflected from the information-recorded surface of the optical disk is propagated on the same optical path as the outward path immediately before the beam splitter (not shown) inside the short wavelength optical unit 1, and are returned to a direction of the light-receiving unit 123 by action of the beam splitter.

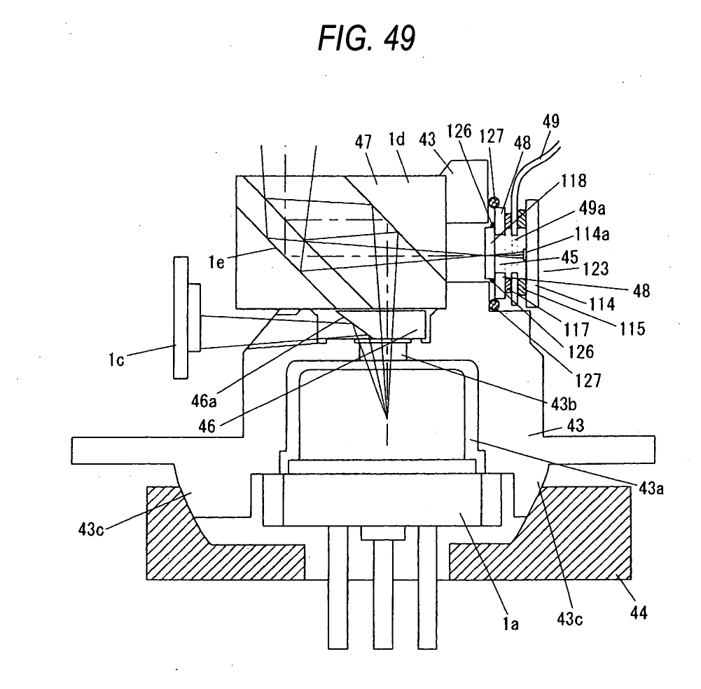

Next, another structure of the light-receiving unit 123 as the light-receiving portion 1b will be described with reference to FIG. 49.

The structure of a light-receiving unit 123 shown in FIG. 49 is the same as the light-receiving unit 123 described with reference to FIGS. 37 to 48 except that the flexible printed substrate unit receiving component 122 for receiving the flexible printed substrate unit 121 is not provided and a light-receiving portion attaching portion 48 is provided which is formed separately from the placing portion 43 between the flexible printed substrate 49 and the transparent glass substrate 118 and fixes the flexible printed substrate 49 and the light-receiving element 114 fixed on the flexible printed substrate 49 to the short wavelength optical unit 1. In this case, the placing portion 43 is preferably made of a metal material such as zinc die cast. With adhesive resin layer 115 for fixing the light-receiving element and made of an anisotropic conductive film (ACF) being interposed between the flexible printed substrate 49 and the light-receiving element 114 in which the light-detecting portion 114a for detecting laser light is composed of bare chip ICs directed to the flexible printed substrate 49 having a through-hole 49a, the light-receiving element 114 and the flexible printed substrate 49 are adhered to each other by means of pressing and heating, a light-receiving-portion attaching portion 48 having a through-hole 45 formed substantially at its center and made of metal plate is disposed at the side of the flexible printed substrate 49 opposite to the side where the light-receiving element 114 is fixed in the flexible printed substrate 49, and is then adhered to the flexible printed substrate 49 by using the adhesive 117 as organic adhesive such as a thermocurable adhesive. A transparent glass substrate 118 is disposed to cover the through-hole 45 of the light-receiving-portion attaching portion 48 on the side of the light-receiving element mounting section 48, adhered to the flexible printed substrate 49, opposite to the flexible printed substrate 49, and is then adhered with adhesive 126 such as photocurable adhesive. With this structure, the above-described light-receiving unit 123 is fixed to the placing portion 43 of the short wavelength optical unit 1 by means of photocurable adhesive after fine-adjustment is carried out on the short-wavelength optical unit 1.

In addition, the light-receiving-portion attaching portion 48 is preferably made of a metal material such as zinc die-cast. By making the light-receiving portion attaching portion 48 of the metal material such as the zinc die-cast, the position of the light-detecting portion 11a of the light-receiving unit 123 with respect to the short wavelength optical unit 1 can be surely fine-adjusted, and can be readily fixed to the placing portion 43 made of a metal material by means of adhesive 126 or the like. When photocurable adhesive such as UV curable adhesive cured when irradiated with UV rays is employed as the adhesive 126 used in the present example, adhesion between the light-receiving unit 123 and the placing portion 43 which has been subjected to the fine-adjustment can be readily carried out.

As described with reference to FIGS. 36 to 49, since no resin exists on the optical path of the reflected light from the optical disk to the light-receiving element, the light-receiving portion 1b can be kept from being deteriorated due to pass of laser light even in the optical disk apparatus using the short wavelength laser which is expected to be a main stream. As a result, the light detection can be carried out with a high efficiency.

The above-described light-receiving portion 1b is configured such that electrodes of the light-receiving element 114 composed of bare chip ICs are directly connected to the electrode pads 116 on the flexible printed substrate 49. Thus, the dimension of the light-receiving unit in the thickness direction of the optical pickup device can be made small, which enables the optical disk apparatus to be small-sized.

In addition, although the above description has been made of the structure in which the light receiving portion 1b of the short wavelength optical unit 1 is configured such that the flexible printed substrate 49 is provided between the light-receiving element 114 and the transparent glass substrate 118, and the light-receiving portion 1b faces the transparent glass substrate 118 via the through-hole 45 of the flexible printed substrate 49, the same can be applied to the light-receiving portion 1c of the short wavelength optical unit 1. Thus the light-receiving portion 1b can be kept from being deteriorated due to pass of the short wavelength laser light and light detection can be efficiently carried out. In addition, the same can be applied to the light-receiving portions 3b and 3c of the long wavelength optical unit 3.

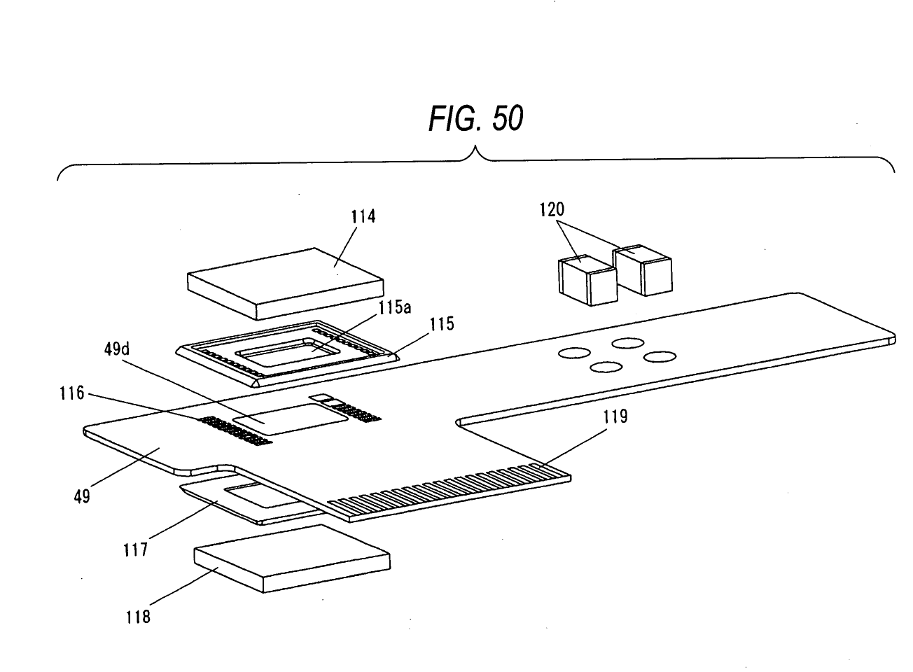

Hereinafter, the light-receiving portion 3b of the long wavelength optical unit 3 will be described with reference to FIG. 50. In addition, members having the same reference numerals as those shown in FIGS. 36 to 49 described about the light-receiving portion 1b of the short wavelength optical unit 1 have almost the same functions, and are members corresponding to the long wavelength laser light in FIG. 50.

Referring to FIG. 50, reference numeral 49d is a transparent substrate made of transparent resin in the flexible printed substrate 49. The light reflected from the information-recorded surface of the optical disk is transmitted through the transparent glass substrate 118 and the transparent substrate 49d to reach the light-detecting portion 114a of the light-receiving element 114. The transparent substrate 49d may be formed such that the through-hole 49a or a portion of the notch 49b as described hitherto is made of transparent resin, or may have another shape. By providing the transparent substrate 49d on the flexible printed substrate 49, the light reflected from the information-recorded surface of the optical disk can be efficiently guided to the light-receiving element 114 even when the above-described through-hole 49a or the notch 49b is not formed. In addition, when the transparent substrate 49d is provided on the flexible printed substrate 49, it is possible to form the light-receiving portion 3b of the long wavelength optical unit 3 with the transparent glass substrate 118 omitted. In addition, the transparent substrate 49d as the light-transmitting portion of the flexible printed substrate 49 may be composed of an opaque member or other members except resin as long as it allows light to be efficiently transmitted therethrough.

In addition, in FIG. 50, the transparent substrate 49d is provided in the flexible printed substrate 49. However, the transparent substrate 49d may not be provided when the flexible printed substrate 49 is made of transparent resin.

In addition, the light-receiving portion 3c can be configured similar to the light-receiving portion 3b of the long wavelength optical unit 3 as described above.

In addition, the above-described transparent glass substrate 118 and the light-transmitting portion such as the window 49c made of transparent glass may be composed of an opaque member or other members except glass as long as they can transmit the light efficiently.

As described with reference to FIGS. 36 to 50, by making the light-receiving unit 123 such that the transparent glass substrate 118 is fixed to the rear surface of the flexible printed substrate 49 on which the light-receiving element 114 is mounted by means of pressing and heating, with the adhesive 117 interposed therebetween, and the light-transmitting portion is formed in almost the middle portion between the electrode pads 116 formed in two rows on the flexible printed substrate 49, and the light reflected from the optical disk and incident from the transparent glass substrate 118 are allowed to reach the light-detecting portion 114a within the light-receiving element 114, the light-receiving portion can be formed at a low cost and the dimension of the optical pickup device in the thickness direction can be made small.

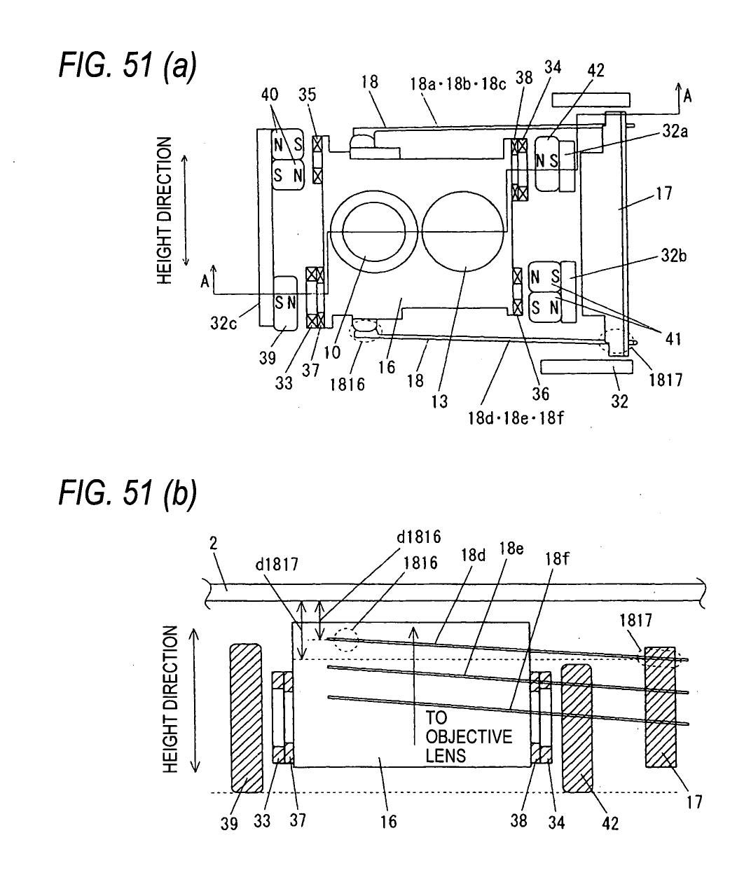

Next, a configuration of the magnets 39 to 42 of the optical pickup device will be described in detail with reference to FIGS. 51 to 53. In addition, members having different shapes from those shown in FIGS. 6 and 7 are shown in FIGS. 51 to 53, but the members having the same reference numerals has almost the same function.

First, the suspension 18 will be described with reference to FIG. 51. FIG. 51B is a schematic view illustrating the cross-section taken along the line A-A in FIG. 51A showing the optical pickup device in the present embodiment, and suspensions 18d, 18e, and 18f are also shown in the same drawing for description. FIG. 51B show the positional relation among the optical disk 2, the lens holder 16, the suspension holder 17, the suspensions 18d, 18e, and 18f, the focusing coils 33 and 34, the sub-tracking coils 37 and 38, and the magnets 39 and 42 when current do not flow through the focusing coils 33 and 34, the tracking coils 35 and 36, and the sub-tracking coils 37 and 38, that is, when the lens holder 16 is not driven.

In addition, referring to FIG. 51B, reference numerals are given for describing the suspension 18d, but the suspensions 18e and 18f are provided substantially parallel to the suspension 18d between the lens holder 16 and the suspension holder 17, thereby obtaining the same effect. In addition, suspensions 18a, 18b, and 18c which are not shown and located opposite to the suspensions 18d, 18e, and 18f with respect to the lens holder 16 are the same case. Accordingly, the suspension 18a, 18b, 18c, 18d, 18e, and 18f are collectively referred to as the suspension 18.

Referring to FIG. 51, reference numeral 1816 denotes a coupling portion for coupling the suspension 18 with the lens holder 16, and 1817 denotes a coupling portion for coupling the suspension 18 with the lens holder 17. The suspension 18 is elastically deformed at the suspension holder 17 other than the coupling portion 1816 and at the lens holder 16 other than the coupling portion 1817, that is, between the coupling portions 1816 and 1817, to move the lens holder 16 in the height and width direction and width directions shown in FIG. 51.

In addition, as shown in FIG. 51B the coupling portion 1816 for coupling the suspension 18 with the lens holder 16 is located closer to the objective lens 10 and 13 than the coupling portion 1817 for coupling the suspension 18 with the suspension holder 17. In this case, the side of the objective lenses 10 and 13 representing the side of the focusing member in the optical pickup device of the present embodiment means a direction that short wavelength laser light or long wavelength laser light, which has been emitted from the short wavelength optical unit 1 or the long wavelength optical unit 3 and transmitted through the beam splitter 7 or the collimator lens 8, is emitted toward the optical disk 2 from the objective lens 13 or the objective lens 10. This will be described in a relation with the optical disk 2 later.

Reference numeral d1816 and d1817 denote distances between the coupling portions 1816 and 1817 and the surface of on the optical disk 2 which is mounted on the spindle motor 25 and on which information is recorded, respectively. As shown in FIG. 51B, the relationship between d1816 and d1817 during of non-drive of the lens holder 16, is d1816<d1817. That is, the suspension 18 is supported to be inclined by means of the suspension holder 17 in a direction closer to the optical disk 2, thereby elastically supporting the lens holder 16. In other words, the coupling portion 1817 for coupling the suspension 18 with the suspension holder 17 has a longer distance from the optical disk than the coupling portion 1816 for coupling the suspension 18 with the lens holder 16.

With this structure, since the suspension holder 17 can support the suspension 18 at a position apart from the optical disk 2, the suspension holder 17 itself can be disposed at a lower position in the optical pickup device, which allows the optical disk apparatus to be small-sized.

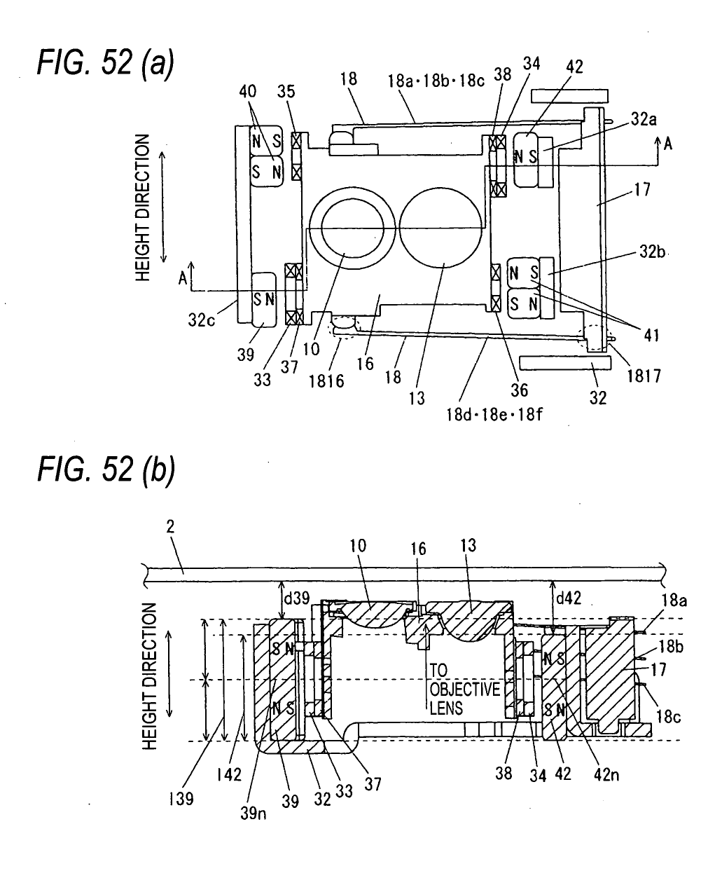

Next, the magnets 39 to 42 will be described with reference to FIG. 52. FIG. 52B is a schematic view illustrating the cross-section taken along the line A-A in FIG. 52A.

Referring to FIG. 52, the magnets 39 and 42 are focusing magnets for driving the lens holder 16 in the height direction as shown in FIG. 52, and the magnets 40 and 41 are tracking magnets for driving the lens holder 16 in the width direction as shown in FIG. 52. Similar to FIGS. 6 and 7, the magnets 39 to 42 are disposed and polarized as described with reference to FIGS. 6 to 8, and the magnet 42 as the focusing magnet is disposed between the lens holder 16 and the suspension holder 17, the magnet 39 as the focusing magnet is disposed opposite to the magnet 42 with respect to the lens holder 16, the magnet 41 as the tracking magnet is disposed between the lens holder 16 and the suspension holder 17, and the magnet 40 as the tracking magnet is disposed opposite to the magnet 41 with respect to the lens holder 16. In addition, the magnet 39 and the magnet 42 are disposed at diagonally opposite positions of the lens holder 16, and the magnet 40 and the magnet 41 are disposed at the other diagonally opposite positions of the lens holder 16. In addition, an end of each of the magnets 39 to 42 opposite to an end thereof at the optical disk 2 in the height direction, that is, the lower end of each of the magnets 39 to 42 is on the same plane, and each of the magnets 39 to 42 is disposed in a direction that its long side is substantially vertical to the information-recorded surface of the optical disk 2 mounted on the spindle motor 25.

In addition, each of the magnets 40 and 41 is composed of one magnet in FIG. 6. However, each of the magnets 40 and 41 may be composed of two magnets as shown in FIG. 52A. The magnet 40 is disposed such that an N pole of one of two magnets and an S pole of the other magnet are exposed to face the tracking coil 35, and that the poles are exposed to face the tracking coil 35 in the order of S pole and N pole toward the suspensions 18a, 18b, 18c from the central surfaces (A-A section in FIG. 6) of the suspensions 18a, 18b, and 18c and the suspensions 18d, 18e, and 18f in the width direction, and the magnet 41 is disposed such that an N pole of one of two magnets and an S pole of the other magnet are exposed to face the tracking coil 36, and that the poles are exposed to face the tracking coil 36 in the order of N pole and S pole toward the suspensions 18d, 18e, and 18f from the central surface (A-A section in FIG. 6) of the suspensions 18a, 18b, 18c and the suspensions 18d, 18e, and 18f in the width direction. With this structure, poles can be disposed as described with reference to FIG. 6, and when one magnet is employed as described with reference to FIG. 6, non-polarized portions of the magnets 40 and 41, which occur at positions where the direction of a pole of each of the magnets 40 and 41 is changed, can be made small, and the operation sensitivity of the lens holder 16 in the width direction can be enhanced.

Referring to FIG. 52B, the magnets 39 and 42 as focusing magnets for driving the lens holder 16 in the height direction will be described in detail.

As shown in FIG. 52B, the magnet 39 disposed opposite to the lens holder 16 is configured to protrude closer to the objective lenses 10 and 13 than the magnet 42 disposed between the lens holder 16 and the suspension holder 17.

Hereinafter, the relationship with the optical disk will be described.

Referring to FIG. 52B, reference numerals 139 and 142 denote the length of the magnets 39 and 42 in its height direction, respectively, that is, denote the length of the long side of the magnets 39 and 42, respectively, and d39 and d42 denote the distance from the information-recorded surface on the optical disk 2 mounted on the spindle motor 25 to the magnets 39 and 42, respectively.

The length relation between the magnet 39 and the magnet 42 is 139>142, that is, the magnet 42 is shorter than the magnet 39. In addition, dimensions d39, d42, 139, and 142 related to the magnets 39 and 42 are such that d39+139≅d42+142, and the distance from the optical disk 2 to the lower end of the magnet 39 is approximately equal to the distance from the optical disk 2 to the lower end of the magnet 42. In other words, the distance from the information-recorded surface of the optical disk 2 mounted on the spindle motor 25 to an end of the magnet 39 opposite to the end thereof at the optical disk 2 in the height direction, becomes approximately equal to the distance from the information-recorded surface of the optical disk mounted on the spindle motor 25 to an end of the magnet 42 opposite to the end thereof at the optical disk 2 in the height direction. Accordingly, the relation between a gap d39 between the optical disk 2 and the magnet 39 and a gap d42 between the optical disk 2 and the magnet 42 is d39<d42, that is, an end of the magnet 42 at the optical disk 2 in the height direction is made longer than an end of the magnet 39 at the optical disk 2 in terms of the distance from the optical disk 2.

In addition, the distance to an end of the magnet 42 at the optical disk 2 in the height direction is made longer than the distance to an end of the magnet 39 at the optical disk 2, in terms of the distance from a surface extended from an optical-disk mounted surface as a surface of the spindle motor 25 where the optical disk 2 is mounted.

In addition, the distance to an end of the magnet 42 at the optical disk 2 in the height direction is made longer than an end of the magnet 39 at the optical disk 2 in terms of the distance from a case of the optical disk apparatus at the objective lenses 10 and 13.

In addition, the gap between the optical disk 2 and each of the magnets 40 and 41 as tracking magnets for driving the lens holder 16 in the width direction is approximately equal to d39, and the ends of the magnets 40 and 41 at the optical disk 2 in the height direction is at almost the same distance as the end of the magnet 39 at the optical disk 2. In addition, the length of the magnets 40 and 41 in the height direction, that is, the length of the long side of the magnets 40 and 41 is equal to that of the magnet 39, and is denoted as reference numeral 139. In addition, the distance from the optical disk 2 to the lower end of each of the magnets 40 and 41 is approximately equal to the distance from the optical disk 2 to the lower end of the magnet 39, and is about d39+139. That is, the distance from the information-recorded surface of the optical disk 2 mounted on the spindle motor 25 to an end of each of the magnets 39 to 42 opposite to the end thereof at the optical disk 2 in the height direction is approximately equal to each other, in other words, a lower surface of the magnets 39 to 42 formed by connecting an end of each of the magnets 39 to 42 opposite to the end thereof at the optical disk 2 in the height direction is configured to be substantially parallel to the information-recorded surface of the optical disk 2.

In addition, as shown in FIG. 52B, the magnet 39 and the magnet 42 are polarized and disposed as described with reference to FIGS. 6 and 7, and reference numerals 39n and 42n are neutral zones where the directions of the respective magnetic poles of the magnets 39 and 42 are changed and not polarized. The neutral zone 39n is disposed at a position about half of the magnet 39 in the direction of its long side, and the distance from the lower end of the magnet 42 to the neutral zone 42n is made approximately equal to the distance from the lower end of the magnet 39 to the neutral zone 39n. That is, a plane formed by connecting the neutral zone 39n and the neutral zone 42n becomes substantially parallel to the lower surface of the magnets 39 to 42, and at the time of non-drive of the lens holder 16, a substantially middle position between the focusing coils 33 and 34 and the sub-tracking coils 37 and 38 in the height direction coincides with the height position of the plane which is formed by connecting the neutral zone 39n and the neutral zone 42n. In other words, a portion of the S pole of the magnet 39 facing the focusing coil 33 and the sub-tracking coil 37, a portion of the N pole of the magnet 39 facing the focusing coil 33 and the sub-tracking coil 37, and a portion of the S pole of the magnet 42 facing the focusing coil 34 and the sub-tracking coil 38 become approximately equal to each other in their area. However, a portion of the N pole of the magnet 42 facing the focusing coil 34 and the sub-tracking coil 38 is smaller than the above-described portions in terms of area. With this structure, tilting of the lens holder 16 occurring during driving of the lens holder 16 can be suppressed to a low level.

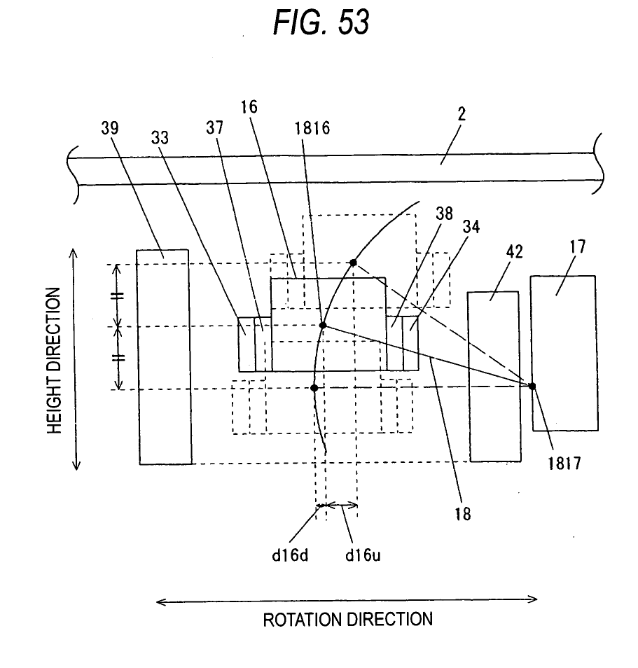

FIG. 53 is a schematic view for explaining the behavior of the lens holder 16, which shows the behavior of the lens holder 16 when the lens holder 16 is moved up and down in the height direction by allowing current to flow through the focusing coils 33 and 34. Referring to FIG. 53, the suspensions 18a, 18b, 18c, 18d, 18e, and 18f described up to now are collectively referred to as the suspension 18. The suspension 18 is shown as a substantially straight line in FIG. 51B at the time of non-drive of the lens holder 16 when seen from a width direction shown in FIG. 51, and is fixed to the lens holder 16 and the suspension holder 17 at the coupling portions 1816 and 1817, respectively. Thus the suspension 18 itself is bent at the time of driving of the lens holder 16 to cause the lens holder 16 to be moved in the height direction, but the shape of the suspension 18 at the time of driving the lens holder 16 is schematically shown as a substantially straight line in FIG. 53.

When the lens holder 16 is moved up and down by the same distance in the height direction from a non-drive position shown by the solid line in FIG. 53, the suspension 18 is stretched to be inclined with respect to the information-recorded surface of the optical disk 2. Thus the amount of movement of the optical disk 2 in the rotation direction (tangential direction) as shown in FIG. 53 has a big difference.

When the lens holder 16 is caused to move away from the optical disk 2 by allowing current to flow through the focusing coils 33 and 34, a gap between the focusing coil 33 and the magnet 39 is not significantly different from a gap between the focusing coil 34 and the magnet 42.

Accordingly, a big difference does not occur between an electromagnetic force generated in the focusing coil 34 and an electromagnetic force generated in the focusing coil 33.

In the meantime, when the lens holder 16 is caused to move toward the optical disk 2 by allowing current to flow through the focusing coils 33 and 34, a difference increases between the gap between the focusing coil 33 and the magnet 39 and the gap between the focusing coil 34 and the magnet 42. As the lens holder 16 moves toward the optical disk 2, the gap between the focusing coil 33 and the magnet 39 increases and an electromagnetic force generated in the focusing coil 33 decreases. However, since the magnet 42 is configured to be disposed at a lower position than the magnet 39 in the height direction, lines of magnetic fields through the focusing coil 33 decrease with the movement of the lens holder 16 toward the optical disk 2, the electromagnetic force generated in the focusing coil 34 is also decreased. Accordingly, even when the lens holder 16 moves toward the optical disk 2, since a big difference between the electromagnetic force generated in the focusing coil 34 and the electromagnetic force generated in the focusing coil 33 does not occur, tilting of the lens holder 16 can be suppressed to a low level.

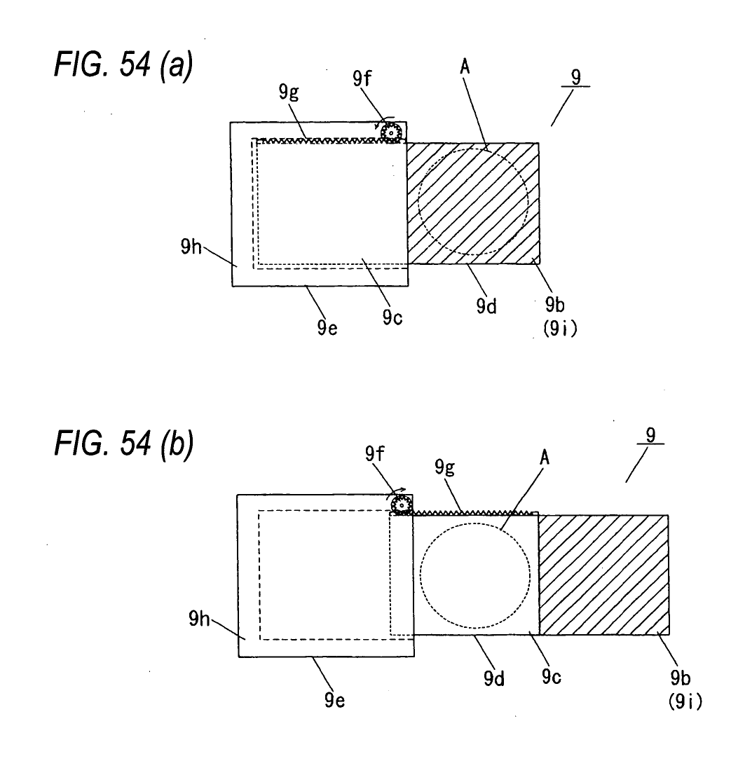

Next, the starting mirror 9 of the optical pickup device will be described with reference to FIGS. 54 to 59. In addition, members shown in FIGS. 54 to 59 are a little different in shape from those shown in FIGS. 1 and 5, but the members having the same reference numerals have almost the same function. Furthermore, although not shown, the ¼ wavelength member 9a shown in FIGS. 1 and 5 is provided in the optical pickup device shown in FIGS. 54 to 59.

The starting mirror 9 may also be configured as described below with reference to FIG. 54.

FIG. 54 is a view illustrating the starting mirror 9 when seen from the z direction in a direction of a light flux of the laser light emitted from the short wavelength optical unit 1 or the long wavelength optical unit 3 transmitted through the beam splitter 7 or the collimator lens 8, as shown in FIG. 5, and a symbol A shown in FIG. 54 denotes a light flux of the laser light arrived at the starting mirror 9.

Referring to FIG. 54, the starting mirror 9 is provided with a reflecting plate 9d as a switching means having a wavelength selection film 9b and a reflecting portion 9c, and an actuator 9e for moving the reflecting plate 9d. The wavelength selection film 9b and the reflecting portion 9c are provided on a surface of the reflecting plate 9d at the beam splitter 7, and are made of a dielectric multi-film or metal.

The wavelength selection film 9b formed in the reflecting plate 9d has a function of transmitting most of the light having a predetermined wavelength without depending on the polarization state, and reflecting most of the light having a different wavelength without depending on the polarization state. In the present embodiment, the wavelength selection film is configured to transmit short wavelength light (e.g. light having a wavelength of about 405 nm) emitted from the short wavelength optical unit 1 and reflect red color light (e.g. light having a wavelength of about 660 nm) and infrared light (e.g. light having a wavelength of about 780 nm) emitted from the long wavelength optical unit 3. That is, the wavelength selection film in the present embodiment has the same structure and the function as the wavelength selection film 9b described with reference to FIG. 1.

The reflecting portion 9c formed in the reflecting plate 9d has a function of reflecting most of the arrived laser light without depending on the wavelength or the polarization state. In addition, when the wavelength selection film 9b and the reflecting portion 9c are formed in the reflecting plate 9d, the reflecting portion 9c may reflect light having a predetermined wavelength without depending on the polarization state, and in the present embodiment, the reflecting portion 9c may be configured to reflect at least the short wavelength light (e.g. light having a wavelength of about 405 nm) emitted from the short wavelength optical unit 1.

The actuator 9e is provide with a gear 9f, a motor (not shown), or the like, and the motor rotates the gear 9f. A small-sized direct-current motor is used as the motor. In the meantime, a rack gear 9g is disposed at one side of the reflecting plate 9d and is engaged with the gear 9f. The reflecting plate 9d and the case 9h are slidably configured.

In the optical pickup device having the above-described reflecting plate 9d, when the optical disk 2 is mounted on the spindle motor 25 described with reference to FIGS. 2 to 4, a control member (not shown) determines the type of the optical disk 2 and applies control signals to the actuator 9e. The actuator 9e rotates the gear 9f by driving the motor by means of the control signals so that the reflecting plate 9d enters or exits the case 9h of the actuator 9e. In addition, the actuator 9e acts to move the reflecting plate 9d by using the motor in the present example, but it may be configured to move the reflecting plate 9d by using a solenoid, a linear motor, a hydraulic piston or the like as long as the actuator 9e is driven by the control signals.

FIG. 54A shows a state in which the reflecting plate 9d is moved by the actuator 9e and the wavelength selection film 9b is present on the optical path, and FIG. 54B shows a state in which the reflecting plate 9d is moved by the actuator 9e and the reflecting portion 9c is present on the optical path.

Hereinafter, the movement of the reflecting plate 9d will be described in response to types of the optical disk 2 mounted on the spindle motor 25.

When recording and reproducing of information are carried out on the optical disk 2 by using the short wavelength light (e.g. light having a wavelength of about 405 nm) and the distance between the recording layer and the surface of the optical disk 2 mounted on the spindle motor 25 is 0.1 mm, the starting mirror 9 allows the wavelength selection film 9b of the reflecting plate 9d to be present on the optical path by the drive of the actuator 9e.

In addition, even when recording and reproducing of information are carried out on the optical disk 2 by using the red color light (e.g. light having a wavelength of about 660 nm) and the distance between the recording layer and the surface of the optical disk 2 mounted on the spindle motor 25 is 0.6 mm, the starting mirror 9 allows the wavelength selection film 9b of the reflecting plate 9d to be present on the optical path by the drive of the actuator 9e.

In addition, even when recording and reproducing of information are carried out on the optical disk 2 by using the infrared light (e.g. light having a wavelength of about 780 nm) and the distance-between the recording layer and the surface of the optical disk 2 mounted on the spindle motor 25 is 1.2 mm, the starting mirror 9 allows the wavelength selection film 9b of the reflecting plate 9d to be present on the optical path by the drive of the actuator 9e.

Alternatively, when recording and reproducing of information are carried out on the optical disk 2 by using the short wavelength light (e.g. light having a wavelength of about 405 nm) and the distance between the recording layer and the surface of the optical disk 2 mounted on the spindle motor 25 is 0.6 mm, the starting mirror 9 allows the reflecting portion 9c of the reflecting plate 9d to be present on the optical path by the drive of the actuator 9e. Furthermore, when recording and reproducing of information are carried out on the optical disk 2 by using the red color light (e.g. light having a wavelength of about 660 nm) and the distance between the recording layer and the surface of the optical disk 2 mounted on the spindle motor 25 is 0.6 mm and by using the infrared light (e.g. light having a wavelength of about 780 nm) and the distance between the recording layer and the surface of the optical disk 2 mounted on the spindle motor 25 is 1.2 mm, the reflecting portion 9c of the reflecting plate 9d may be present on the optical path by the drive of the actuator 9e.

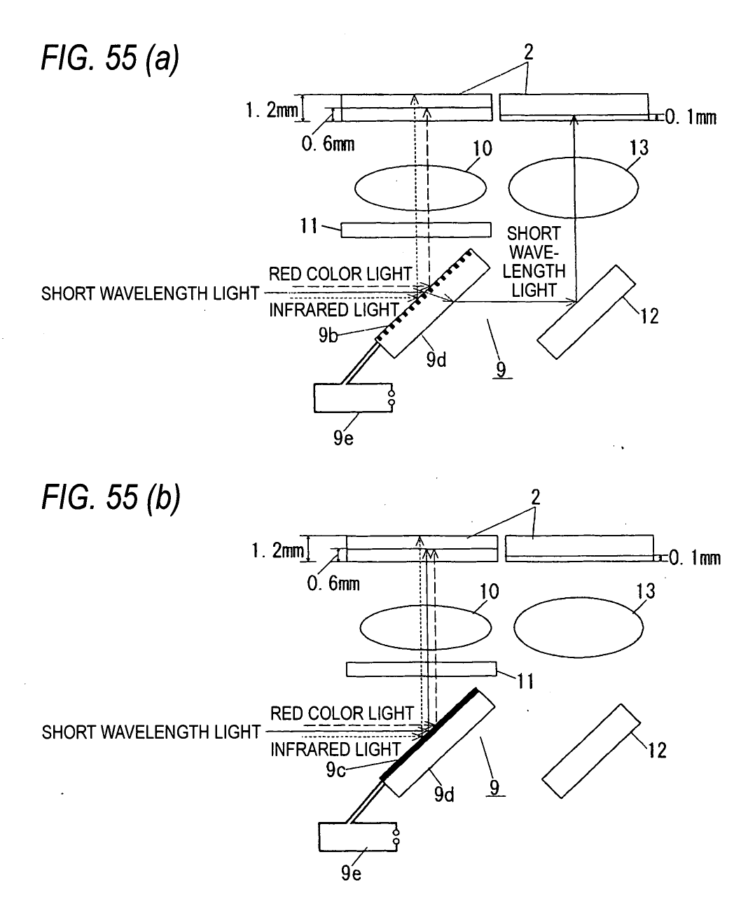

FIG. 55 is a schematic view illustrating an optical path of the laser light in the optical pickup device using the starting mirror 9 in FIG. 54, and FIG. 55A shows a state in which the wavelength selection film 9b is present on the optical path, and FIG. 55B shows a state in which the reflecting portion 9c is present on the optical path. In addition to the structure described with reference to FIG. 1, the optical component 11 provided between the starting mirror 9 and the objective lens 10 has an aperture filter of implementing the required numerical aperture for the optical disk 2 carrying out recording and reproducing of information with the short wavelength light (e.g. light having a wavelength of about 405 nm) and the distance of 0.6 mm between the surface of the optical disk 2 and the recording layer, and an auxiliary hologram having its wavelength selectivity reacting to the short wavelength light (e.g. light having a wavelength of about 405 nm) and carrying out correction on the spherical aberration and the color correction. The aperture filter and the auxiliary hologram may be integrally formed with the optical component 11 or separately formed therefrom.

Hereinafter, an optical path of the optical pickup device will be described according to a difference of types of the optical disk 2 mounted on the spindle motor 25.

When recording and reproducing of information are carried out on the optical disk 2 by using the short wavelength light (e.g. light having a wavelength of about 405 nm) and the distance between the recording layer and the surface of the optical disk 2 mounted on the spindle motor 25 is 0.1 mm, the starting mirror 9 allows the wavelength selection film 9b of the reflecting plate 9d to be present on the optical path as shown in FIG. 55A, and the short wavelength light (e.g. light having a wavelength of about 405 nm) emitted from the short wavelength optical unit 1 and transmitted through the beam splitter 7 or the collimator lens 8 is transmitted through the wavelength selection film 9b of the starting mirror 9, reflected by the starting mirror 12, transmitted through the objective lens 13, and then focused on the recording layer located 0.1 mm away from the surface of the optical disk 2.

In addition, even when recording and reproducing of information are carried out on the optical disk 2 by using the red color light (e.g. light having a wavelength of about 660 nm) and the distance between the recording layer and the surface of the optical disk 2 mounted on the spindle motor 25 is 0.6 mm, the starting mirror 9 allows the wavelength selection film 9b of the reflecting plate 9d to be present on the optical path as shown in FIG. 55A, and the red color light (e.g. light having a wavelength of about 660 nm) emitted from the long wavelength optical unit 3 and transmitted through the beam splitter 7 or the collimator lens 8 is reflected by the wavelength selection film 9b of the starting mirror 9, transmitted through the optical component 11 and the objective lens 10, and then focused on the recording layer located 0.6 mm away from the surface of the optical disk 2.

In addition, even when recording and reproducing of information are carried out on the optical disk 2 by using the infrared light (e.g. light having a wavelength of about 780 nm) and the distance between the recording layer and the surface of the optical disk 2 mounted on the spindle motor 25 is 1.2 mm, the starting mirror 9 allows the wavelength selection film 9b of the reflecting plate 9d to be present on the optical path as shown in FIG. 55A, and the infrared light (e.g. light having a wavelength of about 780 nm) emitted from the long wavelength optical unit 3 and transmitted through the beam splitter 7 or the collimator lens 8 is reflected by the wavelength selection film 9b of the starting mirror 9, transmitted through the optical component 11 and the objective lens 10, and then focused on the recording layer located 1.2 mm away from the surface of the optical disk 2.

In the meantime, when recording and reproducing of information are carried out on the optical disk 2 by using the short wavelength light (e.g. light having a wavelength of about 405 nm) and the distance between the recording layer and the surface of the optical disk 2 mounted on the spindle motor 25 is 0.6 mm, the starting mirror 9 allows the reflecting portion 9c of the reflecting plate 9d to be present on the optical path as shown in FIG. 55B, and the short wavelength light (e.g. light having a wavelength of about 405 nm) emitted from the short wavelength optical unit 1 and transmitted through the beam splitter 7 or the collimator lens 8 is reflected by the wavelength selection film 9b of the starting mirror 9, transmitted through the optical component 11 and the objective lens 10, and then focused on the recording layer located 0.6 mm away from the surface of the optical disk 2.

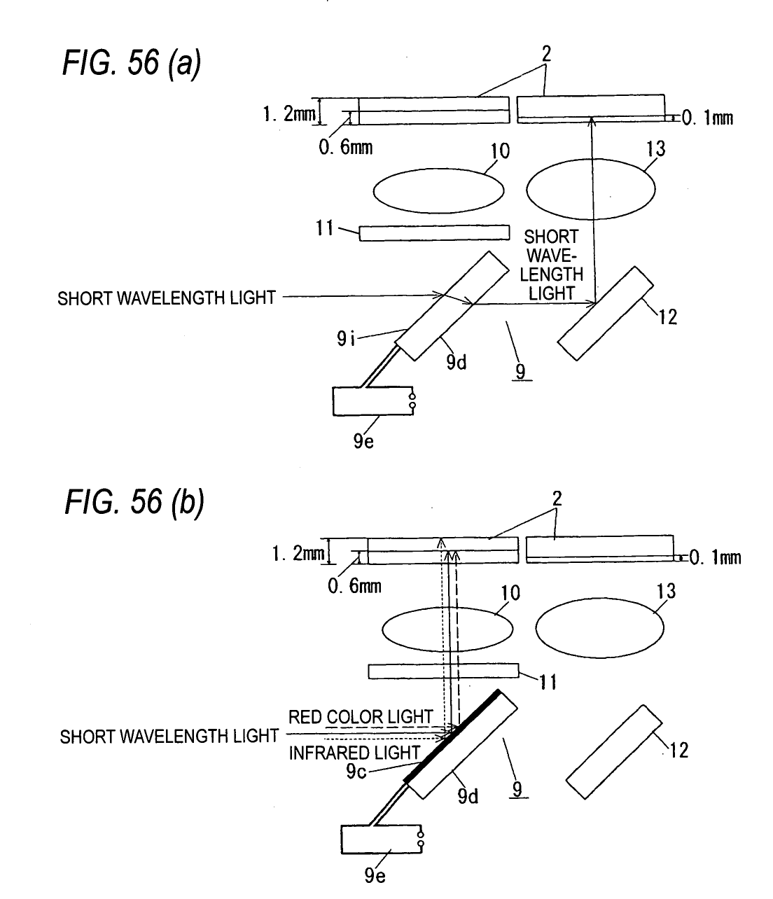

In addition, the reflecting plate 9d of the starting mirror 9 described may be similarly applied to the structure described below with reference to FIGS. 54 and 56. In particular, the same structure as that described with reference to FIGS. 54 and 55 will be employed for the portion which is not particularly described.

In the wavelength selection film 9b shown in FIG. 54, a base material portion 9i where a base material of the reflecting plate 9d is exposed without forming the wavelength selection film 9b is formed, and a surface of the reflecting plate 9d at the beam splitter 7 is configured to have a portion (base material portion 9i) not having the reflecting portion 9c and a portion having the reflecting portion 9c described with reference to FIG. 54.

The base material portion 9i formed in the reflecting plate 9d has a function of transmitting most of the arrived laser light without depending on the wavelength or the polarization state. In addition, when the base material portion 9i and the reflecting portion 9c are formed in the reflecting plate 9d, the base material portion 9i may be one which allows light having a predetermined wavelength to be transmitted without depending on the polarization state, and in the present example, the base material portion 9i may be configured to allow at least the short wavelength light (e.g. light having a wavelength of about 405 nm) emitted from the short wavelength optical unit 1 to be reflected.

The reflecting portion 9 formed in the reflecting plate 9d has a function of reflecting most of the arrived laser light without depending on the wavelength or the polarization state. In this case, the reflecting plate is configured to reflect at least the short wavelength light (e.g. light having a wavelength of about 405 nm) emitted from the short wavelength optical unit 1, red color light (e.g. light having a wavelength of about 660 nm) emitted from the long wavelength optical unit 3, and infrared light (e.g. light having a wavelength of about 780 nm).

Hereinafter, the movement of the reflecting plate 9d provided with the base material portion 9i and the reflecting portion 9c according to the optical disk 2 mounted on the spindle motor 25 will be described.

When recording and reproducing of information are carried out on the optical disk 2 by using the short wavelength light (e.g. light having a wavelength of about 405 nm) and the distance between the recording layer and the surface of the optical disk 2 mounted on the spindle motor 25 is 0.1 mm, the starting mirror 9 allows the base material portion 9i of the reflecting plate 9d to be present on the optical path by the drive of the actuator 9e.

In the meantime, when recording and reproducing of information are carried out on the optical disk 2 by using the red color light (e.g. light having a wavelength of about 660 nm) and the distance between the recording layer and the surface of the optical disk 2 mounted on the spindle motor 25 is 0.6 mm, the starting mirror 9 allows the reflecting portion 9c of the reflecting plate 9d to be present on the optical path by the drive of the actuator 9e.

In addition, even when recording and reproducing of information are carried out on the optical disk 2 by using the infrared light (e.g. light having a wavelength of about 780 nm) and the distance between the recording layer and the surface of the optical disk 2 mounted on the spindle motor 25 is 1.2 mm, the starting mirror 9 allows the reflecting portion 9c of the reflecting plate 9d to be present on the optical path by the drive of the actuator 9e.

In addition, even when recording and reproducing of information are carried out on the optical disk 2 by using the short wavelength light (e.g. light having a wavelength of about 405 nm) and the distance between the recording layer and the surface of the optical disk 2 mounted on the spindle motor 25 is 0.6 mm, the starting mirror 9 allows the reflecting portion 9c of the reflecting plate 9d to be present on the optical path by the drive of the actuator 9e.

FIG. 56 is a schematic view illustrating the optical path of the laser light in the optical pickup device using the starting mirror 9 provided with the base material portion 9i and the reflecting portion 9c, and FIG. 56A shows a state in which the base material portion 9i is present on the optical path, and FIG. 56B shows a state in which the reflecting portion 9c is present on the optical path.

As shown in FIG. 56, as for the optical path of the laser light, the case of using the reflecting plate 9d provided with the base material portion 9i and the reflecting portion 9c is the same as the case of using the reflecting plate 9d described with reference to FIGS. 54 and 55.

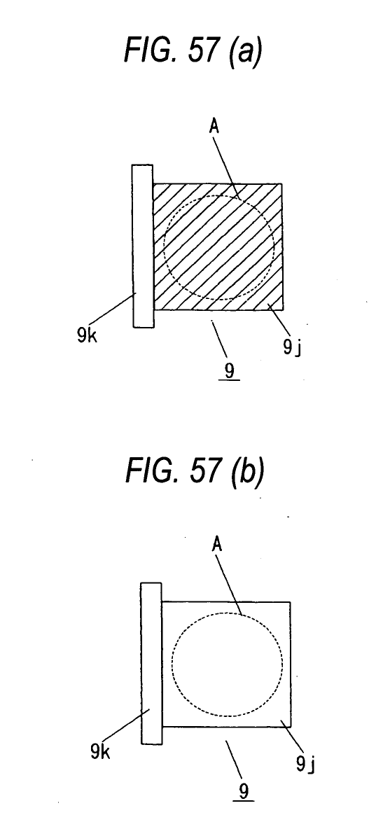

In addition, the starting mirror 9 may be configured as described below with reference to FIG. 57.

Similar to FIG. 54, FIG. 57 shows the starting mirror 9 seen from the z direction in a direction of a light flux of the laser light which has been transmitted through the beam splitter 7 or the collimator lens 8 after emitted from the short wavelength optical unit 1 or the long wavelength optical unit 3 shown in FIG. 5, and a symbol A shown in FIG. 57 denotes a light flux of the laser light which has reached the starting mirror 9.

Referring to FIG. 57, an electric control layer 9j as a switching means whose optical characteristics are changed according to control signals, and a signal applying portion 9k for applying the control signals to the electric control layer 9j are formed on a surface of the starting mirror 9 at the beam splitter 7.

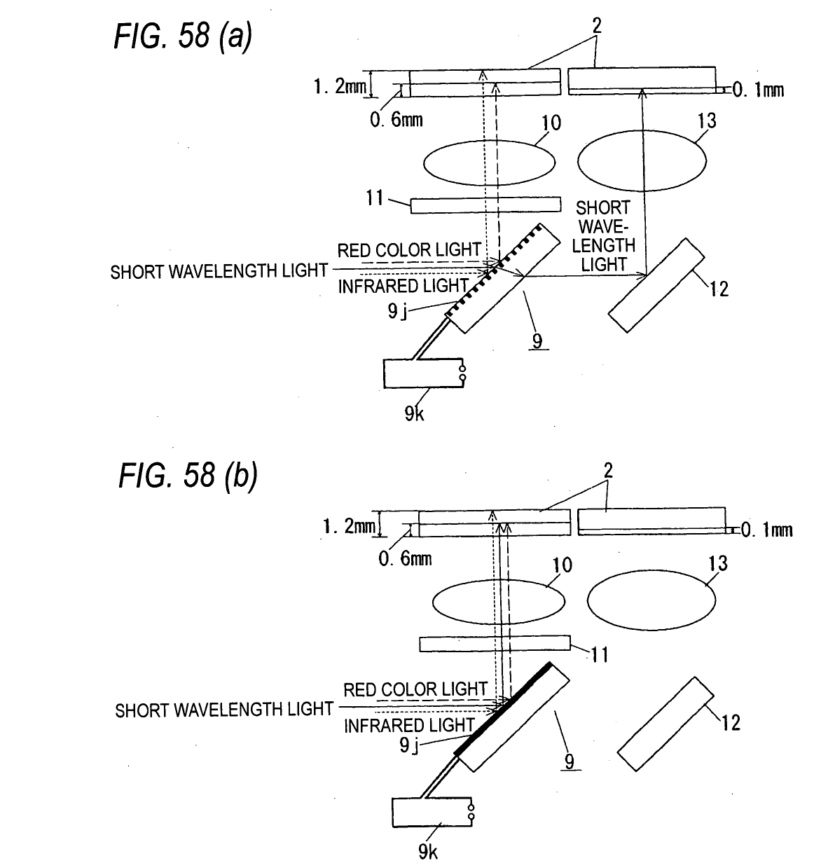

The electric control layer 9j has two states switched by the control signals, that is, a state of the wavelength selection film 9b and a state of the reflecting portion 9c described with reference to FIG. 54. The state of the electric control layer 9j is switched corresponding to the movement of the reflecting plate 9d described With reference to FIGS. 54 and 55 according to the type of the optical disk 2 mounted on the spindle motor 25, so that the optical path of the laser light can be switched in the same manner as FIG. 55 as shown in FIG. 58.

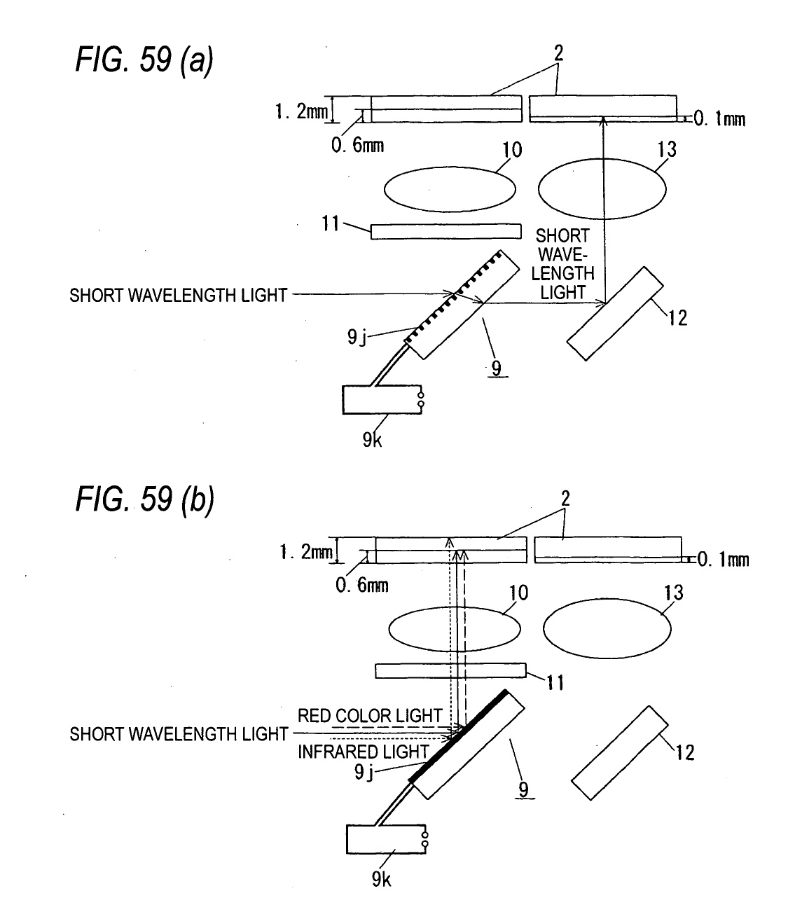

In addition, an electric control layer 9j has a state of the reflecting portion 9c and a state of the base material portion 91 described with reference to FIG. 54, and these two states are switched according to the control signals. The switching is carried out corresponding to the movement of the reflecting plate 9d described with reference to FIGS. 54 and 56 according to the type of the optical disk 2 mounted on the spindle motor 25, so that the optical path of the laser light can be switched in the same manner as FIG. 56 as shown in FIG. 59.

As such, according to the optical pickup device described with reference to FIGS. 54 to 59, since an optical path of the laser light can be switched according to the type of the optical disk 2, several kinds of recording and reproducing having different distances up to the recording layer or different wavelengths to be used can be carried out on the optical disk 2. In particular, the short wavelength light (e.g. light having a wavelength of about 405 nm) can be used to carry out recording and reproducing of information even on both sides of the optical disk 2 which has different distances between its surface and the recording layer such as 0.1 mm and 0.6 mm.

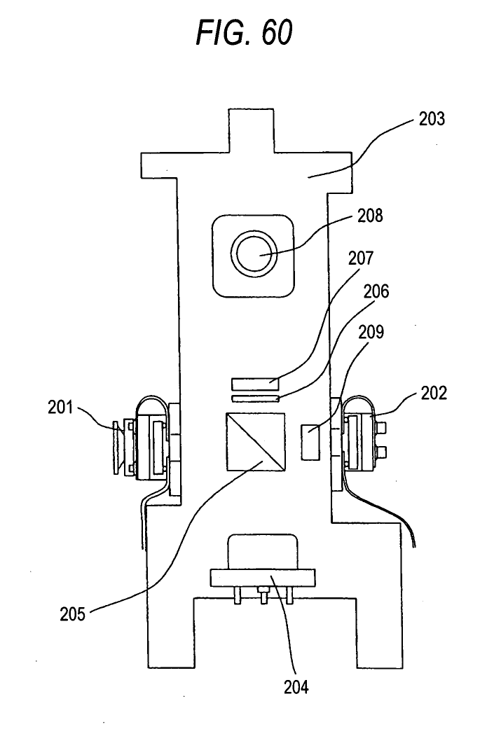

In addition, as described below, the light-receiving unit 1b of the short wavelength optical unit 1 or the light-receiving unit 3b of the long wavelength optical unit 3 described with reference to FIGS. 36 to 50 may also be applied to a light-receiving optical unit 202 for disk light described with reference to FIGS. 60, 63, and 64. In addition, the light-receiving unit 1c of the short wavelength optical unit 1 or the light-receiving unit 3c of the long wavelength optical unit 3 described with reference to FIGS. 36 to 50 may also be applied to a light-receiving optical unit 201 for previous light described with reference to FIGS. 60 to 62, and 65.

FIG. 60 is a schematic view illustrating an optical system of the optical pickup in accordance with an embodiment of the present invention. In addition, two types of light-receiving units are used for one optical pickup in the present embodiment. Referring to FIG. 60, reference numeral 201 denotes a light-receiving unit for previous light, 202 denotes a light-receiving unit for disk light, 204 denotes a laser diode, 205 denotes a polarization beam splitter, 206 denotes a ¼ wavelength plate, 207 denotes a collimator lens, 208 denotes an objective lens, and 209 denotes a cylindrical lens.

A simple operation of the optical system of the optical pickup shown in FIG. 60 will be described. A portion of the light emitted from the laser diode 204 is reflected at a right angle by the polarization beam splitter 205, and is then incident on the light-receiving unit 201 for previous light. The light-receiving unit 201 for previous light converts the incident light into electrical signals which are used to control the amount of light of the laser diode to a constant level. Light which is not reflected by the polarization beam splitter 205 among the light emitted from the laser diode 204 is focused on the objective lens 208 as spot light via the ¼ wavelength plate 206, the collimator 207, and a starting mirror (not shown), and arrives at the optical disk. The light reflected by the optical disk is reflected at a right angle by the polarization beam splitter 205 via the objective lens 208, the collimator lens 207, and the ¼ wavelength plate 206, and is incident on the light-receiving unit 202 for disk light via the cylindrical lens 209. The light incident on the light-receiving unit 202 for disk light is modulated by the information recorded on the optical disk and converted to electrical signals to be used for servo control of the objective lens 208 and reading information.

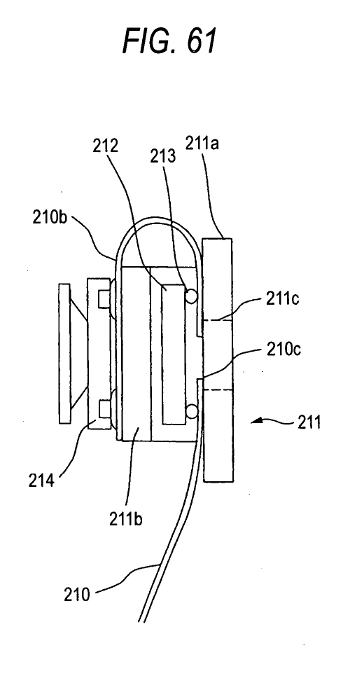

FIG. 61 is an enlarged side view illustrating the light-receiving unit 202 for disk light shown in FIG. 60. Referring to FIG. 61, reference numeral 210 denotes a flexible substrate, 211 denotes a light-receiving unit for previous light, 212 denotes a semiconductor chip for previous light, 213 denotes gold bumps, and 214 denotes a half-fixed resistor. The supporting plate 211 is formed such that one sheet of metal plate is bent by 180°, and is composed of a main portion 211 a for fixing the mounting portion of the semiconductor chip 212 for previous light, and a folded portion 211b for fixing the half-fixed resistor 214. A circular opening 211c is formed in the main portion 211a of the supporting plate, and a circular opening 210c is also formed in the flexible substrate 210, and all of these are caused to coincide with the position of a light-detecting portion formed on a surface of the semiconductor chip 212 for previous light so that the light emitted from the polarization beam splitter 205 reaches the light-detecting portion. The semiconductor chip 212 for previous light is a bare chip having no package, and is mounted on the flexible substrate 210 by means of the gold bumps 213. The flexible substrate 210 has a power supply terminal of the semiconductor chip 212 for previous light, a reference potential terminal, and wiring for connecting a signal output terminal to a connector of the optical pickup, while the flexible substrate has a region mounted with peripheral components of a light-receiving circuit near the light-receiving circuit mounting portion, as a folded portion 210b. After the folded portion 210b is adhered to the outside of the folded portion 211b of the supporting plate, the peripheral components of the light-receiving circuit are mounted thereon. The half-fixed resistor 214 is mounted as an example in FIG. 61. The half-fixed resistor 214 is a component required to adjust the output of the semiconductor chip 212 for previous light and the power of light emitted from the objective lens 208 to a predetermined ratio. The resistance value is adjusted while output signals are monitored when the laser diode emits light after assembly of the optical pickup to operate the light-receiving unit 201 for previous light. For readily adjusting the value, the half-fixed resistor 214 needs to be disposed to face the opposite side of the bonding plane between the carriage 203 and the light-receiving unit 201 for previous light.

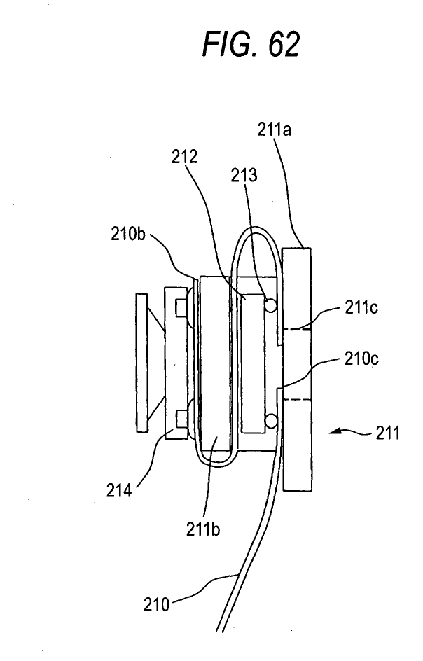

FIG. 62 is a side view illustrating an example in which the arrangement of the flexible substrate 210 of the light-receiving unit 201 for previous light is changed. When a single-surface-mounting-type flexible substrate 210 is used, as shown in FIG. 62, the folded portion of the flexible substrate 210 is folded two times, and then fixed to embrace both of the inner and outer surfaces of the folded portion 211 b of the supporting plate 211. Accordingly, the half-fixed resistor 214 can be mounted outside the folded portion 211b of the supporting plate 211. The arrangement of the flexible substrate 210 shown in FIG. 62 is suitable for a case where a signal frequency band is not relatively high because the wiring distance between the semiconductor chip for previous light 212 and the half-fixed resistor 214 becomes a little longer.

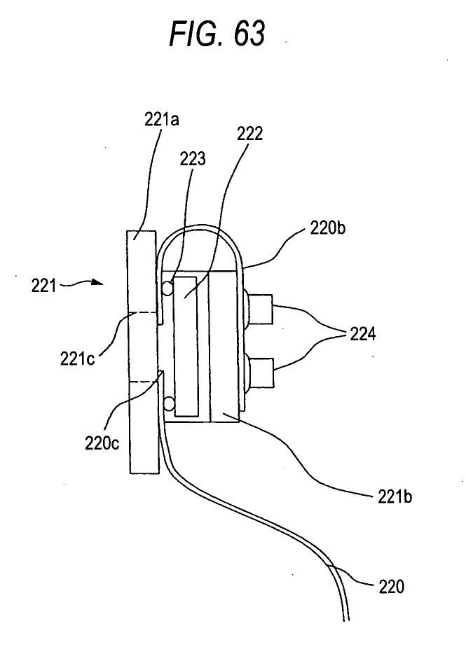

FIG. 63 is an enlarged side view illustrating the light-receiving unit 202 for disk light shown in FIG. 60. Referring to FIG. 63, reference numeral 220 denotes a flexible substrate, 221 denotes a supporting plate of the light-receiving unit for disk light, 222 denotes a semiconductor chip for disk light, and 223 denotes a gold bump, and its basic structure is almost the same as the light-receiving unit 201 for previous light. Referring to FIG. 63, an example is shown in which a ceramic capacitor 224 is mounted on a folded portion 220b of the flexible substrate 220 as a peripheral component. Since the light-receiving unit 202 for disk light processes high-frequency signals which require the accuracy of signals, a ceramic capacitor 224 is needed for stabilizing a power supply voltage or a reference voltage to reduce noises. The ceramic capacitor 224 is soldered after the folded portion 220b of the flexible substrate 220 is adhered and fixed to the outside of the folded portion 221b of the supporting plate 221.

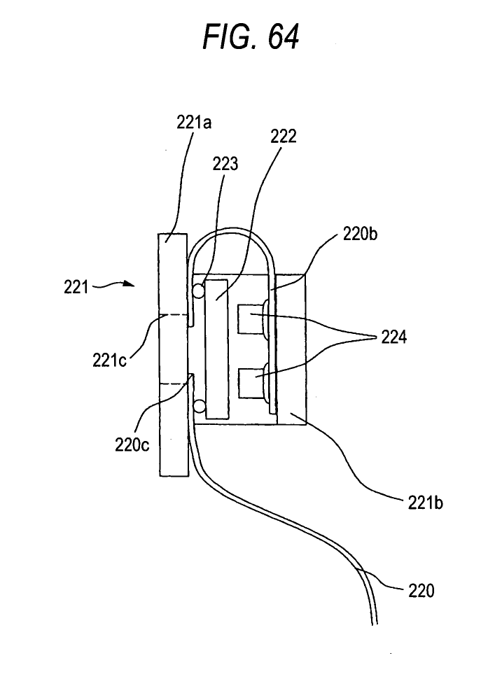

FIG. 64 is a side view illustrating an example in which positions of the peripheral components in the light-receiving unit 202 for disk light are changed. In a case of the single-surface-mounting-type flexible substrate 220 in which a mounting land of the ceramic capacitor 224 is on the same plane as the light-receiving unit 202 for disk light, the folded portion 220b of the flexible substrate 220 can be adhered and fixed to embrace the inside of the folded portion 221b of the supporting plate 221 as shown in FIG. 64. In this case, the ceramic capacitor 224 is mounted on the folded portion 220b of the flexible substrate 220 in advance, and then folded to be inserted into and adhered to the inside of the folded portion 221b of the supporting plate 221. The gap between the folded portion 221b and the main portion 221a of the supporting plate 221 needs to be sufficiently large.

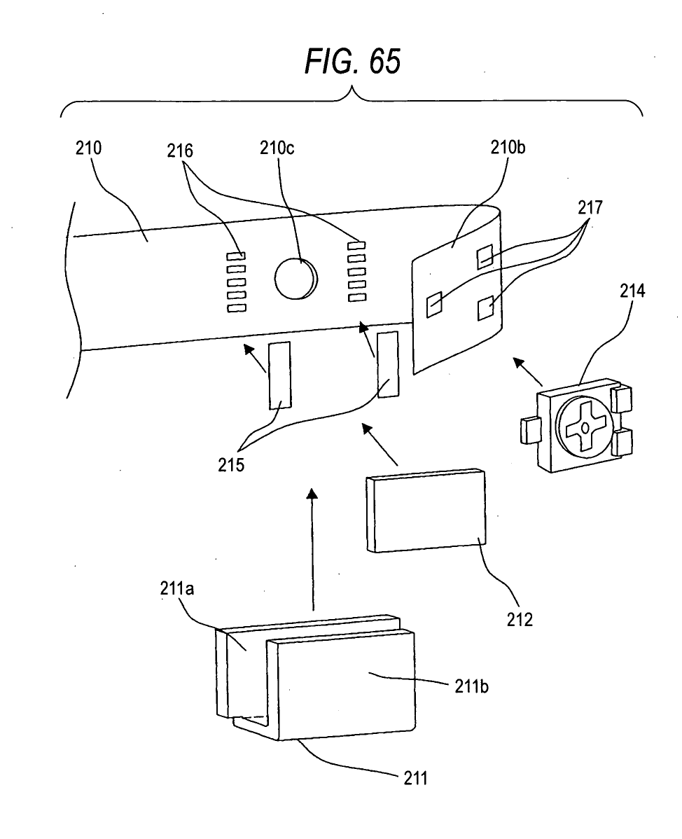

The procedure of assembling the light-receiving unit will be described with reference to the example of the light-receiving unit 201 for previous light. FIG. 65 is a perspective view illustrating the procedure of assembling the light-receiving unit 201 for previous light. Referring to FIG. 65, reference numeral 215 denotes an anisotropic conductive tape, 216 denotes semiconductor-chip mounting lands on the flexible substrate 210, and 217 denotes half-fixed resistor mounting lands. A method of mounting the semiconductor chip 212 on the flexible substrate 210 follows a method called a flip chip mounting method. The anisotropic conductive tape 215 is first attached to each column of the semiconductor chip mounting lands 216 on the flexible substrate 210. A gold bump 213 is then formed in each of the connection pads of the semiconductor chip 212 for previous light, and the gold bump 213 is aligned with each of the mounting lands 216. Thereafter, when pressure and heat are applied from a rear surface of the semiconductor chip 212 for previous light, the gold bumps 213 are electrically connected to the corresponding semiconductor chip mounting lands 216 via conductive particles within the anisotropic conductive tape 215. At the same time, resin as a main material of the anisotropic conductive tape 215 is melt and solidified in such a manner to surround the gold bumps 213, which acts to provide a protection by increasing the strength of a connected portion between the semiconductor chip 212 for previous light and the flexible substrate 210. Since the melt anisotropic conductive tape 215 may reach the peripheral edge of the opening 211c of the flexible substrate 210 due to a capillary phenomenon occurring from a narrow gap between the semiconductor chip 212 for previous light and the flexible substrate 210, it is necessary to make the size of the opening 211c larger than the size of the light-detecting portion of the semiconductor chip 212 so that the light-detecting portion of the semiconductor chip 212 is covered with the resin of the anisotropic conductive tape 215.

Thereafter, a central position of the opening 210c is caused to substantially coincide with a central position of the opening 211c such that the flexible substrate 210 is inserted between the main portion 211a and the folded portion 211b of the supporting plate 211. Then the flexible substrate 210 is adhered and fixed to the main portion 211a of the supporting plate 211. The folded portion 210b of the flexible substrate 210 is adhered and fixed to the outside of the folded portion 211b of the supporting plate 211, and the half-fixed resistor 214 is fixed on the mounting lands 217 by means of soldering. As clear from FIG. 65, since the supporting plate 211 is formed such that the main portion 211a and the folded portion 211b are formed by bending, it can be implemented at a low cost. In addition, by making the size of the main portion 211a of the supporting plate 211 slightly larger than the size of the semiconductor chip 212 for previous light, the flip chip mounting terminal of the semiconductor chip 212 for previous light can be prevented from being peeled off. Thus, the light-receiving unit for previous light 210 can be made small-sized. In addition, the procedure of assembling the light-receiving unit 201 for previous light has been described with reference to FIG. 65, but the procedure of assembling the light-receiving unit 202 for disk light is almost the same.

A method of mounting the light-receiving unit onto the carriage will be described. The light-receiving unit 201 for previous light and the light-receiving unit 202 for disk light are respectively adjusted for their positions in two directions vertical to an optical axis while output signals are considered so that light is properly incident on the light-detecting portions of the light-receiving units, and then bonded and fixed to the carriage 203. In this case, it is possible to avoid grasping the semiconductor chip itself or the soft and flexible substrate which may be easily damaged due to grasping of the supporting substrate 211 or the supporting substrate 221 for positional adjustment.

Since the carriage 203 and the supporting plates 211 and 221 are adjusted for their positions while being sled in close contact with each other, a plane having some adhering margins needs to be prepared in the carriage 203. Since the area of adhesion is small in the above-described light-receiving unit, the plane for adhesion in the carriage 203 can be made small. Thus the carriage 203 can be made small-sized.

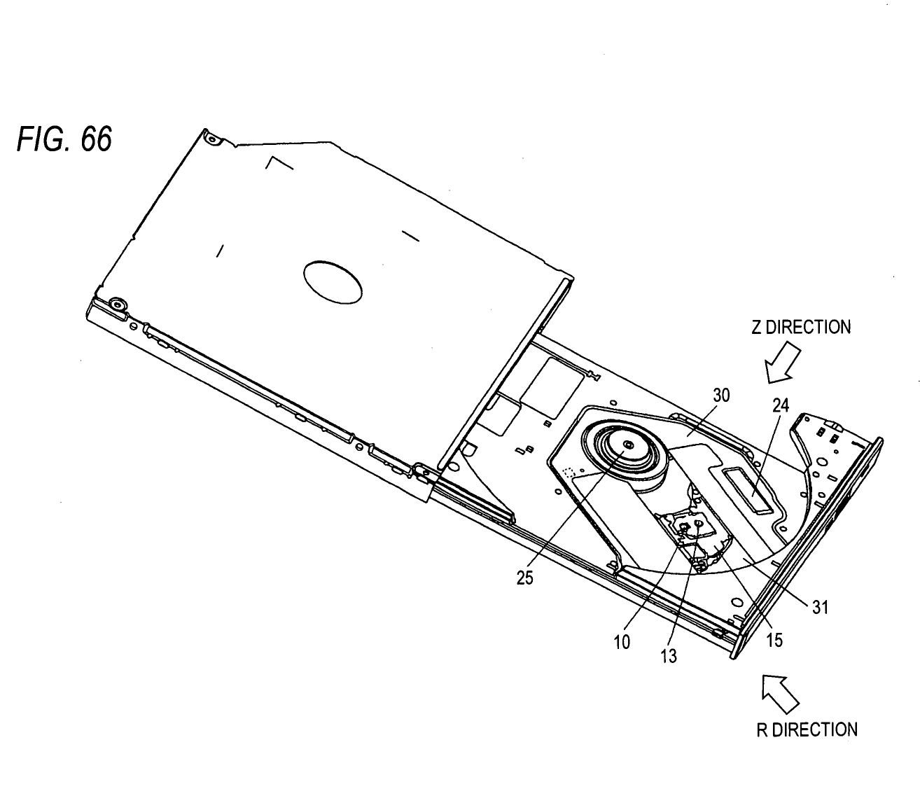

By using the above-described optical pickup device, the optical disk apparatus as shown in FIG. 66 can be made small-sized.

The optical pickup device and the optical disk apparatus of the present invention have an effect of implementing the small-sized ones, and can be applied to electronic equipment such as stationary personal computers or portable electronic equipment such as notebook computers and personal computers.

This application is based upon and claims the benefit of priority of Japanese Patent Application NO. 2004-226495 filed on Aug. 3, 2004, Japanese Patent Application No. 2004-309402 filed on Oct. 25, 2004, Japanese Patent Application NO. 2004-309403 filed on Oct. 25, 2004, Japanese Patent Application NO. 2004-309404 filed on Oct. 25, 2004, Japanese Patent Application NO. 2005-000388 filed on Jan. 5, 2005, Japanese Patent Application No. 2005-048375 filed on Feb. 24, 2005, the contents of which are incorporated herein by references in its entirety.

What is claimed is:

1. An optical pickup device, comprising:
a first light source, emitting light with a short wavelength;
a second light source, emitting light with a wavelength longer than that of the first light source;
an optical member, guiding the light from the first light source and the light from the second light source on almost the same optical path;
a focusing member, focusing the light from the optical member;
a movable lens, provided between the optical member and the focusing lens; and
a drive member, driving the movable lens,
wherein a position of the lens when at least one of recording and reproducing of information is carried out on a medium using the light from the first light source is made different from a position of the lens when at least one of the recording and reproducing of information is carried out on the medium using the light from the second light source.

2. The optical pickup device according to claim 1,
wherein the drive member has a motor, a gear group, and a screw shaft;
the lens is attached on a slider;
the screw shaft is engaged with the slider;
the rotation of the motor is transmitted to the screw shaft via the gear group; and
the slider moves when the screw shaft rotates.

3. The optical pickup device according to claim 1,
wherein the focusing member includes at least:
a first focusing portion, focusing the light from the first light source; and
a second focusing portion, focusing the light from the second light source.

4. The optical pickup device according to claim 1,
wherein the first light source emits light having a wavelength of 400 nm to 415 nm, and the second light source emits light having a wavelength of 640 nm to 800 nm.

5. The optical pickup device according to claim 1,
wherein stop position data on the lens when at least one of the recording and reproducing of information is carried out using the light from the first light source and stop position data on the lens when at least one of the recording and reproducing of information is carried out using the light from the second light source are stored in a memory, and
a control member reads the data from the memory according to signals received from another member and drives the drive member according to the read data to stop the lens at a predetermined position.

6. The optical pickup device according to claim 1,
wherein the position of the lens when at least one of the recording and reproducing of information is carried out on the medium using the light from the first light source is closer to the optical portion than the position of the lens when at least one of the recording and reproducing of information is carried out on the medium using the light from the second light source.

7. An optical disk apparatus, comprising:
an optical pickup device according to claim 1;
a base that movably holds the optical pickup device; and
a rotation-driving portion provided in the base to rotatingly drive a medium.

8. An optical pickup device, comprising:
a first light source, emitting light with a short wavelength;
a second light source, emitting light with a wavelength longer than that of the first light source;
an optical member, guiding the light from the first light source and the light from the second light source on almost the same optical path;
a focusing member, focusing the light from the optical member; and
a base to which the first light source, the second light source, the optical member, and the focusing member are attached,
wherein the cross-section of the light emitted from the first light source is substantially elliptical, a major axis of the cross-section of the light emitted from the first light source is substantially vertical to the thickness direction of the base and is not vertical to an axis substantially vertical to a direction of the light emitted from the first light source.

9. The optical pickup device according to claim 8,
wherein the axis is substantially parallel to the major axis.

10. The optical pickup device according to claim 8,
wherein the first light source is provided such that a semiconductor laser element is disposed in a substantially rectangular base having a long side and a short side, and a major axis of the cross-section of light emitted from the semiconductor laser element is substantially parallel to the long side, and the long side of the base is disposed substantially parallel to a bottom portion of the base.

11. An optical pickup device, comprising:
a first light source, emitting light with a short wavelength;
a second light source, emitting light with a wavelength longer than that of the first light source;
an optical member, guiding the light from the first light source and the light from the second light source on almost the same optical path; and
a focusing member, focusing the light from the optical member;
wherein the cross-section of the light emitted from the first light source is substantially elliptical, and a major axis of the cross-section of the light emitted from the first light source is substantially parallel to a main surface of a medium to be mounted and is not vertical to an axis vertical to a direction of the light emitted from the first light source.

12. The optical pickup device according to claim 11,
wherein the axis is substantially parallel to the major axis.

13. An optical disk apparatus, comprising:
a first light source, emitting light with a short wavelength;
a second light source, emitting light with a wavelength longer than that of the first light source;
an optical member, guiding the light from the first light source and the light from the second light source on almost the same optical path;
a focusing member, focusing the light from the optical member;
a base to which the first light source, the second light source, the optical member, and the focusing member are attached;
a base, movably holding the base; and
a rotation-driving portion, provided in the base to rotatingly drive a medium,
where the cross-section of the light emitted from the first light source is substantially elliptical, and a major axis of the cross-section of the light emitted from the first light source is substantially vertical to a rotation axis of the rotation-driving portion and is not vertical to an axis substantially vertical to a direction of the light emitted from the first light source.

14. An optical pickup device, comprising:
a first light source, emitting light with a short wavelength;
a second light source, emitting light with a wavelength longer than that of the first light source;
an optical member, guiding the light from the first light source and the light from the second light source on almost the same optical path;
a focusing member, focusing the light from the optical member; and
a base to which the first light source, the second light source, the optical member, and the focusing member are attached,
wherein the first light source has a semiconductor laser element, and an active layer of the semiconductor laser element is laminated substantially parallel to the thickness direction of the base.

15. An optical pickup device, comprising:
a light source;
a focusing member, focusing the light from the light source; and
a light-receiving portion, receiving the light from the light source,
wherein the light-receiving portion includes a light-receiving element having a light-detecting portion, and a wiring substrate having a light-transmitting portion facing the light-detecting portion.

16. The optical pickup device according to claim 15,
wherein an electrode of the light-receiving element faces an electrode of the wiring substrate.

17. The optical pickup device according to claim 15,
wherein an anisotropic conductive material is provided between an electrode of the light-receiving element and an electrode of the wiring substrate.

18. The optical pickup device according to claim 15,
wherein the wiring substrate is a flexible printed substrate.

19. The optical pickup device according to claim 15, further comprising a transparent glass substrate,
wherein the light-transmitting portion of the wiring substrate is an opening;
the wiring substrate is provided between the light-receiving element and the transparent glass substrate; and
the light-detecting portion and the transparent glass substrate face each other with the opening therebetween.

20. The optical pickup device according to claim 19,
wherein the opening is a through-hole.

21. The optical pickup device according to claim 19,
wherein the opening is a notch.

22. The optical pickup device according to claim 19,
wherein an attaching member is disposed between the wiring substrate and the transparent glass substrate;
the attaching member is not present at a position where at least a portion of the light-detecting portion of the light-receiving element and the transparent glass substrate face each other.

23. The optical pickup device according to claim 22,
wherein the attaching member is made of metal.

24. The optical pickup device according to claim 15,
wherein the light source emits short wavelength light.

25. An optical disk apparatus, comprising:
an optical pickup device according to claim 15;
a base, movably holding the optical pickup device; and
a rotation-driving member provided in the base to rotatingly drive a medium.

26. A light-receiving unit, comprising:
a light-receiving element having a light-detecting portion; and
a wiring substrate having a light-transmitting portion facing the light-detecting portion.

27. The light-receiving unit according to claim 26,
wherein an electrode of the light-receiving element and an electrode of the wiring substrate face each other.

28. The light-receiving unit according to claim 26,
wherein an anisotropic conductive material is provided between an electrode of the light-receiving element and an electrode of the wiring substrate.

29. The light-receiving unit according to claim 26,
wherein the wiring substrate is a flexible printed substrate.

30. The light-receiving unit according to claim 26, further comprising a transparent glass substrate,
wherein the light-transmitting portion of the wiring substrate is an opening;
the wiring substrate is provided between the light-receiving element and the transparent glass substrate; and
the light-detecting portion and the transparent glass substrate face each other with the opening therebetween.

31. The light-receiving unit according to claim 30,
wherein the opening is a through-hole.

32. The light-receiving unit according to claim 30,
wherein the opening is a notch.

33. The light-receiving unit according to claim 30,
wherein an attaching member is disposed between the wiring substrate and the transparent glass substrate;
the attaching member is not present at a position where at least a portion of the light-detecting portion of the light-receiving element; and
the transparent glass substrate face each other.

34. The light-receiving unit according to claim 33,
wherein the attaching member is made of metal.

35. An optical pickup device, comprising:
a light source;
a focusing member, focusing light from the light source; and
a light-receiving portion, receiving light from the light source;
wherein the light-receiving portion includes a light-receiving element having a light-transmitting portion facing a light-detecting portion of the light-receiving element; and
the light emitted from the light source reach the light-detecting portion through the light-transmitting portion.

36. A light-receiving unit, comprising:
a flexible substrate, having an opening;
a light-receiving element, having a light-detecting portion and mounted on the flexible substrate,
wherein the light-detecting portion of the light-receiving element is disposed to face the opening of the flexible substrate.

37. The light-receiving unit according to claim 36,
wherein a circuit component electrically connected to the light-receiving element is mounted on a portion where the flexible substrate is folded by folding the flexible substrate to face a surface of the light-receiving element opposite to the light-detecting portion.

38. The light-receiving unit according to claim 37, further comprising a supporting substrate, holding the flexible substrate where the light-receiving element and the circuit component are mounted.

39. The light-receiving unit according to claim 37,
wherein the flexible substrate is made of copper foil and polyimide.

40. The light-receiving unit according to claim 37,
wherein a circuit component electrically connected to the light-receiving element is mounted on a portion where the flexible substrate is folded by folding the flexible substrate two times to face a surface of the light-receiving element opposite to the light-detecting portion.

41. The light-receiving unit according to claim 37,
wherein the circuit component is a ceramic capacitor.

42. The light-receiving unit according to claim 41,
wherein the light-receiving element and the ceramic capacitor are mounted on the same surface of the flexible substrate.

43. An optical pickup device, comprising:
a light source;
a focusing member, focusing light from the light source; and
a light-receiving unit according to claim 36 that receives light from the light source.

44. An optical pickup device, comprising:
a light source;
a focusing member, focusing light from the light source;
a holder to which the focusing member is attached; and
a suspension, elastically supporting the holder,
wherein the holder has conductivity; and
the holder and the suspension are coupled together by inserting molding so that the holder and the suspension are insulated from each other.

45. The optical pickup device according to claim 44,
wherein an insulating portion is disposed in at least a portion of the suspension into which the holder is inserted.

46. The optical pickup device according to claim 45,
wherein the insulating portion is formed such that an insulating material like resin is provided on the suspension.

47. The optical pickup device according to claim 44,
wherein the holder has a conductive portion and a non-conductive portion, and the suspension is fixed to the non-conductive portion by inserting molding.

48. The optical pickup device according to claim 44,
wherein at least a portion of the holder is made of a material in which fibers are dispersed in resin, and a liquid crystal polymer, an epoxy resin, a polyimide resin, a polyamide resin, or an acrylic resin is properly employed as the resin, and a carbon fiber, a carbon black, or a metal fiber such as a copper, a nickel, an aluminum, and a stainless, or a composite fiber thereof is employed as the fiber.

49. The optical pickup device according to claim 44,
wherein the light source includes a first light source that emits light with a short wavelength, and a second light source that emits light with a wavelength loner than the first light source, and the focusing member includes a short wavelength light focusing portion that focuses the light emitted from the first light source, and a long wavelength light focusing portion that focuses that light emitted from the second light source.

50. An optical disk apparatus, comprising:
an optical pickup device according to claim 44;
a base, movably holding the optical pickup device; and
a rotation-driving portion, formed in the base to rotatingly drive a medium.

51. An optical pickup device, comprising:
a light source, emitting light with a first wavelength and light with a second wavelength longer than the first wavelength;
a focusing member, focusing the light from the light source; and
a switching member, disposed between the light source and the focusing member to carry out switching between transmission and reflection of light of the first wavelength regardless of a polarization state.

52. The optical pickup device according to claim 51,
wherein a first focusing member where light reflected by the switching member reaches, and a second focusing member where light transmitted through the switching member reaches are used as the focusing member.

53. The optical pickup device according to claim 52,
wherein the numerical aperture of the first focusing member is different from the numerical aperture of the second focusing member.

54. The optical pickup device according to claim 52,
wherein the numerical aperture of the first focusing member is smaller than the numerical aperture of the second focusing member.

55. The optical pickup device according to claim 51,
wherein a first optical unit that emits light with the first wavelength, and a second optical unit that emits light of the second wavelength longer than the first wavelength are used as the light source.

56. An optical disk apparatus, comprising:
an optical pickup device according to claim 51;
a base, movably holding the optical pickup device; and
a rotation-driving portion, provided in the base to rotatingly drive a medium.
